(19) United States
(12) Patent Application Publication
(10) Pub. No.: US 2024/0094603 A1
(43) Pub. Date: Mar. 21, 2024

(54) LENS DRIVING DEVICE

(71) Applicant: LG INNOTEK CO., LTD., Seoul (KR)

(72) Inventors: Hyun Woong JANG, Seoul (KR); Min KIM, Seoul (KR); Jang Hyun KIM, Seoul (KR); Tae Ho KIM, Seoul (KR)

(21) Appl. No.: 18/551,772

(22) PCT Filed: Mar. 22, 2022
(86) PCT No.: PCT/KR2022/004006

§ 371 Date: Sep. 21, 2023

(30) Foreign Application Priority Data
Mar. 22, 2021 (KR) 10-2021-0036598
Mar. 22, 2021 (KR) 10-2021-0036620
Mar. 22, 2021 (KR) 10-2021-0036636

(51) Int. Cl. G03B 5/06

(52) U.S. Cl. CPC G03B 5/06; G03B 2205/0023; G03B 2205/0069

(57) ABSTRACT

A lens driving device according to an embodiment can include a first housing in which a lens assembly is disposed therein and a magnet is disposed; and a second housing in which a coil is disposed and disposed to surround the first housing, wherein the magnet includes a plurality of magnet parts that move the lens assembly based on different rotation axes, and the plurality of magnet parts are arranged in the first housing to be spaced apart from a center of the rotation axis of the lens assembly at a same distance.

### CROSS-REFERENCE TO RELATED APPLICATIONS

This application is the U.S. national stage application of International Patent Application No. PCT/KR2022/004006, filed Mar. 22, 2022, which claims the benefit under 35 U.S.C. § 119 of Korean Application Nos. 10-2021-0036598, filed Mar. 22, 2021; 10-2021-0036620, filed Mar. 22, 2021; and 10-2021-0036636, filed Mar. 22, 2021; the disclosures of each of which are incorporated herein by reference in their entirety.

### TECHNICAL FIELD

The embodiment relates to a lens driving device. In particular, the embodiment relates to a lens driving device, a camera module, a camera device, and a method of driving the same.

### BACKGROUND ART

The camera module performs a function of capturing a subject and storing it as an image or video, and is used by being mounted on a mobile terminal such as a mobile phone, a laptop computer, a drone, or a vehicle.

On portable devices like smartphones, tablet PCs, and laptops, a miniaturized camera module is integrated. These camera modules can perform autofocus (AF) by automatically adjusting the distance between the image sensor and the lens to align the focal length.

Furthermore, recent camera modules are equipped with zoom lenses to perform zooming functions such as zooming in (zoom up) or zooming out to increase or decrease the magnification of distant subjects.

Moreover, recent camera modules provide image stabilization (IS) functions. In other words, movement of the camera module may occur due to unstable fixtures, user movement, vibration, and impact. And, the image stabilization (IS) functions corrects or inhibits image stabilization caused by movement of the camera module.

This image stabilization (IS) function may include an optical image stabilizer (OIS) function and an image stabilization function using an image sensor.

The optical image stabilization function corrects movement by changing the path of light, and the image stabilization function using the image sensor is a function that corrects movement through mechanical and electronic methods.

### DISCLOSURE

### Technical Problem

The embodiment provides a lens driving device and a camera module including the same that can solve the problem of increased driving force occurring as the size of an image sensor increases.

In addition, the embodiment provides a lens driving device and a camera module including the same that can inhibit an increase in rolling torque required for roll driving during OIS operation.

In addition, the embodiment provides a lens driving device and a camera module including the same that can solve the reliability problem of the camera module caused by external impact.

In addition, the embodiment provides a lens driving device and a camera module including the same that can solve the problem of components of the lens driving device being separated from each other due to impact.

In addition, the embodiment provides a lens driving device and a camera module including the same that can solve technical problems related to the occurrence of high-frequency vibration, increase in driving resistance, and dynamic tilt due to a spring structure.

In addition, the embodiment provides a lens driving device capable of inhibiting magnetic field interference between a plurality of magnets and a camera module including the same.

In addition, the embodiment provides a camera device and a method of driving the same that allow sequential movement of a rotation axis when the OIS is driven.

In addition, the embodiment provides a camera device and a method of driving the same that can provide a driving order of a plurality of rotation axes for OIS driving.

In addition, the embodiment provides a camera device and a method of driving the same that can determine the driving order of a plurality of rotation axes for OIS operation based on a degree of shaking of each rotation axis.

In addition, an embodiment provides a camera device and a method of driving the same that can determine a driving order of a plurality of rotation axes for OIS driving based on a shooting mode of the camera device.

Technical problems to be solved by the proposed embodiments are not limited to the above-mentioned technical problems, and other technical problems not mentioned may be clearly understood by those skilled in the art to which the embodiments proposed from the following descriptions belong.

### Technical Solution

A lens driving device according to the embodiment comprises a first housing in which a lens assembly is disposed therein and a magnet is disposed; and a second housing in which a coil is disposed and disposed to surround the first housing, wherein the magnet includes a plurality of magnet parts that move the lens assembly based on different rotation axes, and the plurality of magnet parts are arranged in the first housing to be spaced apart from a center of the rotation axis of the lens assembly at a same distance.

In addition, the plurality of magnet parts can include a first magnet part that moves the lens assembly based on a first rotation axis; a second magnet part that moves the lens assembly based on a second rotation axis different from the first rotation axis; and a third magnet part that moves the lens assembly based on a third rotation axis different from the first and second rotation axes.

In addition, the center of the rotation axis is a center of any one of the first to third rotation axes.

In addition, the centers of the first to third rotation axes are the same.

In addition, a distance from the center of the rotation axis to the third magnet part is same as at least one of a distance from the center of the rotation axis to the first magnet part and a distance from the center of the rotation axis to the second magnet part.

In addition, the third rotation axis corresponds to an optical axis through which light is incident on the lens assembly,

In addition, sizes of the first to third magnet parts are the same.

In addition, the coil includes a first coil part corresponding to the first magnet part; a second coil part corresponding to the second magnet part; and a third coil part corresponding to the third magnet part, and wherein a distance from the center of the rotation axis to the third coil part, the distance from the center of the rotation axis to the first coil part, and the distance from the center of the rotation axis to the second coil part are the same.

In addition, the lens assembly includes a lens; and a bobbin on which the lens is disposed and a fourth coil part corresponding to the first magnet part and the second magnet part is disposed.

In addition, the first magnet part includes a plurality of first magnets disposed facing each other in a first direction from the center of the first housing, wherein the second magnet part includes a plurality of second magnets disposed facing each other in a second direction perpendicular to the first direction from the center of the first housing, and the third magnet part includes a plurality of third magnets disposed facing each other in a diagonal direction between the first direction and the second direction from at the center of the first housing.

In addition, the distance between the plurality of first magnets passing through the center of the first housing, the distance between the plurality of second magnets passing through the center of the first housing, and the distance between the plurality of third magnets passing through the center of the first housing are the same.

Meanwhile, a lens driving device according to an embodiment comprises a lens; a bobbin in which the lens is disposed; and a first housing in which the bobbin is disposed and a plurality of magnet parts are disposed, wherein the plurality of magnet parts include a first magnet part including a plurality of first magnets facing in a first direction from a center of the first housing; a second magnet part including a plurality of second magnets facing in a second direction perpendicular to the first direction from the center of the first housing; and a third magnet part including a plurality of third magnets facing in a diagonal direction between the first and second directions from the center of the first housing; wherein a distance between the plurality of first magnets passing through the center of the first housing, a distance between the plurality of second magnets passing through the center of the first housing and a distance between the plurality of third magnets passing through the center of the first housing are the same.

In addition, the first magnet part is a yaw magnet part for yawing the lens, the second magnet part is a pitch magnet part for pitching the lens, and the third magnet part is a roll magnet part for rolling the lens.

Meanwhile, the lens driving device according to the embodiment comprises a first housing in which a lens assembly is disposed; a second housing in which the first housing is disposed; and a driving part that moves the first housing in which the lens assembly is disposed relative to the second housing, wherein the driving part includes a first driving part that moves the first housing based on a first rotation axis, a second driving part that moves the first housing based on a second rotation axis different from the first rotation axis, and a third driving part that moves the first housing based on a third rotation axis different from the first and second rotation axes, wherein centers of the first to third rotation axes are the same, and distances from the center to the first to third driving parts is the same.

In addition, the first driving part includes a first magnet part and a first coil part, the second driving part includes a second magnet part and a second coil part, the third driving part includes a third magnet part and a third coil part, and wherein the distances are distances from the center to the first to third magnet parts and the distances from the center to the first to third coil parts.

The camera device according to the embodiment comprises a fixed part; and a moving part that moves relative to the fixed part; a driving part that provides driving force so that the moving part can move relative to the fixed part; and a control unit that supplies a driving signal to the driving part, and the driving part includes a plurality of driving parts for moving the moving part around different rotation axes, and wherein the control unit generates a plurality of driving signals to be supplied to the plurality of driving parts and outputs each of the plurality of driving signals at different time points.

In addition, the driving part includes a first driving part that moves the moving part around a first rotation axis; a second driving part that moves the moving part around a second rotation axis different from the first rotation axis; and a third driving part that moves the moving part around a third rotation axis that is different from the first and second rotation axes, and wherein the control unit generates first to third driving signals to be supplied to the first to third driving parts, respectively, and outputs the generated first to third driving signals at different time points.

In addition, the camera device according to the embodiment includes a movement detection unit that acquires movement information, and wherein the control unit generates the first to third drive signals to move the moving part to a target position based on movement information acquired through the movement detection unit.

In addition, the control unit includes a compensation angle calculation unit that calculates a compensation angle for each of the first to third rotation axes based on the movement information; a driving signal generation unit that generates the first to third driving signals based on the compensation angle calculated through the compensation angle calculation unit; and a driving signal output unit that determines an output order of the generated first to third driving signals and outputs the first to third driving signals to the first to third driving parts in response to the determined output order.

In addition, the control unit includes a mode determination unit that determines a mode for determining the output order of the first to third driving signals.

In addition, the mode determination unit extracts pre-stored mode information and determines the output order of the first to third driving signals based on the extracted mode information.

In addition, the mode determination unit periodically calculates a deviation between a target position and a final position for a plurality of modes and updates the stored mode information based on the calculated deviation.

In addition, the driving signal output unit outputs a first priority driving signal among the first to third driving signals at a first time point, outputs a second priority driving signal among the first to third driving signals at a second time point when a first delay time has elapsed from the first time point, and outputs a third priority driving signal among the first to third driving signals at a third time point when a second delay time has elapsed from the second time point.

In addition, at least one of the first delay time and the second delay time is determined by at least one of frequencies of the first to second driving signals, a frequency of a clock signal of the control unit, and driving response speeds of the first to third driving parts.

In addition, the control unit includes a compensation angle comparison unit that compares compensation angles for each of the first to third rotation axes, and wherein the driving signal output unit outputs the first to third driving signals in the order in which the compensation angle is large based on a comparison result of the compensation angle comparison unit.

Meanwhile, a method of driving the camera device according to the embodiment comprises detecting movement information of the camera device; calculating first to third compensation angles for hand-shaking compensation for first to third rotation axes of the camera device, based on the detected movement information; determining an hand-shaking compensation order for the first to third rotation axes; and based on the determined hand-shaking compensation order, sequentially performing the hand-shaking compensation for the first to third rotation axes.

In addition, the calculating of the first to third compensation angles includes calculating a first compensation angle for compensating for the hand-shaking compensation around a first rotation axis; calculating a second compensation angle for compensating for the hand-shaking compensation around a second rotation axis different from the first rotation axis; and calculating a third compensation angle for the hand-shaking compensation around a third rotation axis that is different from the first and second rotation axes.

In addition, the first rotation axis is a yaw axis for yawing, the second rotation axis is a pitch axis for pitching, the third rotation axis is a roll axis for rolling.

In addition, the determining the hand-shaking compensation order includes extracting pre-stored mode information, and wherein the sequentially performing of the hand-shaking compensation includes determining the hand-shaking compensation order of the first to third rotation axes based on the extracted mode information.

In addition, the method includes periodically calculating a deviation between the target position and a final position for a plurality of modes and updating the stored mode information based on the calculated deviation.

In addition, the sequentially performing of the hand-shaking compensation includes based on the compensation order, performing the hand-shaking compensation for a first priority rotation axis at a first time point; based on the compensation order, performing the hand-shaking compensation for a second priority rotation axis at a second time point when a first delay time has elapsed from the first time point; and, based on the compensation order, performing the hand-shaking compensation for a third priority rotation axis at a third time point when a second delay time has elapsed from the second time point.

In addition, the method further comprises comparing first to third compensation angles for each rotation axis, and wherein the determining of the hand-shaking compensation order includes determining the hand-shaking compensation order in the order in which the compensation angle is large based on a comparison result.

The camera device according to the embodiment comprises a fixed part; and a moving part that moves relative to the fixed part; a driving part that provides driving force so that the moving part can move relative to the fixed part; and a control unit that outputs a driving signal for hand-shaking compensation to the driving part, and the driving part includes a plurality of driving parts for moving the moving part around different rotation axes, wherein the driving part includes first to third driving parts for moving the moving unit around first to third rotation axes, and wherein the control unit generates first to third driving signals to be supplied to the first to third driving parts, determines an output order of the first to third driving signals based on a degree of hand-shaking of the first to third rotation axes, and sequentially outputs the first to third driving signals based on the determined output order.

In addition, the degree of hand-shaking is determined by a holding direction or a shooting mode of the camera device.

In addition, the camera device includes a movement detection unit that acquires movement information, and the control unit determines the holding direction or shooting mode of the camera device based on the movement information, and determines the output order of the first to third driving signals based on the determined holding direction or shooting mode.

In addition, when the holding direction of the camera device is a horizontal direction or the shooting mode is a horizontal shooting mode, the control unit allows the first drive signal corresponding to the first rotation axis to be output as first priority.

In addition, when the holding direction of the camera device is a vertical direction or the shooting mode is a vertical shooting mode, the control unit allows the first driving signal corresponding to the second rotation axis to be output as first priority.

In addition, the first rotation axis is an x-axis perpendicular to an optical axis, the second rotation axis is a y-axis perpendicular to the optical axis and the x-axis, and the third rotation axis is a z-axis corresponding to the optical axis.

In addition, the camera device includes a movement detection unit that acquires movement information, and the control unit calculates a compensation angle for each of the first to third rotation axes based on the movement information, generates the first to third driving signals based on the compensation angle, and outputs the first to third driving signals to the first to third driving parts based on the determined output order.

In addition, the control unit compares compensation angles for each of the first to third rotation axes, and determines the output order of the first to third drive signals in the order in which the compensation angle is large based on a comparison result.

In addition, the control unit outputs, based on the determined output order, a first priority driving signal among the first to third driving signals at a first time point, outputs a second priority driving signal among the first to third driving signals at a second time point when a first delay time has elapsed from the first time point, and outputs a third priority driving signal among the first to third driving signals at a third time point when a second delay time has elapsed from the second time point.

In addition, at least one of the first delay time and the second delay time is determined by at least one of frequencies of the first to second driving signals, a frequency of a clock signal of the control unit, and driving response speeds of the first to third driving parts.

In addition, the method of driving the camera device according to the embodiment comprises detecting movement information of the camera device; calculating first to third compensation angles for hand-shaking compensation for first to third rotation axes of the camera device based on the detected movement information; determining a holding direction or shooting mode of the camera device based on the detected movement information; determining a hand-shaking compensation order for the first to third rotation axes based on the holding direction or the shooting mode; and sequentially performing hand-shaking compensation for the first to third rotation axes based on the determined compensation order.

In addition, the determining the hand-shaking compensation order includes when the holding direction is a horizontal direction or the shooting mode is horizontal shooting mode, performing hand-shaking compensation corresponding to the first rotation axis as a first priority; when the holding direction is a vertical direction or the shooting mode is vertical shooting mode, performing hand-shaking compensation corresponding to the second rotation axis as a first priority.

In addition, the sequentially performing includes performing hand-shaking compensation for a first priority rotation axis at a first time point based on the determined hand-shaking compensation order; performing hand-shaking compensation for a second priority rotation axis at a second time point when a first delay time has elapsed from the first time point; and, performing hand-shaking compensation for a third priority rotation axis at a third time point when a second delay time has elapsed from the second time point.

In addition, the first rotation axis is an x-axis perpendicular to the optical axis, the second rotation axis is a y-axis perpendicular to the optical axis and the x-axis, and the third rotation axis is a z-axis corresponding to the optical axis.

Meanwhile, a method of driving the camera device according to the embodiment comprises detecting movement information of the camera device; calculating first to third compensation angles for hand-shaking compensation for first to third rotation axes of the camera device, based on the detected movement information; determining a hand-shaking compensation order for the first to third rotation axes in the order in which the compensation angle is large; and sequentially performing hand-shaking compensation for the first to third rotation axes according to the determined hand-shaking compensation order.

In addition, the first rotation axis is a yaw axis for yawing, the second rotation axis is a pitch axis for pitching, and the third rotation axis is a roll axis for rolling.

In addition, the sequentially performing the and-shaking compensation includes performing hand-shaking compensation for a first priority rotation axis at a first time point based on the hand-shaking compensation order; performing hand-shaking compensation for a second priority rotation axis at a second time point based on the compensation order when a first delay time has elapsed from the first time point; and performing hand-shaking compensation for the third priority rotation axis at a third time point based on the compensation order when a second delay time has elapsed from the second time point.

### Advantageous Effects

According to the lens driving device and the camera module including the same according to the embodiment, the accuracy and reliability of 3-axis OIS operation can be improved. Specifically, in the embodiment, the first magnet part MN1, the second magnet part MN2, and the third magnet part MN3 are disposed in the first housing. At this time, in the embodiment, the first magnet part MN1, the second magnet part MN2, and the third magnet part MN3 disposed in the first housing are disposed at the same distance from a center of a rotation axis. For example, in the comparative example, the third magnet part MN3 was disposed farther from the center of the rotation axis compared to the first magnet part MN1 and the second magnet part MN2. Accordingly, when the OIS of yaw and/or pitch is implemented (yawing and/or pitching) by the first magnet part MN1 and/or the second magnet part MN2, the comparative example has a problem in that the sensing value changes significantly even if the OIS for the roll is not implemented (rolled). In contrast, in the embodiment, the first magnet part MN1, the second magnet part MN2, and the third magnet part are each arranged at the same distance from each other based on the center of the rotation axis in the first housing 300. Accordingly, the embodiment allows the movement distance of each magnet part with respect to a rotation radius to be the same, and the influence of each axis accordingly can be interpreted equally. Accordingly, the embodiment can secure the linearity of the output value of each Hall sensor with respect to the rotation radius, thereby improving OIS implementation accuracy, and further improving operation reliability.

In addition, the embodiment allows the first magnet part MN1, the second magnet part MN2, and the third magnet part MN3 for rotating the lens 100 or bobbin about different axes to have the same size. For example, in the comparative example, the size of the third magnet part MN3 is formed to be small compared to the sizes of the first magnet part MN1 and the second magnet part MN2. Accordingly, when the lens 100 is rotated by the first magnet part MN1 and the second magnet part MN2, in the comparative example, it is impossible to interpret the change in position of the third magnet part MN3. For example, as described above, in the comparative example, it is impossible to interpret how the yaw or pitch implementation by the first magnet part MN1 or second magnet part MN2 affects the change in position of the third magnet part MN3.

In contrast, in the embodiment, the first magnet part MN1, the second magnet part MN2, and the third magnet part MN3 are arranged at the same distance from each other around the rotation axis, and furthermore, they have the same size. Accordingly, in the embodiment, a movement distance of each magnet part with respect to the rotation radius is the same, so that the influence of each axis can be equally analyzed, thereby ensuring linearity of the sensing value of the Hall sensor. Furthermore, the embodiment can effectively reduce the change in Hall sensing range according to the rotation radius and further minimize the influence of other axes (cross-talk).

According to the lens driving device and the camera module including the same according to the embodiment, even if the size of the image sensor increases, as the spring stiffness of the sensor wiring structure for image sensor shift and tilt for OIS implementation increases, the technical contradiction that the force required for image sensor shift or tilt drive for OIS drive increases can be solved.

In addition, the embodiment can solve the problem of deteriorating the reliability of the camera module when an external impact or the like occurs in OIS implementation.

In addition, the embodiment can solve a technical problem that the components of the lens driving device are separated when an impact is applied to the camera module.

In addition, according to the embodiment, the first guide groove GH1 in which the first guide member is disposed can have an asymmetrical shape. Therefore, the embodiment can provide a path through which the lens can move with minimal friction while inhibiting the first guide member from being separated even when an impact or the like occurs.

In addition, the lens driving device and the camera module including the same according to the embodiment can precisely implement AF and OIS for the lens by inhibiting separation of the first guide member when AF, zooming, or OIS is implemented. That is, it is possible to solve the problem of lens decenter or tilt. Due to this, alignment between the plurality of lens groups is well matched to inhibit a change in angle of view or occurrence of out-of-focus, and remarkably improve image quality or resolving power.

In addition, according to the embodiment, it is possible to solve the technical problems of occurrence of high-frequency vibration, increase in driving resistance, and occurrence of dynamic tilt due to a preload spring structure in the AF structure.

For example, according to the embodiment, it is possible to provide a structure for moving a lens with minimal friction and tilt by removing a spring vulnerable to high-frequency vibration from an AF structure and applying a guide shaft. According to the embodiment, the first guide member for AF driving can be disposed between the first guide groove and the second guide groove. Accordingly, there is no vibration due to high frequency by removing the spring structure compared to the related art, and there is no spring structure, so driving resistance is low and power consumption is reduced, and there is a technical effect of less dynamic tilt (Dynamic tilt) compared to the guide bearing structure.

The camera device according to the embodiment includes a driving part that moves the moving part with respect to the fixed part. At this time, the driving part includes a first driving part that moves the moving part around a first rotation axis, and a second driving part that moves the moving part around a second rotation axis, and a third driving part that moves the moving part around a third rotation axis. At this time, when the 3-axis OIS is driven by the first to third driving parts, in the comparative example, first to third driving signals were simply provided to the first to third driving parts without considering the order of operation of these. However, 3-axis OIS technology can define each rotation axis as a rotation matrix by rotation transformation. At this time, since the relationship between each rotation axis is dependent, the movement change of the preceding rotation axis affects the movement change of the other rotation axis. Accordingly, a deviation occurs in the final position of the moving part depending on the driving order.

Accordingly, when driving OIS, the embodiment allows determining the hand-shaking compensation order for each rotation axis or the output order of the drive signal supplied to each driving part, and allows OIS operation for each rotation axis to be performed sequentially according to the determined hand-shaking compensation order or output order. Accordingly, the embodiment improves the accuracy of the final position of the moving part by allowing the OIS drive to be performed based on a specific hand-shaking compensation order or output order with the least mutual influence, and furthermore, it allows to improve OIS reliability.

That is, the embodiment allows determining the hand-shaking compensation order for each rotation axis or the output order of the driving signal supplied to each driving part when driving OIS, and allows OIS operation for each rotation axis to be performed sequentially according to the determined hand-shaking compensation order or output order. Accordingly, the embodiment improves the accuracy of the final position of the moving part by allowing the OIS drive to be performed based on a specific hand-shaking compensation order or output order with the least mutual influence, and furthermore, it allows to improve OIS reliability.

In addition, when the OIS is driven around three rotation axes, the embodiment allows the OIS to proceed sequentially in the order of the rotation axis with the largest amount of movement or the rotation axis with the largest rotation angle (for example, the rotation axis with the most shaking) or the rotation axis with the greatest degree of hand-shaking. Accordingly, the embodiment can minimize cross-talk generated by other rotation axes by performing OIS starting from the rotation axis with a large degree of shaking. In addition, the degree of shaking may correspond to changes in the user's posture. Accordingly, the embodiment can perform OIS operation adaptively according to the user's posture by performing OIS operation in the order of the degree of shaking (or hand shaking), thereby improving user satisfaction.

In addition, the embodiment allows OIS operation to be adaptive to the user's shooting posture. That is, the embodiment allows determining the hand-shaking compensation order for each rotation axis or the output order of the driving signal supplied to each driving part in response to the user's shooting posture. For example, the embodiment determines the hand-shaking compensation order or output order depending on whether the user holds the camera device in a horizontal direction or vertical direction. For example, the embodiment determines the hand-shaking compensation order or output order depending on whether the shooting mode of the camera device is horizontal shooting mode or vertical shooting mode. For example, if the holding direction is a horizontal direction or the shooting mode is horizontal shooting mode, a main hand shaking occurs in the x-axis. And, if the holding direction is a horizontal direction or the shooting mode is horizontal shooting mode, the OIS is driven by giving first priority to the hand-shaking compensation order of the first rotation axis corresponding to the x-axis or the output order of the first drive signal. Conversely, if the holding direction is a vertical direction or the shooting mode is vertical shooting mode, the main hand-shaking occurs in the y-axis. And, if the holding direction is the vertical direction or the shooting mode is vertical shooting mode, the OIS is driven by giving first priority to the hand-shaking compensation order of the second rotation axis corresponding to the y-axis or the output order of the second drive signal. Accordingly, the embodiment can provide OIS performance optimized for the user's shooting posture and thereby improve hand-shaking compensation accuracy.

### DESCRIPTION OF DRAWINGS

FIG. 1A is a perspective view of a camera module according to an embodiment.

FIG. 1B is a detailed perspective view of the camera module according to the embodiment shown in FIG. 1A.

FIG. 2A is a bottom view of the camera module according to the embodiment shown in FIG. 1B.

FIG. 2B is a perspective view in which a wiring substrate, a sensor substrate, and an image sensor are disposed in a camera module according to the embodiment shown in FIG. 2A.

FIG. 2C is an exploded perspective view of the wiring substrate, sensor substrate, and image sensor shown in FIG. 2B.

FIG. 2D is a bottom view of FIG. 2B.

FIG. 3A is a view in which a main substrate is omitted from the camera module according to the embodiment shown in FIG. 1A.

FIG. 3B is a detailed view in which bobbins, lenses, image sensors, and sensor substrates are omitted in FIG. 3A.

FIG. 3C is a detailed view in which the first housing, the first guide part, and the wiring substrate are omitted in FIG. 3B.

FIG. 3D is an enlarged view of the first region in FIG. 3B.

FIG. 3E is an enlarged view of the second area in FIG. 3C.

FIG. 3F is an enlarged view of the second housing in FIG. 3E.

FIG. 4A is a perspective view of a lens driving device in the camera module according to the embodiment shown in FIG. 3A.

FIG. 4B is a plan view of the lens driving device according to the embodiment shown in FIG. 4A.

FIG. 4C is a cross-sectional view of the lens driving device according to the embodiment shown in FIG. 4B along line A1-A2.

FIG. 5A is a perspective view of a lens driving device according to the embodiment shown in FIG. 3A.

FIG. 5B is a side cross-sectional view of the lens driving device according to the embodiment shown in FIG. 5A taken along line B1-B2 perpendicular to the z-axis.

FIG. 6A is an enlarged view of a third region in a cross-sectional side view of the lens driving device according to the embodiment shown in FIG. 5B.

FIG. 6B is a first detail view of FIG. 6A.

FIG. 6C is a second detail view of FIG. 6A.

FIG. 6D is a third detail view of FIG. 6A.

FIG. 7A is a view showing an arrangement structure of a magnet part according to a comparative example.

FIG. 7B a view showing a positional relationship between a third magnet part and a third hall sensor when the OIS is generally not driven.

FIGS. 7C and 7D are views schematically showing a positional relationship between the third Hall sensor and the third magnet part when OIS is driven according to a comparative example.

FIGS. 7E and 7F are views schematically showing the positional relationship between the third Hall sensor and the third magnet part when OIS is driven according to an embodiment.

FIGS. 8A-8E are views showing changes in the sensing value of the third Hall sensor according to the yaw angle and pitch angle according to a comparative example.

FIGS. 9A-9F are views showing changes in the sensing value of the third Hall sensor according to the yaw angle and pitch angle according to an embodiment.

FIG. 10 is a conceptual view for explaining the OIS operation of a camera device according to an embodiment.

FIGS. 11A-11C are views showing a rotation matrix according to the rotation axis in the OIS operation of the embodiment.

FIG. 12 is a block diagram showing the configuration of a camera device according to a first embodiment.

FIG. 13 is a block diagram showing the configuration of a camera device according to a second embodiment.

FIGS. 14A and 14B are block diagrams of the detailed configuration of the control unit shown in FIG. 12 or FIG. 13.

FIG. 15 is a view for explaining hand shaking characteristics according to the holding direction or shooting mode of the camera device.

FIG. 16 is a view for explaining the output order of driving signals according to the comparative example and the embodiment.

FIG. 17 is a flowchart for step-by-step explaining the operation method of the camera device according to the first embodiment.

FIG. 18 is a block diagram showing the detailed configuration of the control unit of FIG. 12 or FIG. 13 according to the second embodiment.

FIG. 19 is a flowchart for step-by-step explaining the operation method of the camera device according to the second embodiment.

FIG. 20 is a perspective view of an optical device according to an embodiment.

FIG. 21 is a configuration diagram of the optical device shown in FIG. 20.

FIG. 22 is a perspective view of a vehicle to which a camera module according to an embodiment is applied.

### MODE FOR INVENTION

Hereinafter, embodiments will be described in detail with reference to the accompanying drawings. Embodiments can apply various changes and can have various forms, and specific embodiments will be illustrated in the drawings and described in detail in the text. However, this is not intended to limit the embodiments to a specific form disclosed, and should be understood to include all modifications, equivalents, or substitutes included in the spirit and technical scope of the embodiments.

Terms such as “first” and “second” can be used to describe various components, but the components should not be limited by the terms. These terms are used for the purpose of distinguishing one component from another. In addition, terms specifically defined in consideration of the configuration and operation of the embodiment are only for describing the embodiment, and do not limit the scope of the embodiment.

In the description of the embodiment, in the case where it is described as being formed on “upper (above)” or “lower (on or under)” of each element, on or under includes both elements formed by directly contacting each other or by indirectly placing one or more other elements between the two elements. In addition, when expressed as “up” or “down (on or under)”, it can include the meaning of not only the upward direction but also the downward direction based on one element.

In addition, relational terms such as “on/above/upper” and “below/bottom/lower” used below refer to any relationship between such entities or elements. It may also be used to distinguish one entity or element from another entity or element without necessarily requiring or implying a physical or logical relationship or order.

### Embodiment

Hereinafter, specific features of the camera module according to the embodiment will be described in detail with reference to the drawings.

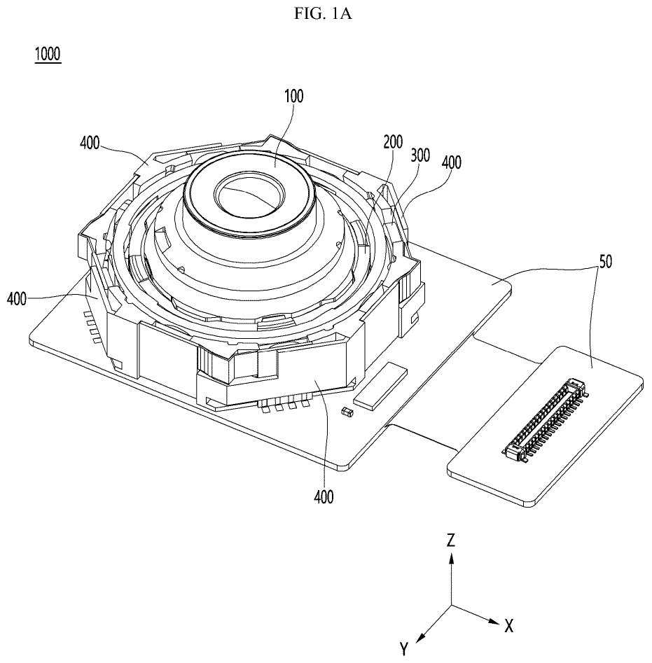

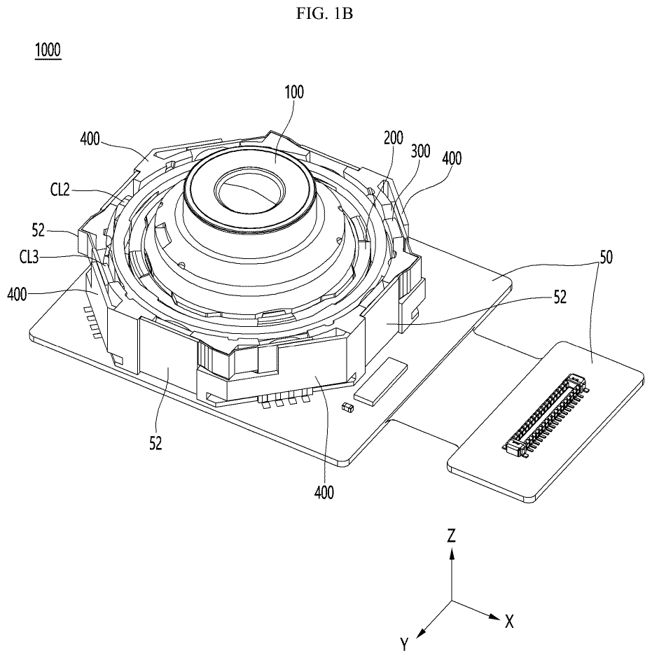

FIG. 1A is a perspective view of a camera module according to an embodiment, and FIG. 1B is a detailed perspective view of the camera module according to the embodiment shown in FIG. 1A.

An optical axis direction used below is defined as an optical axis direction of a camera actuator and a lens coupled to a camera module.

The ‘vertical direction’ used below may be a direction parallel to the optical axis direction.

For example, the optical axis direction or vertical direction may be a direction corresponding to a ‘z-axis’ of FIG. 1A. Accordingly, the optical axis direction, vertical direction, and third direction described below may be substantially the same direction. For example, the z-axis, third axis, and optical axis may mean substantially the same axis.

The ‘horizontal direction’ used below may be a direction perpendicular to the vertical direction.

In addition, the x-y plane indicates the ground perpendicular to the z axis, and the x axis is perpendicular to the z axis in the ground (x-y plane) direction, and the y-axis may mean a direction perpendicular to the x-axis on the ground. At this time, the x-axis may mean the same axis as the first axis described below. In addition, the y-axis may refer to the same axis as the second axis described below.

Meanwhile, “Auto focus function” used below is defined as a function for automatically adjusting a focus on a subject by adjusting a distance from an image sensor and moving a lens in the optical axis direction according to the distance of the subject so that a clear image of the subject may be obtained on the image sensor. Meanwhile, “auto focus” may correspond to “AF (Auto Focus)”. In addition, it can be used interchangeably with ‘auto focusing’.

The ‘image-shaking correction function’ used below is defined as a function that moves the lens and/or the image sensor to offset vibration (movement) generated in the image sensor by external force. Meanwhile, “image-shaking correction’ can correspond to ‘OIS (Optical Image Stabilization)’.

‘Yawing’, used below, may be a movement in the yaw direction that rotates or tilts around the x-axis. ‘Pitching’, used below, may be a movement in the pitch direction rotating around the y-axis. However, the embodiment is not limited thereto, and a movement rotating around the x-axis may be defined as ‘pitching’, and a movement rotating around the y-axis may be defined as ‘yawing’.

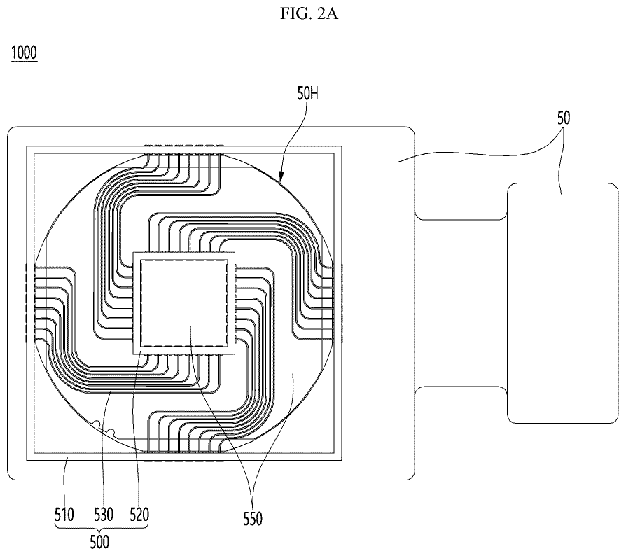

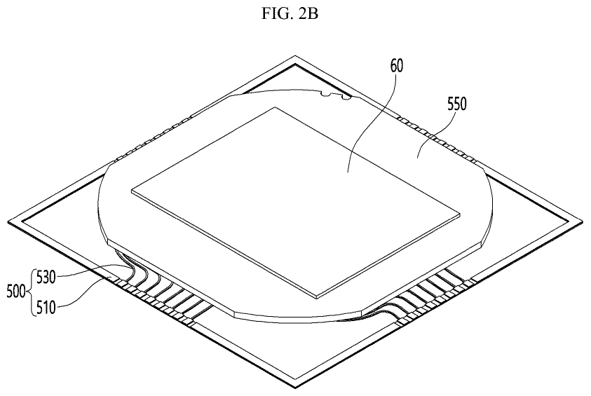

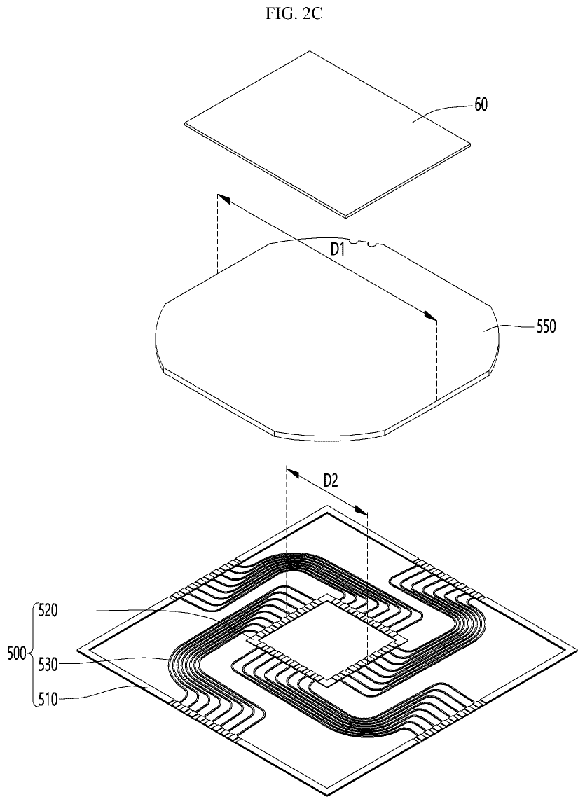

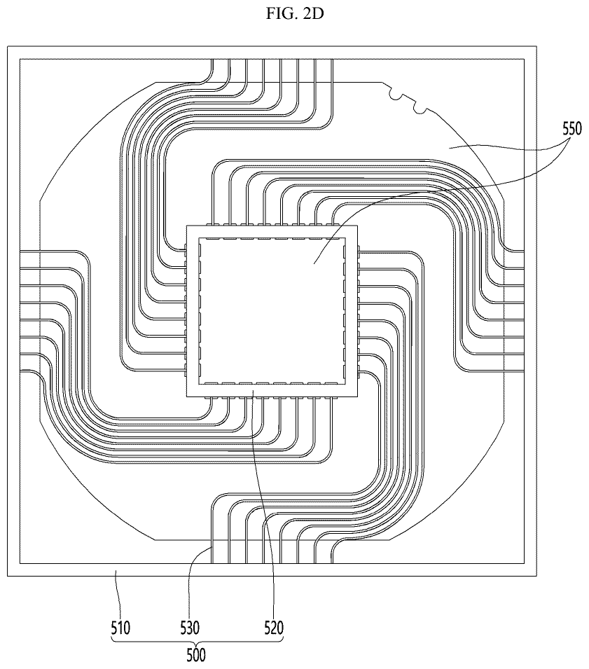

Meanwhile, the camera module 1000 according to the embodiment can be a module tilting method in which a lens 100 and an image sensor 60 (see FIG. 2B) move integrally to implement OIS. Meanwhile, when the AF is driven, only the lens 100 can be moved in a state in which the image sensor 60 is fixed to change the distance to the image sensor 60, but is not limited thereto.

Referring to FIG. 1A, the camera module 1000 according to an embodiment includes a main substrate 50. The camera module 1000 is disposed on the main substrate 50 and can include a bobbin 200 on which a lens 100 is disposed. The camera module 1000 can include a first housing 300 in which the bobbin 200 is disposed. The camera module 1000 can include a second housing 400 in which the first housing 300 is disposed. Here, the lens 100 and the bobbin 200 may also be referred to as a lens assembly.

The second housing 400 can be disposed outside the first housing 300 in plurality. For example, the second housing 400 can be provided in four each disposed at a corner outside the first housing 300, but is not limited thereto.

The main substrate 50 can be a PCB, Flexible Printed Circuit Boards (FPCB), or Rigid Flexible Printed Circuit Boards (RFPCB).

Referring next to FIG. 1B, the embodiment can include a plurality of coil substrates 52 electrically connected to the main substrate 50 and disposed in the second housing 400. The coil substrate 52 may be divided into a plurality of parts. However, the embodiment is not limited thereto, and the coil substrate 52 may be composed of one integrated substrate.

A first coil part CL1, second coil part CL2 and a third coil part CL3 can be disposed on the coil substrate 52. The first coil part CL1 may be arranged in the y-axis direction in the second housing 400. In addition, the second coil part CL2 may be arranged in the x-axis direction in the second housing 400. In addition, the third coil part CL3 may be arranged in the diagonal direction between the x-axis and the y-axis in the second coil part CL2. The first coil part CL1 can also be referred a ‘yaw coil part’ for yawing. In addition, the second coil part CL2 can also be referred to as a ‘pitch coil part’ for pitching. In addition, the third coil part CL3 may also be referred to as a ‘roll coil part’ for rolling. In addition, in the embodiment, a distance from a center of the rotation axis described below to the first coil part CL1, a distance from a center of the rotation axis to the second coil part CL2, and a distance from a center of the rotation axis to the third coil part CL3 are equal to each other.

Meanwhile, the second housing 400 may be divided into a plurality of mutually separated parts. For example, the second housing 400 may be divided into four parts. Accordingly, the coil substrate 52 may be disposed in each of the four parts of the second housing 400.

However, the embodiment is not limited thereto. For example, the second housing 400 may surround the first housing 300 and have an integrated frame structure, and the coil substrate 52 may be disposed in the second housing 400 of the integrated frame structure.

In addition, when the second housing 400 is divided into four parts, the coil substrate 52 may also be divided into four parts corresponding to each part of the second housing 400. And, at least one coil part among the first coil part CL1, the second coil part CL2, and the third coil part CL3 may be disposed on each of the four parts of the coil substrate 52. For example, the first coil part CL1 and the third coil part CL3 may be disposed on the first part of the coil substrate 52, and the second coil part CL2 and the third coil part CL3 may be disposed on the second part of the coil substrate 52, but are not limited thereto.

Meanwhile, a magnet part may be disposed in the first housing 300. For example, a first magnet part MN1, a second magnet part MN2, and a third magnet part MN3 may be disposed in the first housing 300.

The first magnet part MN1 may correspond to the first coil part CL1. The first magnet part MN1 may be arranged in the y-axis direction in the first housing 300.

The second magnet part MN2 may correspond to the second coil part CL2. The second magnet part MN2 may be disposed in the x-axis direction in the first housing 300.

The third magnet part MN3 may correspond to the third coil part CL3. The third magnet part MN3 may be arranged in the diagonal direction between the x-axis and the y-axis in the first housing 300.

The first magnet part MN1 may also be referred to as a ‘yaw magnet part’ for yawing through interaction with the first coil part CL1. In addition, the second magnet part MN2 may be referred to as a ‘pitch magnet part’ for pitching through interaction with the coil part CL2. In addition, the third magnet part MN3 may be referred to as a ‘roll magnet part’ for rolling through interaction with the third coil part CL3.

According to an embodiment, OIS operation may be possible by electromagnetic force between the first coil part CL1 and the first magnet part MN1. For example, according to the embodiment, yawing for OIS driving may be achieved by electromagnetic force between the first coil part CL1 and the first magnet part MN1. According to an embodiment, OIS operation may be possible by electromagnetic force between the second coil part CL2 and the second magnet part MN2. For example, according to an embodiment, pitching for OIS driving may be achieved by electromagnetic force between the second coil part CL2 and the second magnet part MN2. According to an embodiment, OIS operation may be possible by electromagnetic force between the third coil part CL3 and the third magnet part MN3. For example, according to an embodiment, rolling for OIS driving may be achieved by electromagnetic force between the third coil part CL3 and the third magnet part MN3. Preferably, in the embodiment, 3-axis OIS driving can be possible by the first coil part CL1, the second coil part CL2, the third coil part CL3, the first magnet part MN1, the second magnet part MN2, and the third magnet part MN3.

Meanwhile, the first magnet part MN1 and the second magnet part MN2 in the embodiment may also perform an AF driving function as will be described later. For example, a part of the first magnet part MN1 may contribute to OIS driving for yawing, and another part of the first magnet part MN1 may contribute to AF driving. For example, part of the second magnet part MN2 may contribute to OIS driving for pitching, and another part of the second magnet part MN2 may contribute to AF driving.

At this time, the first coil part CL1 and the first magnet part MN1 can be referred to as a first driving part. In addition, the second coil part CL2 and the second magnet part MN2 may be referred to as a second driving part. In addition, the third coil part CL3 and the third magnet part MN3 may be referred to as a third driving part.

Next, FIG. 2A is a bottom view of the camera module according to the embodiment shown in FIG. 1B.

Referring to FIG. 2A, the camera module 1000 according to an embodiment includes the main substrate 50, a wiring substrate 500 disposed on the main substrate 50, and a sensor substrate 550 disposed on the wiring substrate 500.

The wiring substrate 500 can include a first wiring frame 510 electrically connected to the main substrate 50. In addition, the wiring substrate 500 can include a second wiring frame 520 on which the sensor substrate 550 is disposed. At this time, the first wiring frame 510 and the second wiring frame 520 may be spaced apart from each other at a predetermined distance. For example, an open region (not shown) may be formed between the first wiring frame 510 and the second wiring frame 520. In addition, the wiring substrate 500 may include a wiring pattern part 530 that electrically connects the first wiring frame 510 and the second wiring frame 520. The wiring pattern part 530 may be disposed in the open region between the first wiring frame 510 and the second wiring frame 520. The wiring pattern part 530 may have elasticity. For example, the wiring pattern part 530 may be a spring-type elastic wiring pattern part, but is not limited thereto.

The wiring pattern part 530 can have elastic and flexible characteristics, can have a bent shape, and can connect the first wiring frame 510 and the second wiring frame 520.

The first wiring frame 510 and the second wiring frame 520 can have a polygonal shape. For example, the first wiring frame 510 and the second wiring frame 520 can have a rectangular shape, but are not limited thereto. As another example, the first wiring frame 510 and the second wiring frame 520 may have a circular shape.

The wiring pattern part 530 can be formed in plurality. For example, the wiring pattern part 530 may be formed in two, three, four or more to connect a plurality of sides of the first wiring frame 510 and the second wiring frame 520, respectively, but it is not limited thereto.

The main substrate 50 can have a substrate through-hole 50H at its center. The size of the substrate through-hole 50H can be larger than the size of the second wiring frame 520 and can be smaller than the size of the first wiring frame 510. Also, the size of the substrate through-hole 50H can be smaller than that of the sensor substrate 550.

A part of the lower surface of the sensor substrate 550 can be exposed through the substrate through-hole 50H, and the second wiring frame 520 can be space-movable through the substrate through-hole 50H.

In addition, the embodiment can include a gyro sensor (not shown) disposed on the main substrate 50 to sense motion and a driving circuit element (not shown) driven according to input/output signals of the gyro sensor.

The gyro sensor of the embodiment may employ a 2-axis gyro sensor that detects two rotational motion amounts of pitch and yaw, which represent large motions in a two-dimensional image frame. Furthermore, the gyro sensor may employ a 3-axis gyro sensor that detects all movement amounts of pitch, yaw, and roll for more accurate image stabilization. Movements corresponding to pitch, yaw, and roll detected by the gyro sensor can be converted into appropriate physical quantities according to a hand-shaking correction method and a correction direction.

Alternatively, the embodiment may include a position detection sensor (not shown) that detects an amount of yaw movement, an amount of pitch movement, and an amount of roll movement, respectively. The position detection sensor may be implemented as a Hall sensor. For example, a plurality of Hall sensors may be disposed on the coil substrate 52. For example, a first Hall sensor may be disposed in an inner region of the first coil part CL1 disposed on the coil substrate 52. The first Hall sensor can detect a change in magnetic force due to movement of the first magnet part MN1. For example, a second Hall sensor may be disposed in an inner region of the second coil part CL2 disposed on the coil substrate 52. The second Hall sensor can detect a change in magnetic force due to movement of the second magnet part MN2. For example, a third Hall sensor may be disposed in an inner region of the third coil part CL3 disposed on the coil substrate 52. The third Hall sensor can detect a change in magnetic force due to movement of the third magnet part MN3.

Next, FIG. 2B is a perspective view in which the wiring substrate 500, the sensor substrate 550, and the image sensor 60 are disposed in the camera module according to the embodiment shown in FIG. 2A.

For example, FIG. 2B shows perspective view of the wiring substrate 500, the sensor substrate 550 disposed on the wiring substrate 500, and the image sensor 60 disposed on the sensor substrate 550 in the camera module according to the embodiment shown in FIG. 2A.

Also, FIG. 2C is an exploded perspective view of the wiring substrate 500, the sensor substrate 550, and the image sensor 60 shown in FIG. 2B, and FIG. 2D is a bottom view of FIG. 2B.

On the other hand, one of the technical problems of the embodiment is that when the size of the image sensor increases, the spring stiffness of the sensor wiring structure for shifting and tilting the image sensor for OIS implementation increases. Accordingly, it is intended to provide the lens driving device and the camera module including the same that can solve the technical problem of requiring more force for image sensor shift or tilting driving for OIS driving.

Hereinafter, technical features of an embodiment for solving the above technical problem will be described with reference to FIG. 2C.

Referring to FIG. 2C, the camera module 1000 according to the embodiment can include a wiring substrate 500, a sensor substrate 550 disposed on the wiring substrate 500, and an image sensor 60 disposed on the sensor substrate 550.

The wiring substrate 500 can include a first wiring frame 510 electrically connected to the main substrate 50, a second wiring frame 520 on which the sensor substrate 550 is disposed, and a wiring pattern part 530 electrically connecting the first wiring frame 510 and the second wiring frame 520.

In an embodiment, a first size D1 of the sensor substrate 550 can be larger than a second size D2 of the second wiring frame 520. Also, a size of the image sensor 60 can be smaller than the first size D1 of the sensor substrate 550 and larger than the second size D2 of the second wiring frame 520.

In the embodiment, the size of each component can be a horizontal length in the first axis direction, but is not limited thereto.

According to the lens driving device and the camera module including the same according to the embodiment, when the size of the image sensor increases, the spring rigidity of the sensor wiring structure for shifting and tilting the image sensor for implement OIS increases. Accordingly, a technical contradiction arises in that more force is required for shifting or tilting the image sensor for OIS driving. Embodiments may provide the lens driving device capable of solving these technical contradictions and the camera module including the same.

For example, in the embodiment, as the size of the image sensor 60 increases, the first size D1 of the sensor substrate 550 on which the image sensor 60 is mounted may increase. At this time, in the embodiment, a second wiring frame 520 electrically connected to the sensor substrate 550 is provided. The second size D2 of the second wiring frame 520 can be controlled to be smaller than the first size D1 of the sensor substrate 550 and the image sensor 60. The second wiring frame 520 may connect directly with wiring pattern part 530.

Accordingly, even if the size of the image sensor 60 increases, a size of the second wiring frame 502 connected with wiring pattern part 530 may not increase, so the wiring pattern part 530 can be designed to be long, and accordingly the length of the wiring pattern part 530 can be provided long, therefore the spring rigidity of the wiring pattern part 530 can be reduced.

Therefore, in the embodiment, even if the size of the image sensor increases, the length of the wiring pattern part 530 can be secured without increasing the size of the camera module, so the spring stiffness of the sensor wiring structure for shifting and tilting the image sensor for OIS implementation can be controlled to be small.

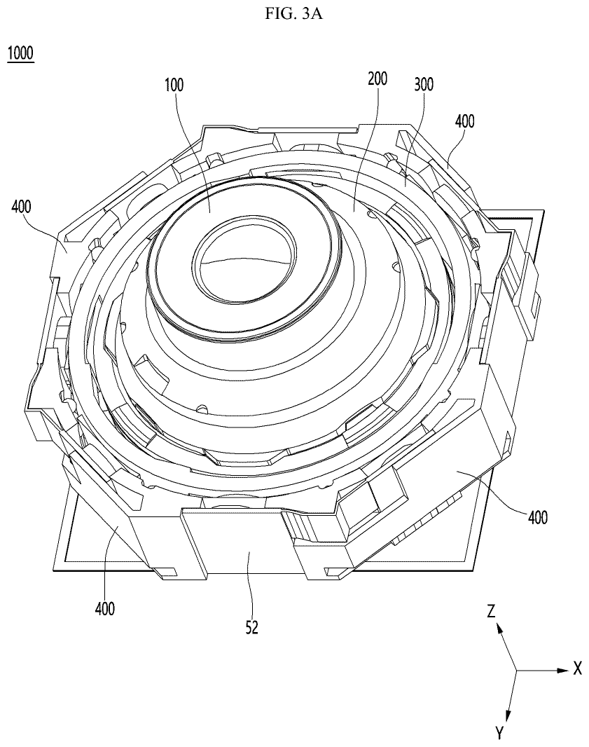

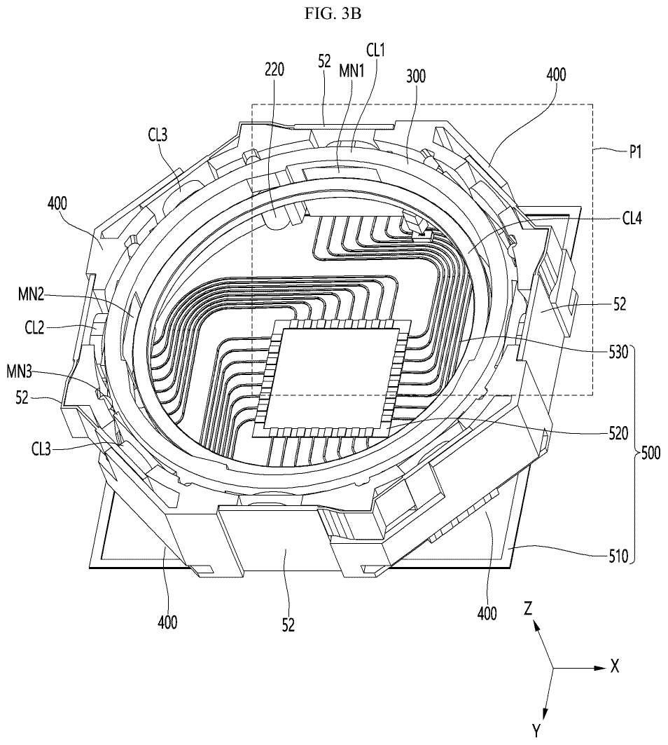

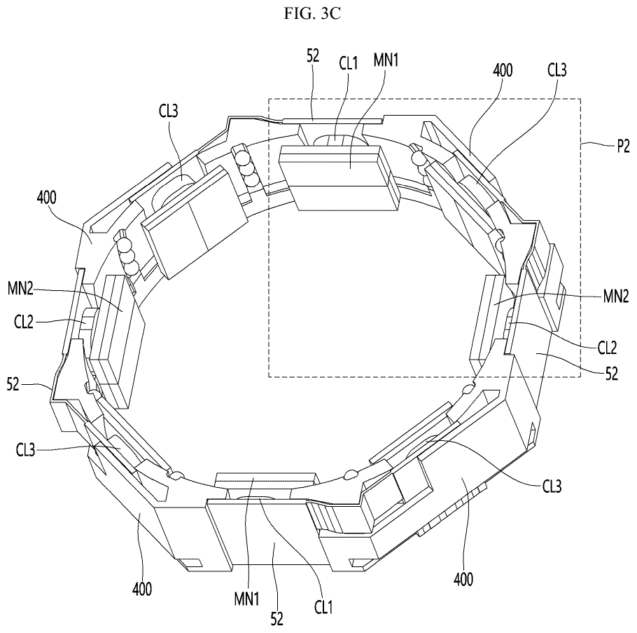

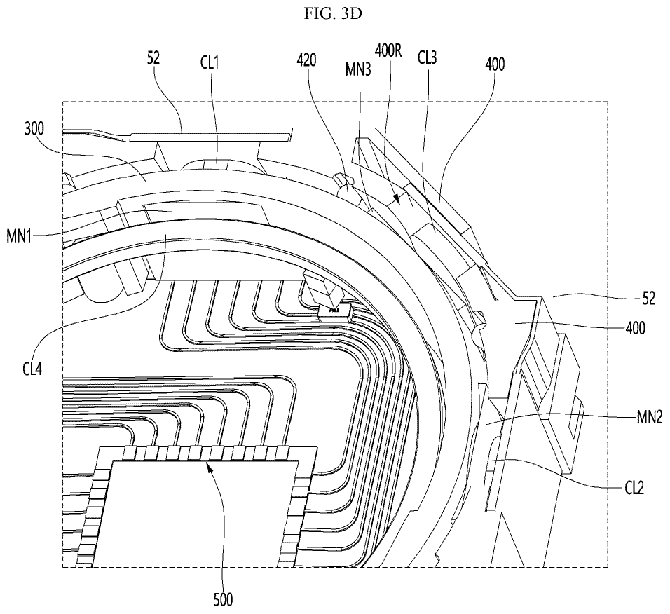

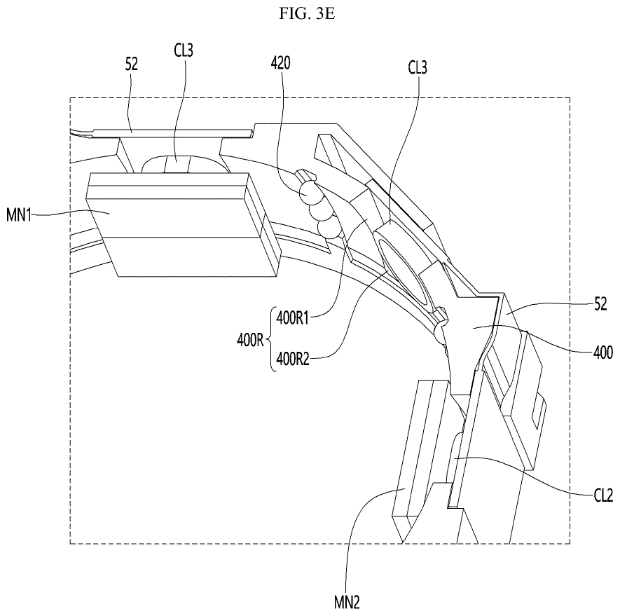

Next, the OIS driving of the embodiment will be described with reference to FIGS. 3A to 3C. FIG. 3A is a view in which the main substrate 50 is omitted from the camera module according to the embodiment shown in FIG. 1A, and FIG. 3B is a detailed view in which the bobbin 100, the lens 100, the image sensor 60, and the sensor substrate 550 are omitted in FIG. 3A.

Also, FIG. 3C is a detailed view in which the first housing 300, the first guide member 220, and the wiring substrate 500 are omitted in FIG. 3B.

First, referring to FIG. 3A, the camera module 1000 according to the embodiment can include a first housing 300 on which a bobbin 200 is disposed and a second housing 400 on which the first housing 300 is disposed.

Next, referring to FIG. 3B based on FIG. 3A, the embodiment can include a wiring substrate 500 electrically connected to the main substrate 50 and disposed below the second housing 400.

The camera module 1000 according to the embodiment can be a module tilting method in which a lens 100 and an image sensor 60 move integrally to implement OIS.

Through this, the embodiment can operate OIS by moving the entire module including the lens and the image sensor, so the correction range is wider than that of the existing lens movement method. Also, since the optical axis of the lens and the axis of the image sensor are not twisted there is a technical effect without distortion of the image by minimizing the deformation of the image.

Referring to FIG. 3B, the wiring substrate 500 can include a first wiring frame 510 electrically connected to the main substrate 50. The wiring substrate 500 can include a second wiring frame 520 electrically connected to the image sensor 60. The wiring substrate 500 can include a wiring pattern part 530 connecting the first wiring frame 510 and the second wiring frame 520.

The first wiring frame 510 and the second wiring frame 520 can be a rigid printed circuit board (Rigid PCB) but is not limited thereto. The wiring pattern part 530 can be a flexible printed circuit board (Flexible PCB) or a rigid printed circuit board (Rigid Flexible PCB), but is not limited thereto.

The wiring pattern part 530 can be disposed in a curved shape in the form of a flexible printed circuit board.

Next, referring to FIGS. 3B and 3C together, the embodiment can include a plurality of coil substrates 52.

For example, the coil substrates 52 can be disposed in each of the four parts of the second housing 400, and the second and third coil parts CL2 and CL3 are disposed on each of the coil substrate 52, respectively, but is not limited thereto.

Referring to FIG. 3B, the first housing 300 may have a circular shape. Also, the first magnet part MN1, the second magnet part MN2, and the third magnet part MN3 may be respectively disposed in the first housing 300.

According to the embodiment, the OIS can be driven by a first electromagnetic force between the first magnet part MN1 and the first coil part CL1, a second electromagnetic force between the second magnet part MN2 and the second coil part CL2, and a third electromagnetic force between the third magnet part MN3 and the third coil part CL3.

Specifically, according to the embodiment, a yaw OIS can be driven by the first the electromagnetic force between the first magnet part MN1 and the first coil part CL1. In addition, according to the embodiment, a pitch OIS can be driven by the second electromagnetic force between the second magnet part MN2 and the second coil part CL2. In addition, according to the embodiment, a roll OIS can be driven by the third electromagnetic force between the third magnet part MN3 and the third coil part CL3.

In the OIS drive in the embodiment, the first housing 300 may rotate in pitch or yaw or roll relative to the second housing 400 by a second guide member 420 disposed between the first housing 300 and the second housing 400.

For example, in an embodiment, an outer surface of the first housing 300 may include a curved surface. For example, the outer surface of the first housing 300 may include a curved surface in which a central portion is convex outward from an upper and/or lower portion. For example, in an embodiment, the inner surface of the second housing 400 corresponding to the outer surface of the first lower housing 300 may include a curved surface. For example, the inner surface of the second housing 400 may include a curved surface in which a central portion is convex outward (specifically, in a direction away from the outer surface of the first housing) from an upper and/or lower portion. In an embodiment, OIS may be implemented through the curved surface of the outer surface of the first housing 300 and the curved surface of the inner surface of the second housing 400.

For example, referring to FIG. 3C, the inner surface of the second housing 400 can include a curved surface in which the central portion is convex outward than the upper and lower portions. A second guide member 420 is disposed, so that the first housing 300 can be rotated in pitch or yaw or roll relative to the second housing by the module rotational movement of the first housing 300.

For example, referring to FIG. 3B, in the embodiment, the first housing 300 includes an outer surface (not shown) of the first housing 300 facing the second housing 400, and the second housing 400 can include an inner surface (not shown) of the second housing facing the first housing 300.

The outer surface of the first housing and the inner surface of the second housing can include curved surfaces in which a central portion is convex outward than upper and lower portions. In the embodiment, OIS implementation can be possible through a curved surface.

Referring also to FIG. 3C, the embodiment can include a second guide member 420 disposed between the outer surface of the first housing and the inner surface of the second housing. In the embodiment, the first guide member 220 and the second guide member 420 can have different shapes. For example, the first guide member 220 can have a cylindrical shape, and the second guide member 420 can have a ball shape. The second guide member 420 can be a ball bearing, but is not limited thereto.

In addition, according to the embodiment, a fourth coil part CL4 may be disposed on the bobbin 200. The fourth coil part CL4 may be disposed around the bobbin 200. The fourth coil part CL4 may correspond to the first magnet part MN1, the second magnet part MN2, and the third magnet part MN3. For example, in an embodiment, the AF driving may be possible along the first guide part 200 by mutual electromagnetic force between a part of the first magnet part MN1 or a part of the second magnet part MN2 and the fourth coil part CL4.

According to the lens driving device and the camera module including the same according to the embodiment, relative position detection errors can be resolved when pitch, yaw, and roll are implemented in OIS implementation.

For example, in an embodiment, the first magnet part MN1 for implementing the yaw, the second magnet part MN2 for implementing the pitch, and the third magnet part MN2 for implementing the roll MN3 can be arranged at the same distance based on the center of the rotation axis.

For example, the first magnet part MN1 rotates the lens 100 or the bobbin 200 around the first axis. In addition, the second magnet part MN2 rotates the lens 100 or the bobbin 200 around the second axis. In addition, the third magnet part MN3 rotates the lens 100 or bobbin 200 around the third axis. At this time, a center of the first axis, a center of the second axis, and a center of the third axis may be the same. For example, the center of the first axis may correspond to the center of the second axis and the center of the third axis. At this time, the center of the first axis, the center of the second axis, and the center of the third axis may mean the center of the lens 100 or the bobbin 200. Hereinafter, the center of the first axis, the center of the second axis, the center of the third axis, and further, the center of the lens 100 or the bobbin 200 will be described as the center of the rotation axis.

For example, according to the embodiment, the first magnet part MN1, the second magnet part MN2, and the third magnet part MN3 are disposed on the outer surface of the first housing 300, respectively. At this time, the center of the first housing 300 may also be referred to as the center of the lens 100, the center of the bobbin 200, or the center of the rotation axis. In addition, the embodiment allows each of the first magnet part MN1, the second magnet part MN2 and the third magnet part MN3 disposed in the first housing 300 to be disposed at the same distance from the center of the rotation axis. Accordingly, the embodiment allows the distance of the driving points of each of the first magnet part MN1, the second magnet part MN2, and the third magnet part MN3 to be the same, and thereby minimizing mutual interference.

For example, in the comparative example, the third magnet part MN3 is disposed farther from the center of the rotation axis compared to the first magnet part MN1 and the second magnet part MN2. Accordingly, in the comparative example, when yaw and/or pitch are implemented by the first magnet part MN1 and/or the second magnet part MN2, a position detection error occurred for the roll implementation. For example, in the comparative example, when yaw and/or pitch are implemented, even though the roll has not been substantially implemented, a change in the sensing value detected by the third hall sensor occurs. At this time, in the comparative example, as the third magnet part MN3 is disposed farther from the center of the rotation axis compared to the first magnet part MN1 and the second magnet part MN2, when yaw or pitch is implemented by the first magnet part MN1 and the second magnet part MN2, the position of the third Hall sensor is greatly spaced from the center of the third magnet part MN3. Accordingly, in the comparative example, even though roll was not implemented (for example, roll rotation angle=0°), the position of the third Hall sensor is greatly spaced from the center of the third magnet part MN3, and accordingly, the sensing value by the third Hall sensor changes. In addition, in the comparative example, there is a problem that the accuracy of OIS driving is reduced due to a change in the sensing value by the third Hall sensor.

In contrast, in the embodiment, the first magnet part MN1, the second magnet part MN2, and the third magnet part are disposed at the same distance from each other based on the center of the rotation axis in the first housing 300. Accordingly, the embodiment allows the movement distance of each magnet part with respect to a rotation radius to be the same, and the influence of each axis accordingly can be interpreted equally. Accordingly, the embodiment can secure the linearity of the output value of each Hall sensor with respect to the rotation radius, thereby improving OIS implementation accuracy, and further improving operation reliability.

In addition, the embodiment allows the first magnet part MN1, the second magnet part MN2, and the third magnet part MN3 for rotating the lens 100 or bobbin about different axes to have the same size. For example, in the comparative example, the size of the third magnet part MN3 is formed to be small compared to the sizes of the first magnet part MN1 and the second magnet part MN2. Accordingly, when the lens 100 is rotated by the first magnet part MN1 and the second magnet part MN2, in the comparative example, it is impossible to interpret the change in position of the third magnet part MN3. For example, as described above, in the comparative example, it is impossible to interpret how the yaw or pitch implementation by the first magnet part MN1 or second magnet part MN2 affects the change in position of the third magnet part MN3.

In contrast, in the embodiment, the first magnet part MN1, the second magnet part MN2, and the third magnet part MN3 are arranged at the same distance from each other around the rotation axis, and furthermore, they have the same size. Accordingly, in the embodiment, a movement distance of each magnet part with respect to the rotation radius is the same, so that the influence of each axis can be equally analyzed, thereby ensuring linearity of the sensing value of the Hall sensor. Furthermore, the embodiment can effectively reduce the change in Hall sensing range according to the rotation radius and further minimize the influence of other axes (cross-talk). This will be explained in more detail below.

In addition, as described above, according to the embodiment, even if the size of the image sensor 60 increases, the size of the second wiring frame 520 connected to the wiring pattern part 530 may not increase. Because of this, since the length of the wiring pattern part 530 directly connected to the second wiring frame 520 can be designed to be long, the spring rigidity of the wiring pattern part 530 can be reduced.

Therefore, the embodiment can solve the technical problem of requiring more force for image sensor shift or tilting driving for OIS driving when the size of the image sensor increases, when the spring stiffness of the sensor wiring structure for shifting and tilting the image sensor for OIS implementation increases.

Next, FIG. 3D is an enlarged view of the first area P1 in FIG. 3B, and FIG. 3E is an enlarged view of the second area P2 in FIG. 3C. Also, FIG. 3F is an enlarged view of the second housing 400 in FIG. 3E.

Referring to FIG. 3D, in the OIS drive in the embodiment, the first housing 300 may pitch or yaw or roll rotate relative to the second housing 400 by the second guide member 420 disposed between the first housing 300 and the second housing 400.

For example, in the embodiment, the yaw OIS can be driven by the electromagnetic force between a part of the first magnet part MN1 and the first coil part CL1. For example, in the embodiment, the pitch OIS can be driven by the electromagnetic force between a part of the second magnet part MN2 and the second coil part CL2. For example, in the embodiment, the roll OIS can be driven by the electromagnetic force between a part of the third magnet part MN3 and the third coil part CL3.

Accordingly, in the OIS drive in the embodiment, the first housing 300 may pitch or yaw or roll rotate relative to the second housing 400 by the second guide member 420 disposed between the first housing 300 and the second housing 400.

Also, according to the embodiment, AF can be driven along the first guide part 200 by mutual electromagnetic force between another part of the first magnet part MN1, another part of the second magnet part MN2, and the fourth coil part CL4 disposed around the bobbin 200.

In addition, the embodiment can solve the problem of deteriorating the reliability of the camera module when an external shock or the like occurs in OIS implementation.

For example, in an embodiment, the first housing 300 may include at least one protruding part (not shown). In addition, the first housing 300 may include a housing groove 400R. The third coil part CL3 disposed on the coil substrate 52 may be disposed in the housing groove 400R. At this time, in the embodiment, the protruding part (not shown) formed on the first housing 300 contacts the housing groove 400R when the first housing 300 moves relative to the second housing 400, and accordingly the embodiment can have a technical effect of implementing a stopper function related to a 3-axis OIS.

Specifically, referring to FIG. 3E, the housing groove 400R can include a groove sidewall portion 400R1 and a groove bottom portion 400R2. The groove sidewall portion 400R1 and the groove bottom portion 400R2 may be disposed to surround the side and lower portions of the third coil part CL3 disposed on the coil substrate 52. For example, the groove sidewall portion 400R1 and the groove bottom portion 400R2 may be spaced apart from the side and lower portions of the third coil portion CL3 disposed on the coil substrate 52 by a certain distance. In addition, the groove side wall portion 400R1 may function as a stopper during roll rotation, and the groove bottom portion 400R2 may function as a stopper during yaw or pitch rotation, but is not limited thereto. Also, the groove bottom portion 400R2 may function as a stopper during AF operation.

Also, in the embodiment, the second guide member 420 can be disposed adjacent to the housing groove 400R, which is a stopper structure.

Also, in the embodiment, the second guide member 420 can be disposed symmetrically left and right with respect to the housing groove 400R. Through this, the OIS function can be stably implemented.

Also, in the embodiment, the first guide member 220 can be disposed to overlap the second guide member 420 in the radial direction about the optical axis.

As described above, according to the embodiment, the second housing 400 has a technical effect of functioning as a stopper while accommodating the third coil part CL3 and the like.

Also, according to an embodiment, the second magnet part MN2 can be disposed closer to the second coil part CL2 than to the housing groove 400R.

Next, referring to FIG. 3F, the second housing 400 can include a housing body 410, a guide groove 420G disposed on the housing body 410, and a housing side wall 425 extending and disposed outside the housing body 410. A housing hole 420H can be provided between the housing sidewall 425 and the housing body 410.

A second guide member 420 can be disposed in the guide groove 420G so that OIS can be realized. In addition, the coil substrate 52 can be disposed in the housing hole 420H. In addition, the third coil part CL3 disposed on the coil substrate 52 may be disposed in the housing groove 400R.

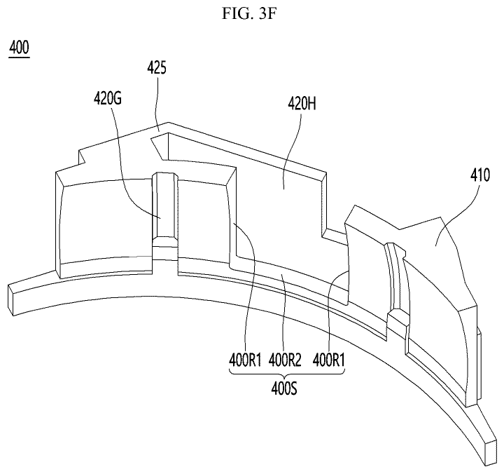

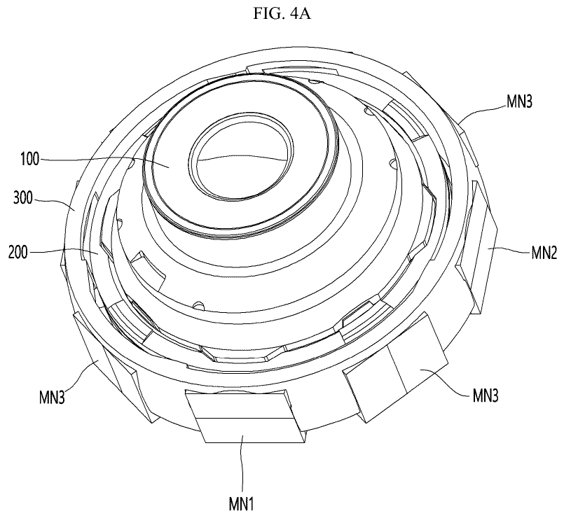

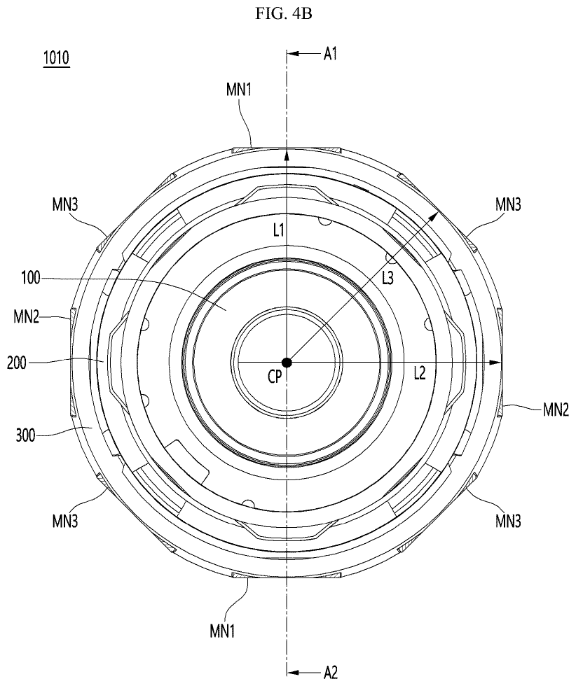

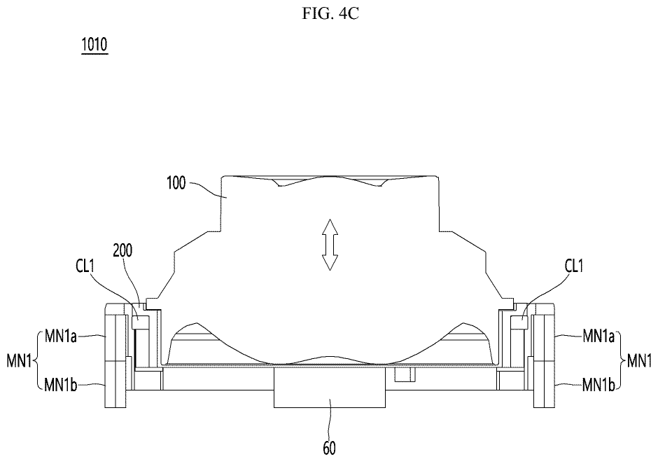

Next, FIG. 4A is a perspective view of the lens driving device 1010 in the camera module according to the embodiment shown in FIG. 3A.

Referring to FIG. 4A, a lens driving device 1010 according to an embodiment can include a bobbin 200 on which a lens 100 is disposed, a first housing 300 on which the bobbin 200 is disposed, and a first guide member 220 disposed between the first housing 300 and the bobbin 200.

In an embodiment, the yaw OIS may be driven by electromagnetic force between a part of the first magnet part MN1 and the first coil part CL1. For example, in an embodiment, the pitch OIS can be driven by electromagnetic force between a part of the second magnet part MN2 and the second coil part CL2. In addition, in an embodiment, the roll OIS can be driven by electromagnetic force between the third magnet part MN3 and the third coil part CL3.

Accordingly, in the OIS driving in the embodiment, the first housing 300 may rotate in pitch, yaw, or roll relative to the second housing 400 by the second guide member 420 disposed between the first housing 300 and the second housing 400.

In addition, according to the embodiment, the AF can be driven along the first guide part 200 by the mutual electromagnetic force between another part of the first magnet part MN1 and another part of the second magnet part MN2 and the fourth coil part CL4 disposed around the bobbin 200.

Next, FIG. 4B is a plan view of the lens driving device 1010 according to the embodiment shown in FIG. 4A, and FIG. 4C is a cross-sectional view taken along the line A1-A2 of the lens driving device 1010 according to the embodiment shown in FIG. 4B.

As shown in FIG. 4B, the first magnet part MN1, the second magnet part MN2, and the third magnet part MN3 are disposed in the first housing 300. The first magnet part MN1 may be arranged in the second axis direction based on the rotation axis center CP. The first magnet part MN1 can rotate or tilt the lens 100 using the first axis as a rotation axis. The second magnet part MN2 may be arranged in the first axis direction based on the rotation axis center CP. The second magnet part MN2 can rotate or tilt the lens 100 using the second axis as a rotation axis. The third magnet part MN3 may be arranged in the diagonal direction between the first axis and the second axis based on the rotation axis center CP. The third magnet part MN3 can rotate or tilt the lens 100 using the third axis as a rotation axis.

At this time, the first magnet part MN1 may be spaced apart from the rotation axis center CP by a first distance L1. In addition, the second magnet part MN2 may be spaced apart from the rotation axis center CP by a second distance L2. In addition, the third magnet part MN3 may be spaced apart from the rotation axis center CP by a third distance L3. At this time, the first distance L1, the second distance L2, and the third distance L3 may be the same. Furthermore, in the embodiment, the sizes of the first magnet part MN1, the second magnet part MN2, and the third magnet part MN3 may be the same.

For example, the first magnet part MN1 includes a plurality of first magnets facing each other. In addition, the second magnet part MN2 includes a plurality of second magnets facing each other. In addition, the third magnet part MN3 includes a plurality of third magnets facing each other. At this time, in the embodiment, the distance between the plurality of first magnets, the distance between the plurality of second magnets, and the distance between the plurality of third magnets may be the same. Accordingly, in the embodiment, the first magnet part MN1, the second magnet part MN2, and the third magnet part MN3 are arranged to be spaced apart from each other at the same distance from the center of the rotation axis, so that the rotation radii of the rotation axes are the same, and thereby improving OIS reliability.

As shown in FIG. 4C, AF driving is possible by the interaction between the first magnet part MN1 and the fourth coil part CL4 disposed on the bobbin 200. Also, a lens 100 may move up and down in the direction of the optical axis or third axis or Z-axis, and can be controlled the distance to the image sensor 60 according to the movement of the bobbin 200.

In this case, the first magnet part MN1 can include a positively magnetized magnet.

For example, the first magnet part MN1 can include a first-first magnet MN1a and a first-second magnet MN1b. The first-first magnet MN1a can be disposed to face the fourth coil part CL4.

In the embodiment, AF driving can be possible as long as the vertical width of the first-first magnet MN1a, but is not limited thereto. The first-second magnets MN1b may contribute to driving the OIS by interacting with the first coil part CL1.

Also, the first-first magnet MN1a may contribute to driving the OIS by interacting with the first coil part CL1. That is, the first-first magnet MN1a can be a magnet for both AF driving and OIS, but is not limited thereto.

Meanwhile, the second magnet part MN2 may have a structure corresponding to the first magnet part MN1. For example, the second magnet part MN2 may include a positively magnetized magnet, and thus may include a second-first magnet (not shown) and a second-second magnet (not shown).

At this time, each of the first magnet part MN1 and the second magnet part MN2 may have a positively magnetized magnet disposed in the third axis direction, optical axis direction, or z-axis direction.

Meanwhile, the third magnet part MN3 may also include a positively magnetized magnet, and accordingly may include a third-first magnet (not shown) and a third-second magnet (not shown). At this time, the third-first magnet and the third-second magnet of the third magnet part MN3 may be arranged in the horizontal direction, unlike the first magnet part MN1 and the second magnet part MN2.

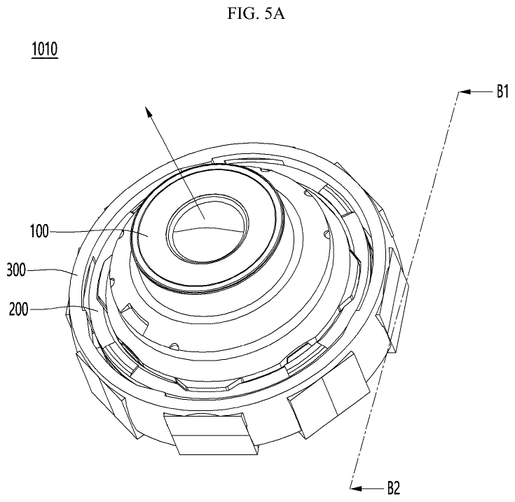

Next, FIG. 5A is a perspective view of the lens driving device 1010 according to the embodiment shown in FIG. 3A, and FIG. 5B is a cross-sectional side view of the lens driving apparatus 1010 according to the embodiment shown in FIG. 5A perpendicularly to the z-axis taken along line B1-B2.

Referring to FIG. 5B, the lens driving device 1010 according to the embodiment can include a bobbin 200 on which the lens 100 is disposed and a first housing 300 on which the bobbin 200 is disposed. Furthermore, the lens driving device 1010 can include a first guide member 220 disposed between the first housing 300 and the bobbin 200.

The first guide member 220 can be disposed in plurality. For example, the first guide member 220 can be provided four disposed between the bobbin 200 and the first housing 300, but is not limited thereto.

The first guide member 220 can have a shaft shape, but is not limited thereto.

Referring to FIG. 5B, the bobbin 200 of the embodiment can include a second recess 200R2 in a region corresponding to the first magnet part MN1 and the second magnet part MN2 disposed on the first housing 300.

According to the embodiment, as the second recess 200R2 is disposed on the bobbin 200, the electromagnetic force between the first magnet part MN1 and the fourth coil part CL4 or the electromagnetic force between the second magnet part MN2 and the fourth coil part CL4 can be improved. Also, as the weight of the bobbin 200 decreases, the driving force can be improved.

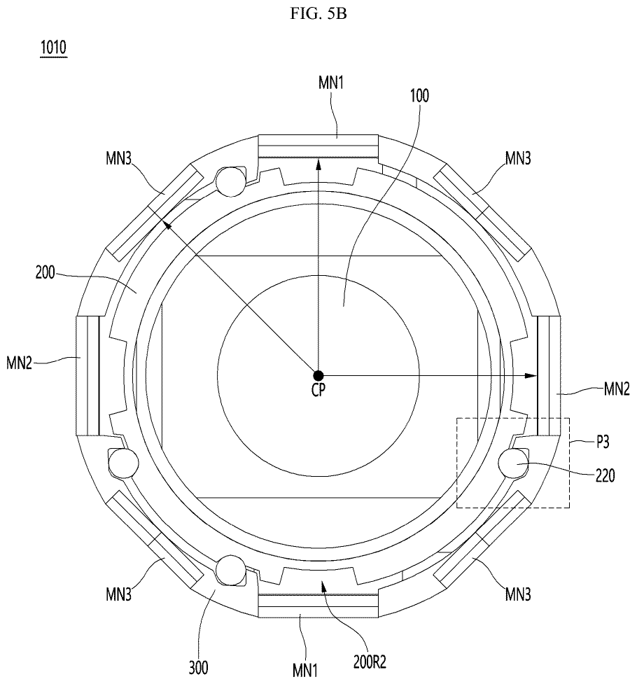

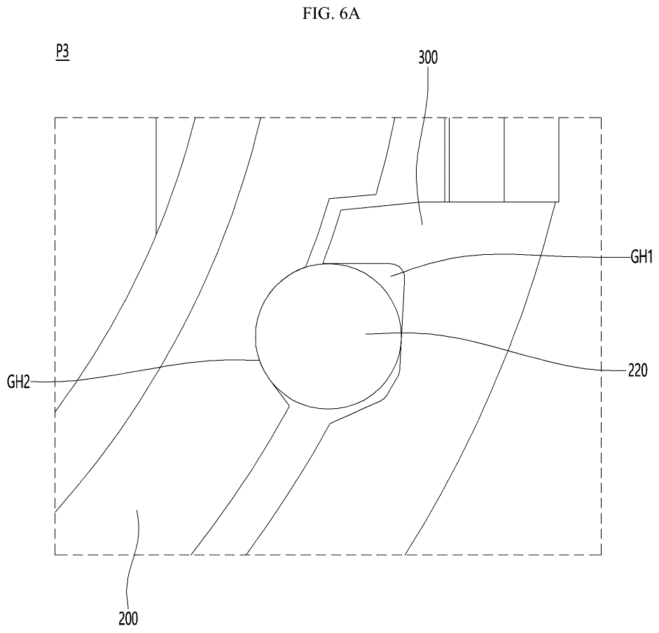

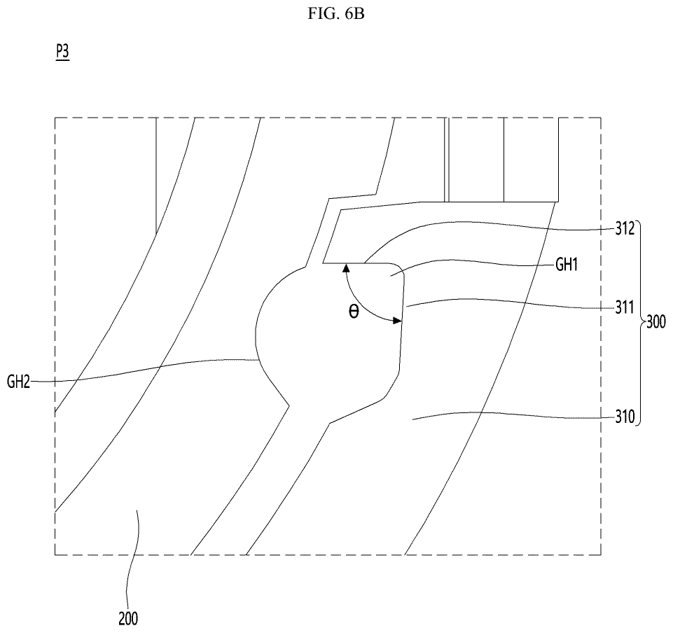

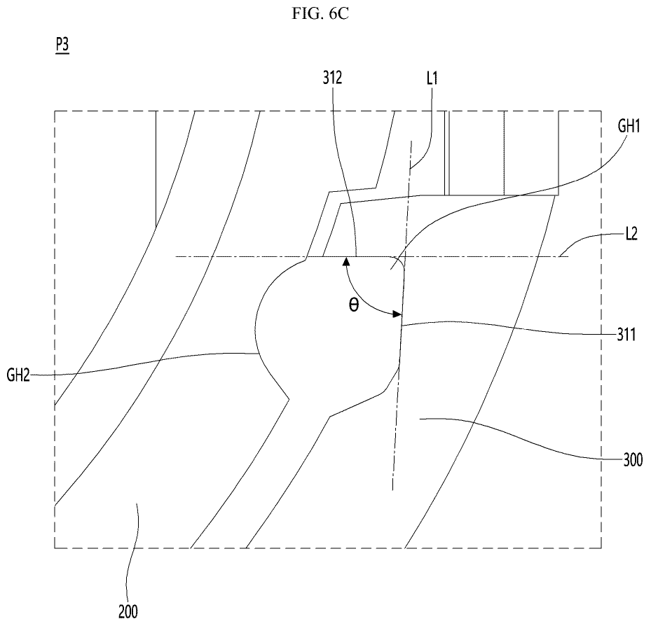

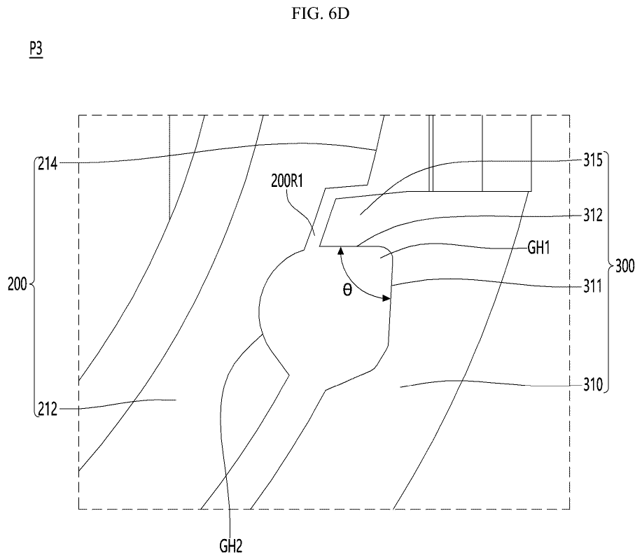

Next, FIG. 6A is an enlarged view of a third area P3 in a side cross-sectional view of the lens driving device 1010 according to the embodiment shown in FIG. 5B, FIG. 6B is a first detailed view of FIG. 6A, and FIG. 6C is a second detail view of FIG. 6A, and FIG. 6D is a third detail view of FIG. 6A.

For example, FIG. 6B is a first detailed view in which the first guide member 220 is omitted from the enlarged view of the third area P3 in the side cross-sectional view of the lens driving device 1010 according to the embodiment shown in FIG. 6A, FIG. 6C is a second detailed view in which the first guide member 220 is omitted from the enlarged view of the third area P3 in the side cross-sectional view of the lens driving device 1010 according to the embodiment shown in FIG. 6A.

First, referring to FIG. 6A, in the embodiment, the first housing 300 can have a first guide groove GH1 in which the first guide member 220 is disposed. The first guide groove GH1 can have an asymmetrical shape.

Also, the bobbin 200 can have a second guide groove GH2 in which the first guide member 220 is disposed. The second guide groove GH2 can have a shape corresponding to the outer circumferential surface of the first guide member 220. For example, the second guide groove GH2 can have a curved shape corresponding to the outer circumferential surface of the first guide member 220.

Specifically, referring to FIG. 6B, the first housing 300 includes a first hollow housing frame accommodating the bobbin 200. The first guide groove GH1 can be formed inside the first housing frame of the first housing 300.

The first guide groove GH1 can include a first guide surface 311 and a second guide surface 312 that can contact the first guide member 220. The first guide surface 311 and the second guide surface 312 may be an acute angle Θ.

In addition, the first guide groove GH1 can include a first guide surface 311 and a second guide surface 312 that may contact the first guide member 220. The first guide surface 311 and the second guide surface 312 can be flat.

According to the lens driving device and the camera module including the same according to the embodiment, it is possible to solve the technical problem of separation of the lens driving device when an impact is applied to the camera module.

For example, in the embodiment, the first guide member 220 for AF driving of the lens is disposed between the first guide groove GH1 and the second guide groove GH2, and the first guide groove GH1 and the second guide groove GH2 may function as a guide rail.

According to the embodiment, since the first guide groove GH1 in which the first guide member 220 is disposed has an asymmetrical shape, it is possible to inhibit the first guide member 220 from being separated even when an impact or the like occurs. Also, there is a technical effect that can provide a movement path through which the lens can move with minimal friction.

In addition, in the embodiment, the angle Θ formed by the first guide surface 311 and the second guide surface 312 can be an acute angle, and through this, even if an impact or the like occurs, there is a technical effect that can inhibit separation of the first guide member 220.

Specifically, referring to FIG. 6C, based on a first line L1 extending from the first guide surface 311 in the first guide groove GH1 and a second line L2 extending from the second guide surface 312, the angle Θ formed by the first guide surface 311 and the second guide surface 312 can be an acute angle.

The first line L1 and the second line L2 can be one of tangential lines to the first guide member 220.

According to the embodiment, by controlling the angle formed between the first guide surface 311 and the second guide surface 312 in the first guide groove GH1 of the first housing 300 to an acute angle, the technical problem of separation of the first guide member 220 when an impact is applied to the camera module can be solved.

Next, referring to FIG. 6D, the bobbin 200 can include a bobbin frame 212 in which the second guide groove GH2 is formed and a first recess 200R1 extending inwardly from the outermost periphery 214 of the bobbin frame.

The first housing 300 can include a first guide protruding part 315 protruding from the first housing frame toward the bobbin 200, and the first guide protruding part 315 can be disposed on the first recess 200R1 of the bobbin 200.

The first guide protruding part 315 can be disposed lower than the outermost periphery 214 of the bobbin 200. Through this, separation of the first guide member 220 can be effectively inhibited.

For example, the first guide protruding part 315 of the first housing 300 protrudes in the direction of the bobbin 200 and is protruded and disposed on the first recess 200R1 of the bobbin 200, thereby even in impacting circumstances, the first guide member 220 can be firmly positioned in the first guide groove GH1 and the second guide groove GH2 without being separated, and reliability can be improved by inhibiting the AF module from being separated due to impact.

In addition, according to the embodiment, it is possible to solve the technical problems of occurrence of high-frequency vibration, increase in driving resistance, and occurrence of dynamic tilt due to a preload spring structure in the AF structure.

For example, according to the embodiment, it is possible to provide a structure for moving a lens with minimal friction and tilt by removing a spring vulnerable to high-frequency vibration from an AF structure and applying a guide shaft.

For example, by adopting the first guide member 220 in the form of a guide shaft in the embodiment, it can move up and down in a point contact state with the first housing 300. Also, according to the embodiment, the first guide member 220 for AF driving can be disposed between the first guide groove GH1 and the second guide groove GH2. Accordingly, there is no vibration due to high frequency by removing the spring structure compared to the related art, and since there is no spring structure, driving resistance is reduced and power consumption is lowered. Therefore, there is a technical effect of less dynamic tilt compared to the guide bearing structure.

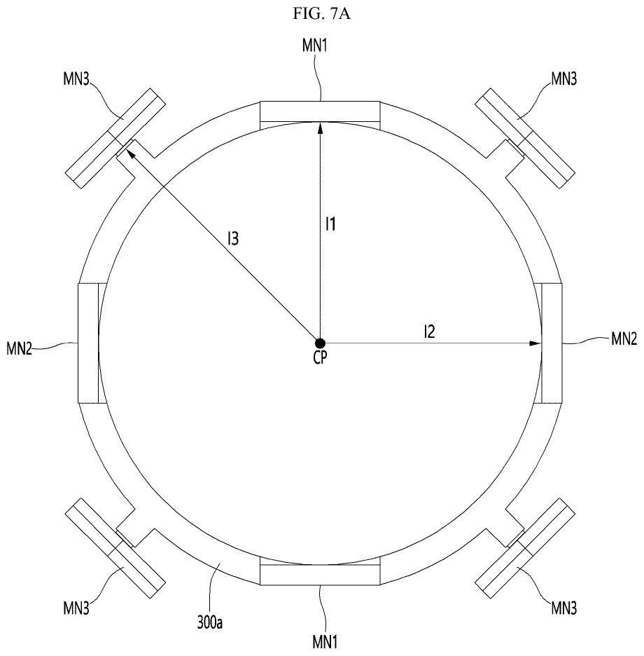

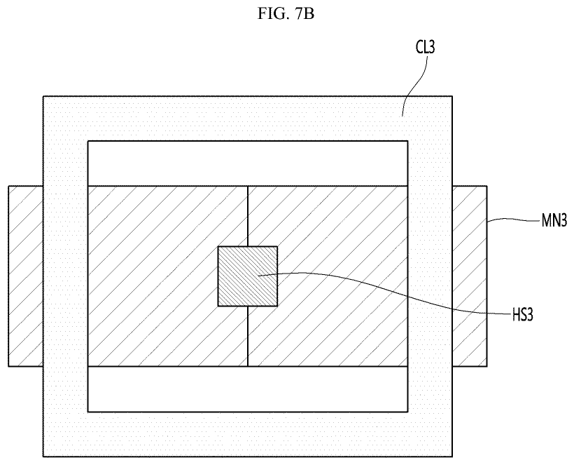

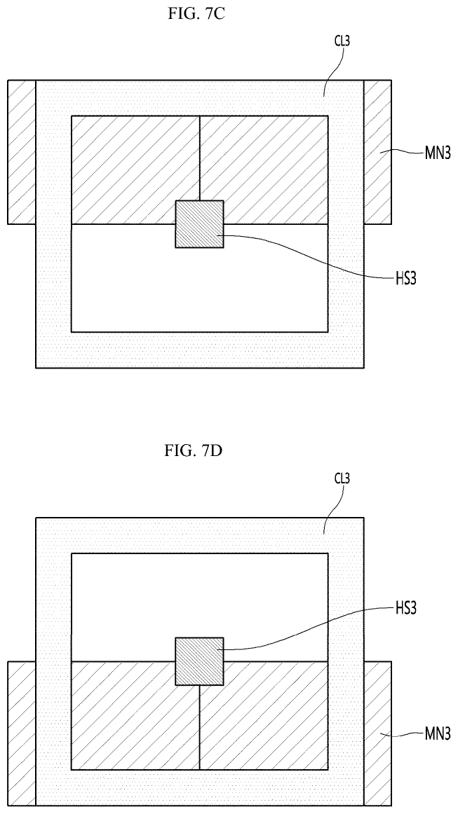

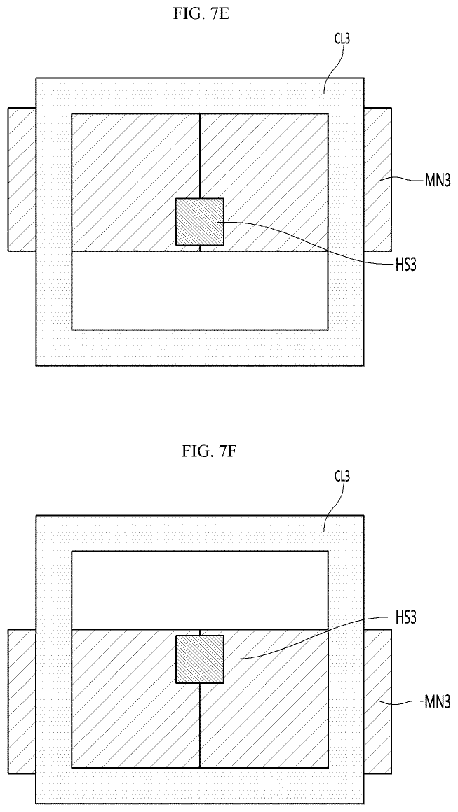

FIG. 7A is a view showing an arrangement structure of a magnet part according to a comparative example, FIG. 7B a view showing a positional relationship between a third magnet part and a third hall sensor when the OIS is generally not driven, FIGS. 7C and 7D are views schematically showing a positional relationship between the third Hall sensor and the third magnet part when OIS is driven according to a comparative example, and FIGS. 7E and 7F are views schematically showing the positional relationship between the third Hall sensor and the third magnet part when OIS is driven according to an embodiment.

Referring to FIG. 7A, in the comparative example, the first magnet part MN1, the second magnet part MN2, and the third magnet part MN3 are disposed in the first housing 300a. At this time, the first housing 300a in the comparative example has a plurality of protruding parts (not shown) protruding in an outward direction on the outside of the frame. And, in the comparative example, the first magnet part MN1 and the second magnet part MN2 are disposed on the frame of the first housing 300a. In addition, in the comparative example, the third magnet part MN3 is disposed on the protruding part of the first housing 300a. Accordingly, the first magnet part MN1 in the comparative example is arranged to be spaced apart by a first distance 11 based on the rotation axis center CP. In addition, the second magnet part MN2 in the comparative example is arranged to be spaced apart by a second distance 12 based on the rotation axis center CP. In addition, the third magnet part MN3 in the comparative example is arranged to be spaced apart by a third distance 13 based on the rotation axis center CP. At this time, the first distance 11 and the second distance 12 in the comparative example are the same. And in the comparative example, the third distance 13 is greater than the first distance 11 and the second distance 12. Specifically, in the comparative example, the third magnet part MN3 is disposed farther from the rotation axis center CP than the first magnet part MN1 and the second magnet part MN2.

Referring to FIG. 7B, the positional relationship between the third magnet part MN3 and the third hall sensor HS3 when the OIS is not driven is as follows. Here, the OIS not driven means that, with respect to the OIS, the yaw rotation angle is 0°, the pitch rotation angle is 0°, and the roll rotation angle is 0°.

At this time, when the OIS is not driven as described above, based on the direction in which the third magnet part MN3 is arranged at the center of the rotation axis CP, the third Hall sensor HS3 may be positioned to overlap the center of the third magnet part MN3.

At this time, referring to FIGS. 7C and 7D, in the comparative example, when the OIS is driven, the overlapped position of the third Hall sensor HS3 and the third magnet part MN3 may vary significantly based on the arrangement direction. For example, as in FIG. 7C, when the OIS is driven at an yaw angle or pitch angle greater than 0°, in a comparative example, the third Hall sensor HS3 moves downward based on the center of the third magnet part MN3. At this time, in the comparative example as above, the third distance 13 is greater than the first distance 11 and the second distance 12, and accordingly, the amount of downward movement of the third Hall sensor HS3 may be great. Accordingly, in the case as shown in FIG. 7C, at least a portion of the lower region of the third Hall sensor HS3 does not overlap with the third magnet part MN3 based on the arrangement direction. In addition, as shown in FIG. 7D, when the OIS is driven at a yaw or pitch angle less than 0°, the third Hall sensor HS3 moves upward based on the center of the third magnet part MN3. At this time, in the comparative example as described above, the third distance 13 is greater than the first distance 11 and the second distance 12, and accordingly, the amount of upward movement of the third hall sensor HS3 can be great. Accordingly, in the case as shown in FIG. 7D, in the comparative example, at least a portion of the upper region of the third Hall sensor HS3 does not overlap with the third magnet part MN3 based on the arrangement direction. As above, in the comparative example, the third distance L3 from the rotation axis center CP to the third magnet part MN3 is greater the first distance L1 from the rotation axis center CP to the first magnet part MN1 or the second distance 12 from the rotation axis center CP to the second magnet part MN2. For this reason, under conditions where roll OIS is not driven and yaw or pitch OIS is driven, the position of the third Hall sensor HS3 is greatly spaced from the center of the third magnet part MN3, and as a result, there is a problem in that the sensing value of the third Hall sensor HS3 decreases. Furthermore, in the comparative example, the size of the third magnet part MN3 is smaller than the size of the first magnet part MN1 or the size of the second magnet part MN2. Accordingly, when the yaw or pitch OIS is driven, in the comparative example, there is a problem in that the position of the third Hall sensor HS3 moves more significantly from the center of the third magnet part MN3.

At this time, referring to FIGS. 7E and 7F, in the embodiment, when OIS is driven, based on the arrangement direction, the amount of change in the overlapped position of the third Hall sensor HS3 and the third magnet part MN3 may be reduced compared to the comparative example. This is because the third magnet part MN3 in the embodiment is disposed at a distance equal to the distance from the rotation axis center CP to the first magnet part MN1 or the second magnet part MN2.

For example, as in FIG. 7E, in an embodiment, when the OIS is driven at an yaw angle or pitch angle greater than 0° (the same angle as FIG. 7C in the comparative example), the third Hall sensor HS3 moves downward based on the center of the third magnet part MN3. At this time, it was confirmed that the amount of movement in the downward direction in the comparative example was significantly reduced compared to the comparative example. Accordingly, as in FIG. 7E, in the embodiment, the entire region of the third Hall sensor HS3 overlaps with the third magnet part MN3 based the arrangement direction, thereby minimizing the decrease in sensing value. Furthermore, as in FIG. 7F, in the embodiment, when the OIS is driven at a yaw angle or pitch angle less than 0° (the same angle as FIG. 7D), the third Hall sensor HS3 moves upward based on the center of the third magnet part MN3. At this time, as described above, in the embodiment, the third distance L3 is same as the first distance L1 and the second distance L2, and accordingly, the amount of movement of the third Hall sensor HS3 in the upward direction may be smaller than that of the comparative example. Accordingly, as in FIG. 7F, in the embodiment, the entire region of the third Hall sensor HS3 overlaps with the third magnet part MN3 based on around the arrangement direction.

In conclusion, in the comparative example, the third magnet part MN3 was disposed farther from the center of the rotation axis compared to the first magnet part MN1 and the second magnet part MN2. Accordingly, when the OIS of yaw and/or pitch is implemented (yawing and/or pitching) by the first magnet part MN1 and/or the second magnet part MN2, a position detection error (for example, a decrease in the sensing value of the hall sensor) occurred in the roll implementation. For example, if yaw and/or pitch are implemented in the comparative example, even though the roll has not been substantially implemented, a change in the sensing value detected by the third hall sensor occurs. At this time, in the comparative example, the third magnet part MN3 is disposed farther from the center of the rotation axis than the first magnet part MN1 and the second magnet part MN2, and accordingly, when yaw or pitch is implemented by the first magnet part MN1 and the second magnet part MN2, the position of the third Hall sensor is greatly spaced from the center of the third magnet part MN3. Accordingly, in the comparative example, even though roll was not implemented (e.g., roll rotation angle=0°), the position of the third Hall sensor is greatly spaced from the center of the third magnet part MN3, so the sensing value by the third Hall sensor changes. In addition, in the comparative example, there is a problem that the accuracy of OIS driving is reduced due to a change in the sensing value by the third Hall sensor.

In contrast, in the embodiment, the first magnet part MN1, the second magnet part MN2, and the third magnet part are each arranged at the same distance from each other based on the center of the rotation axis in the first housing 300. Accordingly, the embodiment allows the movement distance of each magnet part with respect to a rotation radius to be the same, and the influence of each axis accordingly can be interpreted equally. Accordingly, the embodiment can secure the linearity of the output value of each Hall sensor with respect to the rotation radius, thereby improving OIS implementation accuracy, and further improving operation reliability.

In addition, the embodiment allows the first magnet part MN1, the second magnet part MN2, and the third magnet part MN3 for rotating the lens 100 or bobbin about different axes to have the same size. For example, in the comparative example, the size of the third magnet part MN3 is formed to be small compared to the sizes of the first magnet part MN1 and the second magnet part MN2. Accordingly, when the lens 100 is rotated by the first magnet part MN1 and the second magnet part MN2, in the comparative example, it is impossible to interpret the change in position of the third magnet part MN3. For example, as described above, in the comparative example, it is impossible to interpret how the yaw or pitch implementation by the first magnet part MN1 or second magnet part MN2 affects the change in position of the third magnet part MN3.

In contrast, in the embodiment, the first magnet part MN1, the second magnet part MN2, and the third magnet part MN3 are arranged at the same distance from each other around the rotation axis, and furthermore, they have the same size. Accordingly, in the embodiment, a movement distance of each magnet part with respect to the rotation radius is the same, so that the influence of each axis can be equally analyzed, thereby ensuring linearity of the sensing value of the Hall sensor. Furthermore, the embodiment can effectively reduce the change in Hall sensing range according to the rotation radius and further minimize the influence of other axes (cross-talk).

Below, the degree of change in the sensing value of the Hall sensor in the comparative example and the embodiment will be described when the yaw angle or pitch angle changes while the roll angle is fixed,

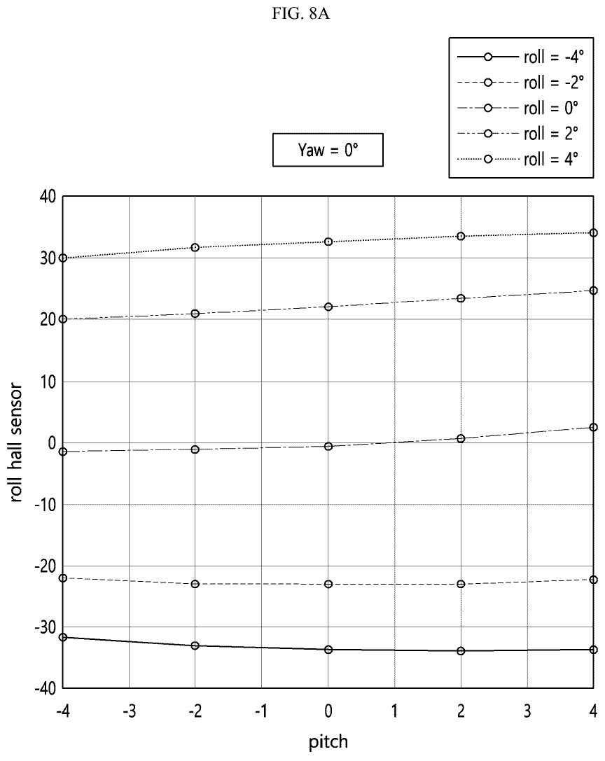

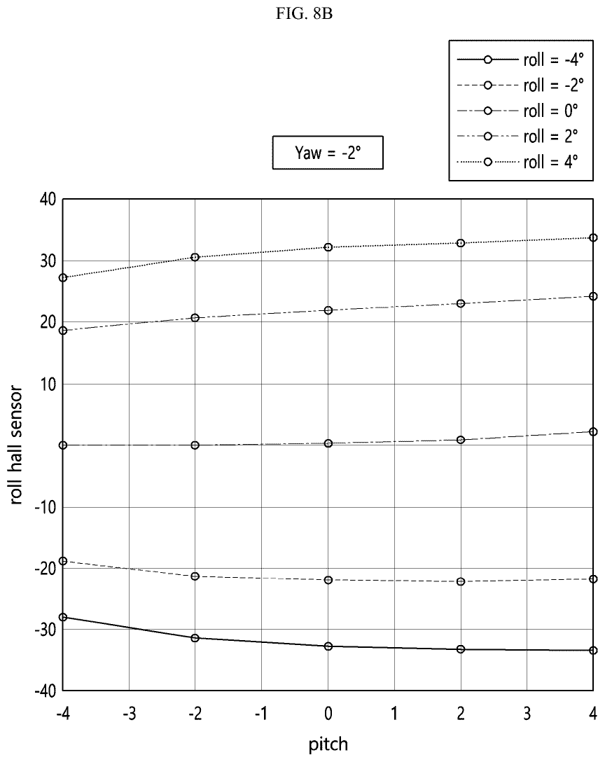

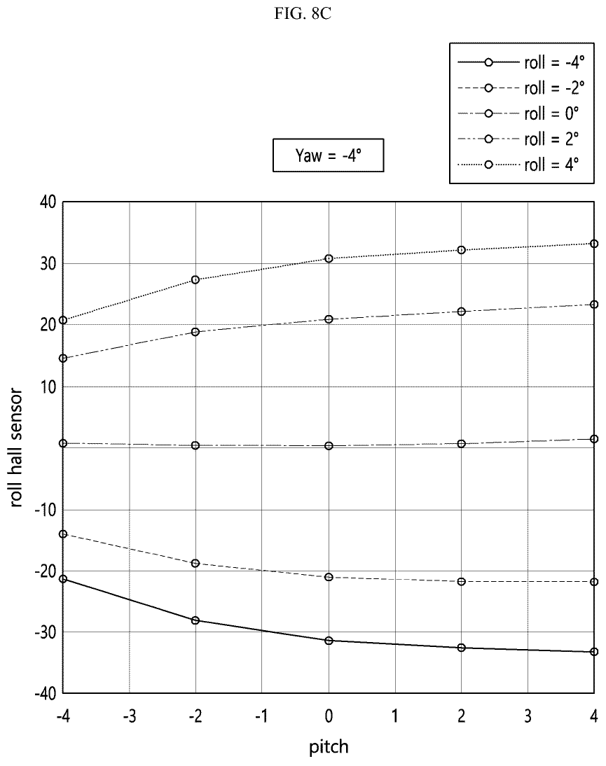

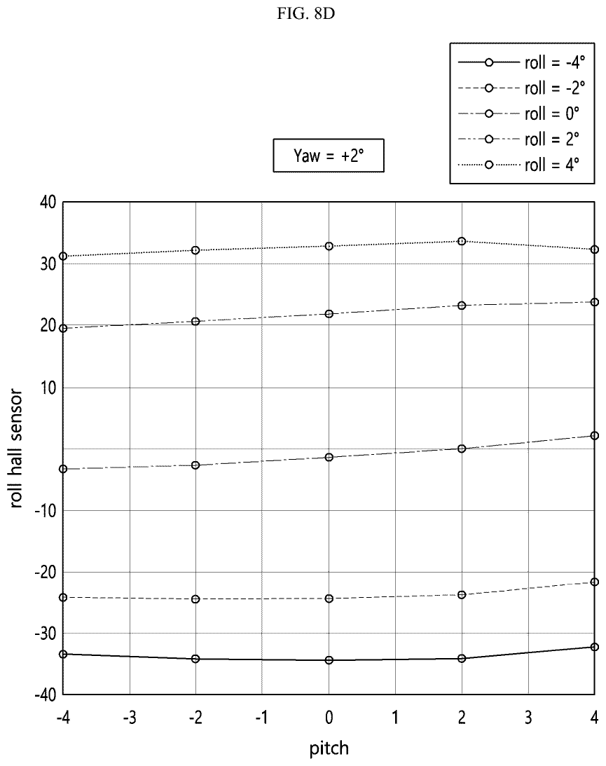

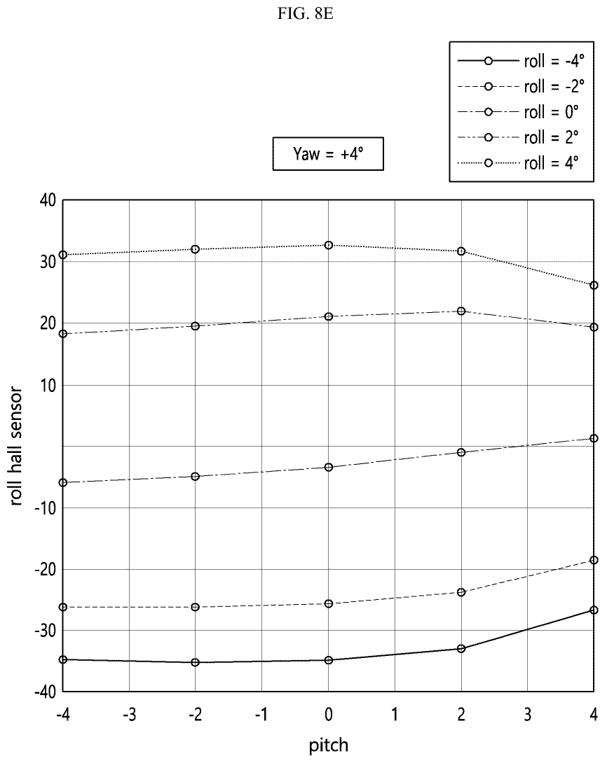

FIGS. 8A-8E are views showing changes in the sensing value of the third Hall sensor according to the yaw angle and pitch angle according to a comparative example.

FIG. 8A shows the change in the sensing value of the third Hall sensor HS3 when the yaw angle is fixed at 0°, the roll angle is fixed at any one of −4°, −2°, 0°, 2°, and 4°, and the pitch angle changes from −4° to 4°. In a graph of FIG. 8A, the x-axis means the pitch angle, and the y-axis means the sensing value (roll hall sensor) of the third hall sensor HS3.

FIG. 8B shows the change in the sensing value of the third Hall sensor HS3 when the yaw angle is fixed at −2°, the roll angle is fixed at any one of −4°, −2°, 0°, 2°, and 4°, and the pitch angle changes from −4° to 4°. In a graph of FIG. 8B, the x-axis means the pitch angle, and the y-axis means the sensing value (roll hall sensor) of the third hall sensor HS3.

FIG. 8C shows the change in the sensing value of the third Hall sensor HS3 when the yaw angle is fixed at −4°, the roll angle is fixed at any one of −4°, −2°, 0°, 2°, and 4°, and the pitch angle changes from −4° to 4°. In a graph of FIG. 8C, the x-axis means the pitch angle, and the y-axis means the sensing value (roll hall sensor) of the third hall sensor HS3.

FIG. 8D shows the change in the sensing value of the third Hall sensor HS3 when the yaw angle is fixed at 2°, the roll angle is fixed at any one of −4°, −2°, 0°, 2°, and 4°, and the pitch angle changes from −4° to 4°. In a graph of FIG. 8D, the x-axis means the pitch angle, and the y-axis means the sensing value (roll hall sensor) of the third hall sensor HS3.

FIG. 8E shows the change in the sensing value of the third Hall sensor HS3 when the yaw angle is fixed at 4°, the roll angle is fixed at any one of −4°, −2°, 0°, 2°, and 4°, and the pitch angle changes from −4° to 4°. In a graph of FIG. 8E, the x-axis means the pitch angle, and the y-axis means the sensing value (roll hall sensor) of the third hall sensor HS3.

As in FIG. 8A to 8E, in the comparative example, even if only the pitch angle changes while the yaw angle and roll angle are fixed, it was confirmed that the sensing value of the third Hall sensor HS3, which senses the pitch angle, changed significantly with irregularity. Furthermore, in the comparative example, it was confirmed that as the pitch angle increased, the change in the sensing value of the third Hall sensor HS3 became greater, and as a result, it was confirmed that the reliability of OIS deteriorated.

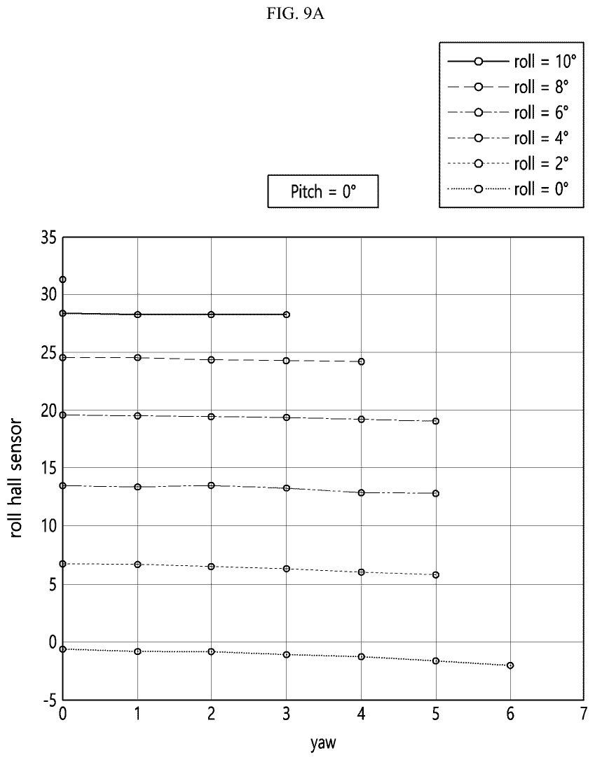

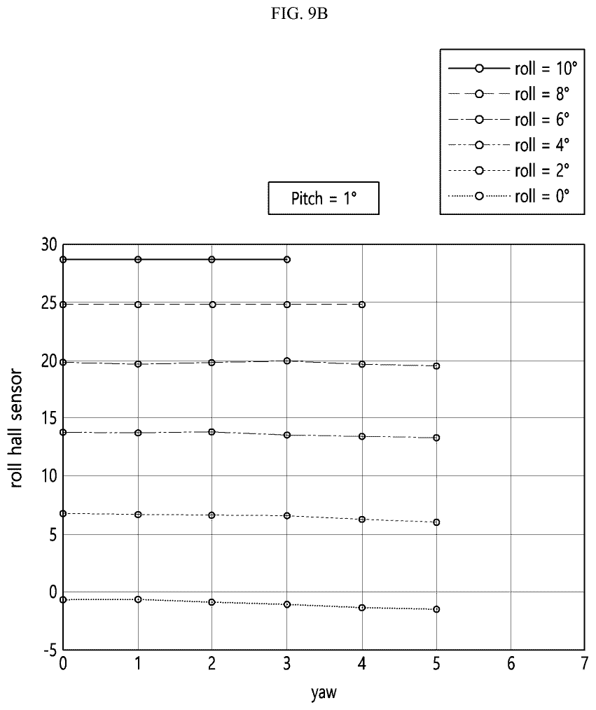

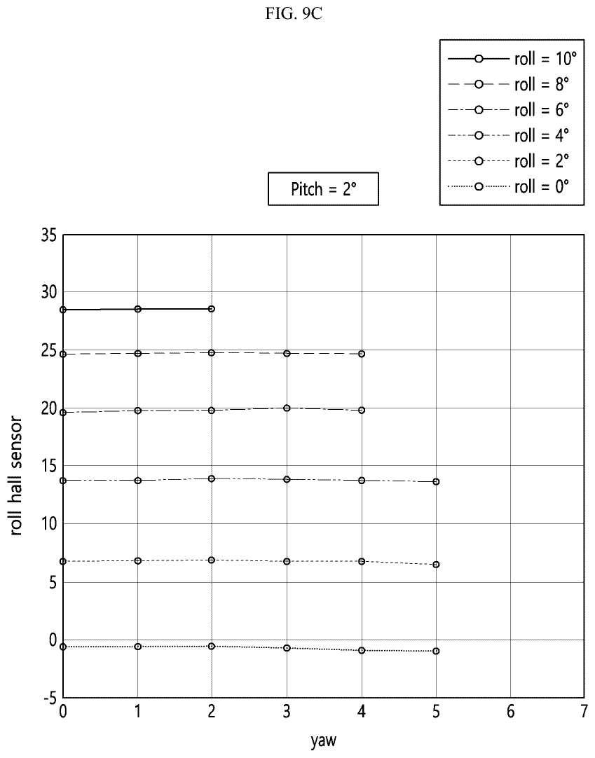

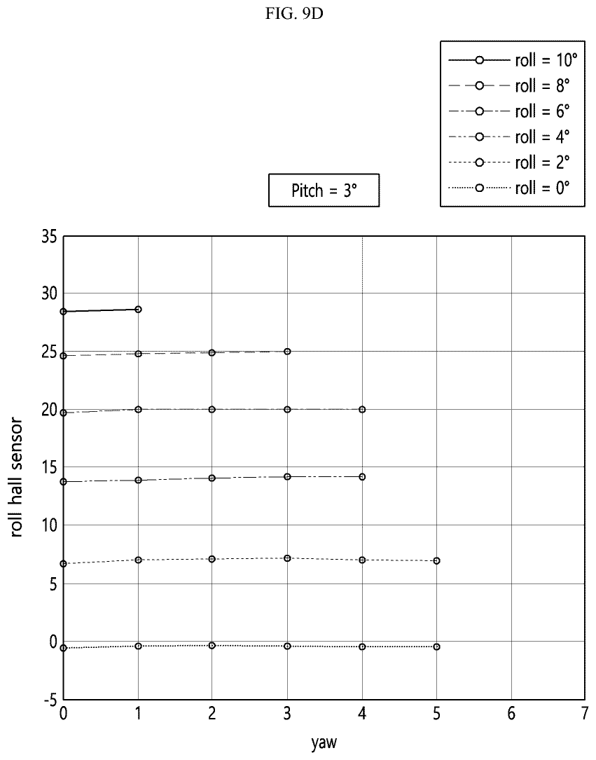

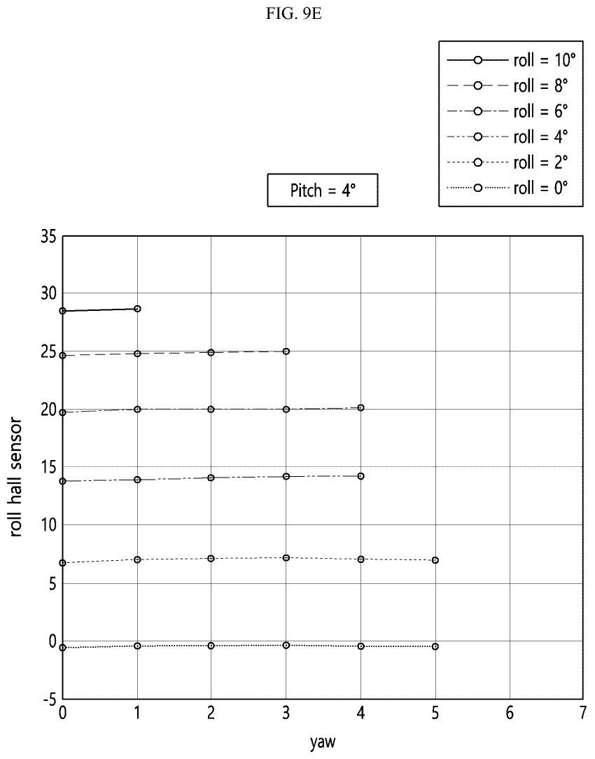

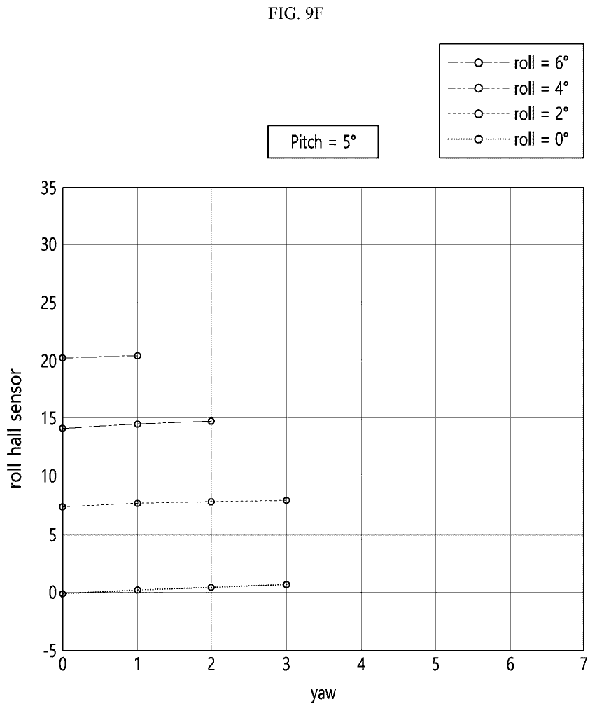

FIGS. 9A-9F are views showing changes in the sensing value of the third Hall sensor according to the yaw angle and pitch angle according to an embodiment.

FIG. 9A shows the change in the sensing value of the third Hall sensor HS3 when the pitch angle is fixed at 0°, the roll angle is fixed at any one of 0°, 2°, 4°, 6°, 8° and 10°, and the yaw angle changes from 0° to 6°. In a graph of FIG. 9A, the x-axis means the yaw angle, and the y-axis means the sensing value (roll hall sensor) of the third hall sensor HS3.

FIG. 9B shows the change in the sensing value of the third Hall sensor HS3 when the pitch angle is fixed at 1°, the roll angle is fixed at any one of 0°, 2°, 4°, 6°, 8° and 10°, and the yaw angle changes from 0° to 5°. In a graph of FIG. 9B, the x-axis means the yaw angle, and the y-axis means the sensing value (roll hall sensor) of the third hall sensor HS3.

FIG. 9C shows the change in the sensing value of the third Hall sensor HS3 when the pitch angle is fixed at 2°, the roll angle is fixed at any one of 0°, 2°, 4°, 6°, 8° and 10°, and the yaw angle changes from 0° to 5°. In a graph of FIG. 9C, the x-axis means the yaw angle, and the y-axis means the sensing value (roll hall sensor) of the third hall sensor HS3.

FIG. 9D shows the change in the sensing value of the third Hall sensor HS3 when the pitch angle is fixed at 3°, the roll angle is fixed at any one of 0°, 2°, 4°, 6°, 8° and 10°, and the yaw angle changes from 0° to 5°. In a graph of FIG. 9D, the x-axis means the yaw angle, and the y-axis means the sensing value (roll hall sensor) of the third hall sensor HS3.

FIG. 9E shows the change in the sensing value of the third Hall sensor HS3 when the pitch angle is fixed at 4°, the roll angle is fixed at any one of 0°, 2°, 4°, 6°, 8° and 10°, and the yaw angle changes from 0° to 5°. In a graph of FIG. 9E, the x-axis means the yaw angle, and the y-axis means the sensing value (roll hall sensor) of the third hall sensor HS3.

FIG. 9F shows the change in the sensing value of the third Hall sensor HS3 when the pitch angle is fixed at 5°, the roll angle is fixed at any one of 0°, 2°, 4°, 6°, 8° and 10°, and the yaw angle changes from 0° to 3°. In a graph of FIG. 9F, the x-axis means the yaw angle, and the y-axis means the sensing value (roll hall sensor) of the third hall sensor HS3.

As shown in FIGS. 9A to 9F, in an embodiment, when the pitch angle and/or the yaw angle is changed while the roll angle is fixed, it was confirmed that the sensing value of the third Hall sensor HS3 changed with a certain regularity. Furthermore, it was confirmed that the amount of change in the sensing value of the third Hall sensor HS3 according to the pitch angle or yaw angle change in the embodiment was significantly reduced compared to the comparative example.

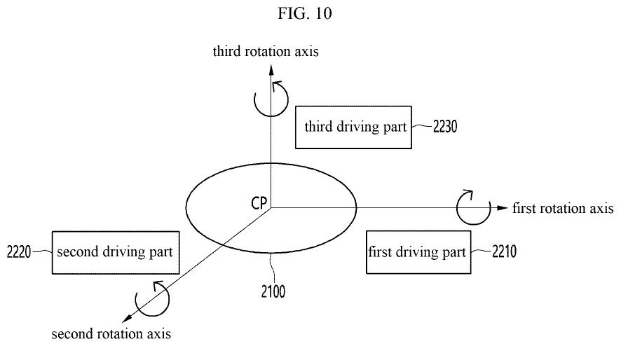

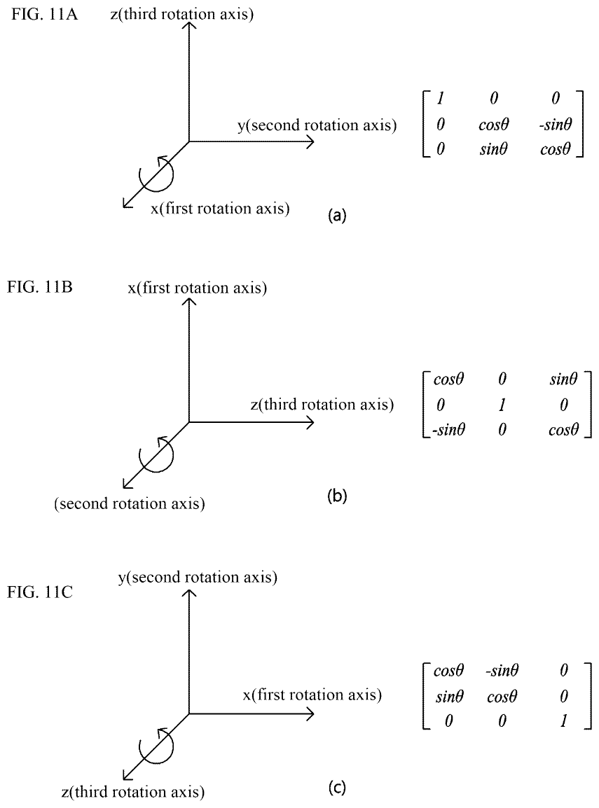

FIG. 10 is a conceptual view for explaining the OIS operation of a camera device according to an embodiment, and FIGS. 11A-11C are views showing a rotation matrix according to the rotation axis in the OIS operation of the embodiment.

Referring to FIGS. 10-11C, the OIS operation of the embodiment may be performed based on three axes.

For example, the camera device may include a camera module 1000 as described above. The camera module 1000 may include a fixed part, a first moving part, a second moving part, and a driving part.

The driving part 2200 may provide driving force to move the first moving part and the second moving part relative to the fixed part. For example, the driving part 2200 may move the second moving part relative to the first moving part and the fixed part when the AF is driven. In addition, the driving part 2200 may move the first moving part and the second moving part relative to the fixed part when the OIS is driven. At this time, the embodiment has a feature in driving OIS, and accordingly, the feature that appear when OIS is driven will be described in detail. Accordingly, hereinafter, the first moving part and the second moving part will be described as ‘moving part’. The moving part 2100 may include the lens 200 as described above. In addition, the moving part may include the image sensor 60.

Accordingly, the driving part 2200 may provide a driving force to move the moving part 2100 including the lens 200 and the image sensor 60 relative to the fixed part for OIS operation.

The driving part 2200 may include a first driving part 2210, a second driving part 2220, and a third driving part 2230.

The first driving part 2210 may provide a first driving force to rotate, tilt, or move the moving part 2100 around a first rotation axis. This may mean yawing in OIS operation, but is not limited thereto.

The second driving part 2220 may provide a second driving force to rotate, tilt, or move the moving part 2100 around a second rotation axis. This may mean pitching in an OIS operation, but is not limited thereto.

The third driving part 2230 may provide a third driving force to rotate, tilt, or move the moving part 2100 around a third rotation axis. This may mean rolling in OIS operation, but is not limited thereto.

In the embodiment, the OIS is implemented by moving the moving part 2100 relative to the fixed part around three different rotation axes as described above.

At this time, the 3-axis OIS as described above can define the position of the moving part 2100 with respect to the fixed part through a combination of rotational drive of pitch, yaw, and roll. At this time, the 3-axis OIS as described above can be driven by defining each rotation axis as a rotation matrix by rotation transformation, as shown in FIGS. 7A-7F. At this time, as described above, the center CP of each rotation axis is the same. For example, each rotation axis is not independent of each other, but shares at least part of it with each other. Accordingly, the rotation matrices for each rotation axis as described above may not have independent characteristics, but may have interdependent characteristics.

And, as the relationship between these rotation axes is dependent, the changing position around each rotation axis can affect the changing position around the other rotation axis. For example, when the moving part 2100 rotates or moves around the first rotation axis for OIS driving and the position of the moving part 2100 changes with respect to the first rotation axis, this also affects the position of the moving part 2100 with respect to the second rotation axis and the third rotation axis.

In other words, when expressing a position in a rotation matrix, it can be expressed as the multiplication of the rotation matrices of each rotation axis. However, the rotation matrix has the characteristic that the commutative law is not established. Accordingly, a final position of the moving part 2100 varies depending on which rotation axis among the three rotation axes is given priority and OIS of the moving part 2100 is achieved. For example, when the OIS is driven around three rotation axes as described above, there is a problem that the final position of the moving part 2100 varies depending on a driving order or hand-shaking compensation order. The driving order and hand-shaking compensation order may have substantially the same meaning. In addition, the driving order can also be expressed as an output order of driving signals for driving each driving part. Accordingly, the meaning of the driving order, hand-shaking compensation order, and output order described below may be substantially the same, but is not limited thereto.

For example, when rotating by 1° around each of the three rotation axes for the above OIS operation, the final position of the moving part 2100 when the moving part 2100 is moved or rotated in the driving order of the first rotation axis→the second rotation axis→the third rotation axis is different from the final position of the moving part 2100 when the moving part 2100 is moved or rotated in the driving order of the third rotation axis→the second rotation axis→the first rotation axis.

At this time, in the comparative example, the OIS is implemented without any consideration of the order of operation for OIS, and there is a problem in that the position accuracy of the moving part 2100 is reduced as a result.

At this time, if the rotation angle or movement amount for each rotation axis is small, the difference in the final position is not large. However, as the rotation angle or movement amount for each rotation axis increases, the difference in the final position increases, and thus OIS reliability deteriorates. Accordingly, when the OIS is driven, there is a problem that an error occurs regarding the final position of the moving part 2100 when approaching a general compensation method due to the above driving order and dependent relationship between each rotation axis, and there is a problem that performance deteriorates as a result.

Accordingly, when the OIS is driven, the embodiment allows determining the driving order or hand-shaking compensation order for movement based on each rotation axis, and allows the OIS operation to be performed sequentially according to the determined order, thereby improving the accuracy of the final position of the moving part 2100 and further improving OIS reliability.

Meanwhile, when the OIS is driven based on two axes, the final position of the moving part 2100 may not be significantly affected by the drive order or hand-shaking compensation order. That is, when the OIS is driven based on two axes, only a relative 1:1 relationship for the two axes can be considered, and accordingly, the difference in the final position of the moving part 2100 depending on the driving order or hand-shaking compensation order is not large. However, when the OIS is driven based on three axes, a large difference occurs in the final position of the moving part 2100 according to the driving order.

In the prior art, an OIS driving range is not large. For example, in the prior art, the OIS is driven within the OIS driving range of ±1 degree based on each of the three rotation axes. In addition, when the OIS driving range is about 1 degree as above, the mutual influence of each rotation axis as described above was not significant. However, recent OIS technology development and hand-shaking compensation range are increasing, and accordingly, the OIS driving range is within ±5 degrees. In addition, as the driving range increases as described above, the mutual influence on each rotation axis increases, and accordingly, the difference in the final position of the moving part 2100 according to the driving order also increases.

Accordingly, the embodiment allows determining the movement order (i.e. hand-shaking compensation order) or drive order for each rotation axis when driving OIS, and allows the OIS operation to be performed sequentially according to the determined order, thus improving the accuracy of the final position of the moving part 2100 and further improving OIS reliability.

Hereinafter, when OIS is driven, position changes according to the driving order will be described in detail.

When the 3-axis OIS is driven, the conditions for the driving order can be divided into six conditions. And, the change in final position according to each driving order may be as shown in Table 1 below. Table 1 shows the differences in the final positions of the moving part under a condition that a radius of the actuator is 8 mm, and the OIS is driven at 5° based on the first rotation axis, 5° based on the second rotation axis, and 5° based on the third rotation axis.

TABLE 1

| | | | | pixel |
|---|---|---|---|---|
| | | | | difference |
| | | | | (When |
| | | | | using a |
| | | | | sensor with |
| Driving | Initial | | Displacement | 1pixcel = |
| order | position | Final position | difference | 1 μm) |
| X→→ | (0, 0, 8) | (0.69, −0.69, 7.93) | (0, 0, 0) | 0 |
| Z→→ | (0, 0, 8) | (0.76, −0.63, 7.93) | (0.05, 0.06, 0) | 60.53 |
| X→→ | (0, 0, 8) | (0.69, −0.63, 7.94) | (0.002, 0.06, 0.005) | 60.53 |
| Y→→ | (0, 0, 8) | (0.69, −0.69, 7.93) | (0.0026, 0.0026, 0) | 2.65 |
| Y→→ | (0, 0, 8) | (0.75, −0.69, 7.93) | (0.057, 0, 0.0052) | 87.88 |
| Z→→ | (0, 0, 8) | (0.75, −0.63, 7.93) | (0.057, 0.063, 0) | 53.41 |

In Table 1, X refers to the first rotation axis, Y refers to the second rotation axis, and Z refers to the third rotation axis.

As described above, when the OIS is driven around three rotation axes, the driving order can be broadly divided into six conditions as follows.
(1) first rotation axis (X)→second rotation axis (Y)→third rotation axis (Z)
(2) third rotation axis (Z)→second rotation axis (Y)→first rotation axis (X)
(3) first rotation axis (X)→third rotation axis (Z)→second rotation axis (Y)
(4) second rotation axis (Y)→first rotation axis (X)→third rotation axis (Z)
(5) second rotation axis (Y)→third rotation axis (Z)→first rotation axis (X)
(6) third rotation axis (Z)→first rotation axis (X)→second rotation axis (Y)

As described above, the 3-axis OIS can be driven based on six driving orders. At this time, as shown in Table 1, when the OIS is driven in the order of the first rotation axis (X)→the second rotation axis (Y)→the third rotation axis (Z), the final position of the moving part 2100 may correspond to the target position. On the other hand, when OIS is driven in the order of the third rotation axis (Z)→the second rotation axis (Y)→the first rotation axis (X), the final position of the moving part 2100 may be different from the target position, and this was confirmed to be a pixel difference of 60.53 compared to the target position. In addition, when OIS is driven in the order of the first rotation axis (X)→the third rotation axis (Z)→the second rotation axis (Y), the final position of the moving part 2100 may be different from the target position, and this was confirmed to be a pixel difference of 60.53 compared to the target position. In addition, when OIS is driven in the order of the second rotation axis (Y)→the first rotation axis (X)→the third rotation axis (Z), the final position of the moving part 2100 may be different from the target position, and this was confirmed to be a pixel difference of 2.65 compared to the target position. In addition, when OIS is driven in the order of the second rotation axis (Y)→the third rotation axis (Z)→the first rotation axis (X), the final position of the moving part 2100 may be different from the target position, and this was confirmed to be a pixel difference of 57.88 compared to the target position. In addition, when OIS is driven in the order of the third rotation axis (Z)→the first rotation axis (X)→the second rotation axis (Y), the final position of the moving part 2100 may be different from the target position, and this was confirmed to be a pixel difference of 63.41 compared to the target position.

As above, it was confirmed that even when the OIS is driven under the same conditions for each of the three rotation axes, there is a difference in the final position depending on the driving order. This was confirmed to be a maximum pixel difference of 63.41 compared to the target position.

Accordingly, the embodiment allows determining each driving order or hand-shaking compensation order for the three rotation axes, and allows the 3-axis OIS to be driven based on this. Accordingly, the embodiment allows to improve the accuracy of OIS and further allows to improve OIS performance and reliability.

Meanwhile, in the comparative example, driving signals were actually supplied from the driver IC to three driving parts at the same time. However, even if the driving signals are supplied simultaneously, differences in the timing at which the OIS is actually driven by each driving part occur due to differences in performance of each driving part. The performance difference may be due to a difference in a length of the connection signal line or a difference in the response speed of the driving part. Therefore, even if the driving signal is supplied to each driving part simultaneously, the rotation order of the moving part 2100 around each rotation axis appears differently due to the above-mentioned performance difference, and this causes a difference in the final position. Accordingly, the embodiment allows driving signals to be sequentially supplied to each driving part based on a driving signal that can minimize errors.

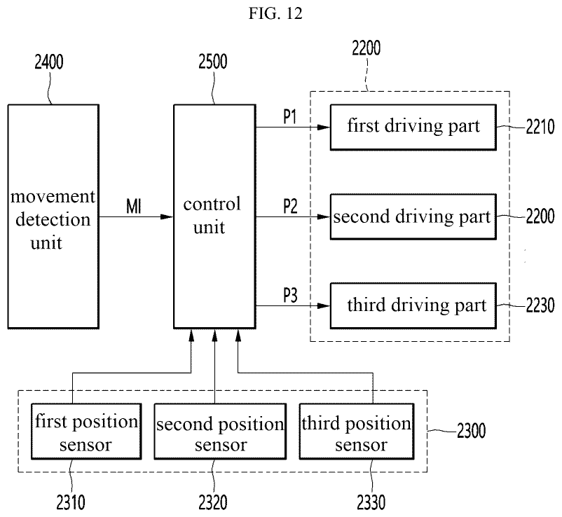

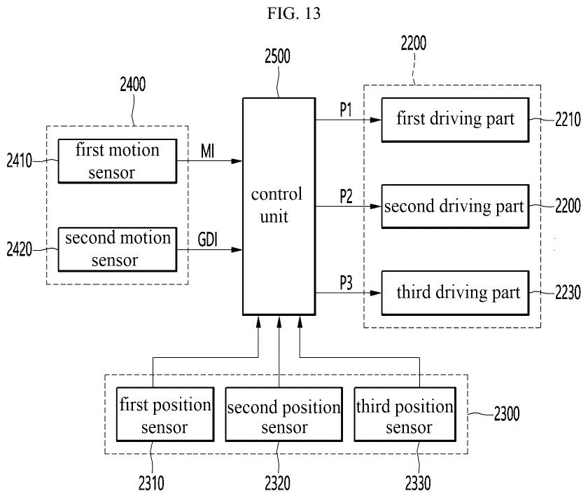

FIG. 12 is a block diagram showing the configuration of a camera device according to a first embodiment, and FIG. 13 is a block diagram showing the configuration of a camera device according to a second embodiment. The camera devices of FIGS. 12 and 13 may differ in the detailed configuration of a movement detection unit 2400. For example, the movement detection unit 2400 of the camera device of the first embodiment of FIG. 12 may include at least one motion sensor. For example, the movement detection unit 2400 of the camera device of the second embodiment of FIG. 13 may include at least two motion sensors. Hereinafter, the camera devices of the first and second embodiments will be described as a whole by assigning the same reference numerals to the same components.

Referring to FIGS. 12 and 13, the camera device can include a driving part 2200 that provides driving force to move or rotate the moving part 2100, a position sensor 2300 that detects the position of the moving part 2100, a movement detection unit 2400 that detects the movement of the camera device, and a control unit 2500 that supplies a driving signal to move or rotate the moving part 2100 according to the movement of the camera device.

The driving part 2200 includes a first driving part 2210, a second driving part 2220, and a third driving part 2230. For example, the driving part 2200 includes a first driving part 2210 for moving or rotating the moving part 2100 around a first rotation axis. In addition, the driving part 2200 includes a second driving part 2220 for moving or rotating the moving part 2100 around a second rotation axis. In addition, the driving part 2200 includes a third driving part 2230 for moving or rotating the moving part 2100 around a third rotation axis.

The position sensor 2300 may include a first position sensor 2310, a second position sensor 2320, and a third position sensor 2330. The first position sensor 2310 can detect the position of the moving part 2100 based on the first rotation axis. For example, the first position sensor 2310 may detect the position of the first driving part 2210. The second position sensor 2320 can detect the position of the moving part 2100 based on the second rotation axis. For example, the second position sensor 2320 may detect the position of the second driving part 2220. The third position sensor 2330 can detect the position of the moving part 2100 based on the third rotation axis. For example, the third position sensor 2330 may detect the position of the third driving part 2230. The first position sensor 2310, the second position sensor 2320, and the third position sensor 2330 may be the first to third Hall sensors as described above, but are not limited thereto.

The movement detection unit 2400 may be a motion sensor.

First, the movement detection unit 2400 of the first embodiment will be described.

The movement detection unit 2400 in the first embodiment may acquire movement information MI according to detection of movement of the camera device. The movement information MI can include angular velocity information and acceleration information. For example, the movement detection unit 2400 may include a 3-axis gyro sensor, a 6-axis gyro sensor, an angular velocity sensor, an acceleration sensor, and an inertial sensor, but is not limited thereto. Meanwhile, in an embodiment, the movement detection unit 2400 may be omitted from the camera device and may be mounted in an optical device. In this case, the control unit 2500 of the camera device may receive movement information MI detected from a movement detection unit of the optical device. In addition, in another embodiment, the movement detection unit 2400 may be mounted in both a camera device and an optical device.

As described above, the movement detection unit 2400 may detect and output at least one of angular velocity information and acceleration information according to movement. Here, the angular velocity information may include at least one of X-axis angular velocity, Y-axis angular velocity, and Z-axis angular velocity. In addition, the acceleration information may include at least one of X-axis acceleration, Y-axis acceleration, and Z-axis acceleration.

The movement detection unit 2400 of the second embodiment will be described.

The movement detection unit 2400 in the second embodiment may acquire first movement information MI according to detection of movement of the camera device. The first movement information MI may be hand-shaking information of the camera device.

In addition, the movement detection unit 2400 may detect second movement information (GDI) about the shooting mode or holding direction of the camera device.

To this end, the movement detection unit 2400 may include a first motion sensor 2410 and a second motion sensor 2420.

The first motion sensor 2410 may include an angular velocity sensor. The second motion sensor 2420 may include an acceleration sensor. At this time, in the embodiment, it has been described that the movement detection unit 2400 is divided into a first motion sensor 2410 and a second motion sensor 2420, but the embodiment is not limited thereto. For example, the movement detection unit 2400 may be composed of a 6-axis gyro sensor that acquires angular velocity information and acceleration information.

Meanwhile, in an embodiment, the movement detection unit 2400 may further include an inertial sensor, etc.

In addition, in an embodiment, the movement detection unit 2400 may be omitted from the camera device. For example, the movement detection unit 2400 may be mounted in an optical device rather than the camera device. In addition, the control unit of the camera device receives the first movement information MI and second movement information (GDI) acquired from the movement detection unit mounted in the optical device, and can control OIS operation using the received information. In addition, in another embodiment, the movement detection unit 2400 may be mounted in both a camera device and an optical device.

As described above, the movement detection unit 2400 may detect and output at least one of angular velocity information and acceleration information according to movement. For example, the first motion sensor 2410 may detect and output first movement information MI corresponding to angular velocity information including the X-axis angular velocity, Y-axis angular velocity, and Z-axis angular velocity. For example, the second motion sensor 2420 may detect and output second movement information (GDI) corresponding to acceleration information including X-axis acceleration, Y-axis acceleration, and Z-axis acceleration.

Hereinafter, MI may mean movement information MI of the first embodiment, and may mean first movement information MI of the second embodiment.

Specifically, the movement detection unit 2400 in the first embodiment of FIG. 12 may mean the first motion sensor 2410 of the movement detection unit 2400 in the second embodiment of FIG. 13.

The control unit 2500 in the first embodiment may output a control signal for controlling the position of the moving part 2100 based on the movement information MI detected by the movement detection unit 2400. In addition, the control unit 2500 in the second embodiment may output a control signal for controlling the position of the moving part 2100 based on the first movement information MI detected by the first motion sensor 2410 of the movement detection unit 2400. For example, the movement information MI or the first movement information MI may be hand-shaking information of a camera device.

Here, the control signal for controlling the position of the moving part 2100 may be a driving signal to be supplied to the driving part 2200. At this time, the driving signal may be a signal corresponding to constant current or constant voltage supplied to the coil part constituting the driving part 2200. For example, the driving signal may be a pulse signal.

To this end, the control unit 2500 can calculate the target position of the moving part 2100 based on the movement information MI detected by the movement detection unit 2400 or the first movement information MI detected by the first motion sensor 2410. The target position may be a position to which the moving part 2100 must move to correct hand-shaking of the camera device, according to the movement information MI. The target position may be expressed as a target angle, target tilt angle, target rotation angle, etc.

In addition, the control unit 2500 can receive position information of the moving part 2100 detected through the position sensor 2300.

Subsequently, the control unit 2500 may generate and output a driving signal for moving the moving part 2100 based on the target position and the detected position information.

For example, the control unit 2500 can generate and output a first driving signal P1 for rotating the moving part 2100 around a first rotation axis, a second driving signal P2 for rotating the moving part 2100 around a second rotation axis and a third driving signal P3 for rotating the moving part 2100 around a third rotation axis.

At this time, the control unit 2500 sequentially outputs the first driving signal P1, the second driving signal P2, and the third driving signal P3 with a certain time difference. That is, the first driving signal P1 is a signal for hand-shaking compensation for the first rotation axis of the moving part 2100. In addition, the second driving signal P2 is a signal for hand-shaking compensation for the second rotation axis of the moving part 2100. In addition, the third driving signal P3 is a signal for hand-shaking compensation for the third rotation axis of the moving part 2100. In addition, the meaning that the first driving signal P1, the second driving signal P2, and the third driving signal P3 are output sequentially at a certain time difference can mean that hand-shaking compensation for the first to third rotation axes is performed sequentially at certain time intervals. The embodiment allows determining the output order of the first to third drive signals or the hand-shaking compensation order for the first to third rotation axes and allows sequential hand-shaking compensation to proceed according to the determined order, thereby improving the reliability of OIS.

At this time, the control unit 2500 may determine the driving order in different methods depending on the embodiment.

The control unit 2500 in the first embodiment determines the output order or hand-shaking compensation order of the three driving signals based on a preset mode. In addition, the control unit 2500 sequentially outputs the three driving signals with a certain delay time based on the determined output order or hand-shaking compensation order. That is, in the first embodiment, a mode is preset, and the control unit 2500 can determine the output order of the driving signal according to the preset mode.

Unlike this, the control unit 2500 in the second embodiment determines a mode for determining the output order of the three driving signals or the hand-shaking compensation order. And, the control unit 2500 sequentially outputs the three driving signals with a certain delay time according to the determined mode. For example, the second embodiment may additionally perform the process of determining the mode compared to the first embodiment.

That is, in the first embodiment, when the mode is set, the output order of the three driving signals is determined according to the set mode.

Unlike this, in the second embodiment, a mode determination operation is additionally performed to determine the output order of the three driving signals. At this time, the mode determination operation may be performed based on the second movement information (GDI) acquired from the second motion sensor 2420 of the movement detection unit 2400.

A process for determining the mode is described in detail as follows.

The control unit 2500 determines a mode for determining the output order or hand shake correction order based on the second movement information (GDI) detected by the second motion sensor 2420. Here, the second movement information (GDI) may include acceleration information of the x-axis component and acceleration information of the y-axis component.

In addition, the control unit 2500 may determine the holding direction or shooting mode of the camera device using the acceleration information of the x-axis component and the acceleration information of the y-axis component. Here, the holding direction may refer to whether the user holds the camera device in horizontal or vertical mode. In addition, the shooting mode can correspond to whether the user takes photos or videos in horizontal shooting mode while holding the camera device in the horizontal direction, or the user takes photos or videos in vertical shooting mode while holding the camera device in the vertical direction. That is, the holding direction and shooting mode may include substantially the same information. That is, the holding direction and shooting mode may indicate whether the camera device is positioned in the horizontal direction or vertical direction.

Also, when the holding direction or shooting mode is determined, the control unit 2500 can determine the output order of the driving signal or the hand shake correction order correspondingly. For example, the control unit 2500 selects or determines a specific mode among a plurality of modes based on the holding direction or shooting mode. Then, the control unit 2500 determines the output order of the driving signal or the hand shake correction order corresponding to the selected or determined mode.

Hereinafter, the operation of the control unit 2500 will be described in detail.

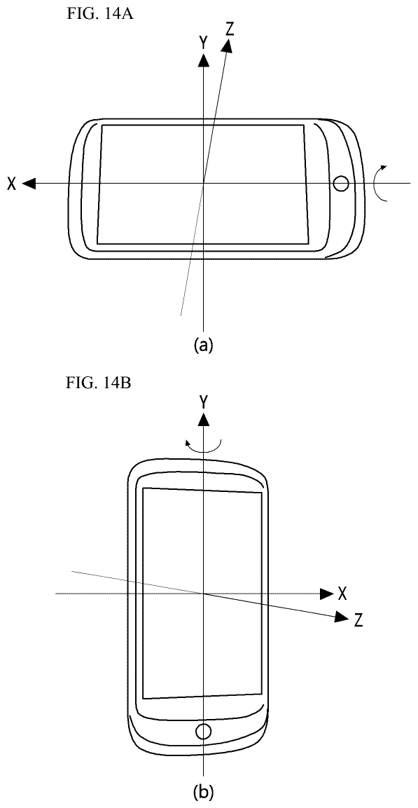

FIGS. 14A and 14B are block diagrams of the detailed configuration of the control unit shown in FIG. 12 or FIG. 13.

Referring to FIGS. 14A and 14B, the control unit 2500 includes a compensation angle calculation unit 2510, a driving signal generation unit 2520, a driving signal output unit 2530, and a mode determination unit 2540. Movement information MI provided from the movement detection unit 2400 described below is described based on the first embodiment, and this may be substantially the same as the first movement information MI provided from the first motion sensor 2410 of the movement detection unit 2400 in the second embodiment.

The compensation angle calculation unit 2510 can calculate the compensation angle for moving the moving part 2100 to the target position based on the movement information MI provided from the movement detection unit 2400 and the position information provided from the position sensor 2300. For example, the compensation angle calculation unit 2510 integrates movement information MI provided from the movement detection unit 2400. In addition, the compensation angle calculation unit 2510 can calculate the angle or movement distance according to an integrated result. At this time, the compensation angle calculation unit 2510 can calculate the compensation angle for each of the three rotation axes.

Specifically, the compensation angle calculation unit 2510 may calculate the target position of the moving part 2100 based on the movement information MI. In addition, the compensation angle calculation unit 2510 may calculate the compensation angle based on the difference between the calculated target position and the position information of the moving part 2100.

The compensation angle calculation unit 2510 can include a target position calculation unit for calculating the target position, a comparison unit for comparing the target position and the position information, and a PID controller for Proportional Integral Derivative (PID) control of the output of the comparison unit, but is not limited thereto.

The driving signal generation unit 2520 may generate a driving signal based on the compensation angle output from the compensation angle calculation unit 2510. For example, the compensation angle may include a first compensation angle for the first rotation axis, a second compensation angle for the second rotation axis, and a third compensation angle for the third rotation axis.

In addition, the driving signal generation unit 2520 may generate a first driving signal P1 to be provided to the first driving part 2210 based on the first compensation angle.

In addition, the driving signal generation unit 2520 may generate a second driving signal P2 to be provided to the second driving part 2220 based on the second compensation angle.

In addition, the driving signal generation unit 2520 may generate a third driving signal P3 to be provided to the third driving part 2230 based on the third compensation angle.

The driving signal generation unit 2520 can include an amplifier for amplifying the output of the PID controller of the compensation angle calculation unit 2510, a pulse signal generation unit for generating a pulse signal (e.g., a pulse width modulated signal) based on the output of the amplifier, and a driver for generating the first driving signal P1, the second driving signal P2, and the third driving signal P3 based on the pulse signal, but is not limited thereto.

The driving signal output unit 2530 may output the first driving signal P1, the second driving signal P2, and the third driving signal P3 generated by the driving signal generation unit 2520, respectively.

At this time, the driving signal output unit 2530 does not output the first driving signal P1, the second driving signal P2, and the third driving signal P3 at the same time, but outputs the driving signals sequentially based on a certain delay time.

For example, the driving signal output unit 2530 can output any one of the first to third driving signals (P1, P2, and P3) at a first time point, output another driving signal at a second time point when a certain delay time has elapsed from the first time point, and output the remaining driving signal at a third time point when a certain delay time has elapsed from the second time point.

At this time, the delay time may be set based on at least one of the driving frequency, the frequency of the clock signal of the control unit 2500, and the driving response speeds of the first to third driving parts.

For example, the delay time may be set based on the driving frequency. The driving frequency may correspond to the frequency of pulse width modulation signals for the first driving signal P1, the second driving signal P2, and the third driving signal P3.

For example, the delay time may be set based on the frequency of the clock signal of the control unit 2500. The frequency of the clock signal of a typical control unit 2500 may be 88 MHz. Accordingly, the delay time can be set to correspond to 88 MHz.

For example, the delay time may be set based on the driving response speeds for the first to third driving parts. The driving response speed may refer to the time from when a driving signal is supplied to the driving part to when the movement of the moving part 2100 is terminated by the driving signal. At this time, the driving response speed of the first driving part 2210, the driving response speed of the second driving part 2220, and the driving response speed of the third driving part 2230 may be different from each other. At this time, the control unit 2500 may set the delay time based on a slowest driving response speed among the driving response speeds of each of the three driving parts.

The mode determination unit 2540 determines the mode for the output order of the driving signal from the driving signal output unit 2530.

The mode may include first to sixth modes.

And, the output order of the driving signals for the first to sixth modes may be as shown in Table 2 below.

TABLE 2

| | Driving | Driving | Driving |
|---|---|---|---|
| | signal to be | signal to be | signal to be |
| | output at | output at | output at |
| | the first time | the second | the third time |
| MODE | point | time point | point |
| MODE 1 | P1 | P2 | P3 |
| MODE 2 | P2 | P3 | P1 |
| MODE 3 | P3 | P1 | P2 |
| MODE 4 | P1 | P3 | P2 |
| MODE 5 | P3 | P2 | P1 |
| MODE 6 | P2 | P1 | P3 |

As described above, the embodiment includes six modes, and the mode determination unit 2540 determines one mode among the six modes and determines the output order of the driving signal from the driving signal output unit 2530. At this time, the driving signal output at the first time point refers to the driving signal output in the first priority according to the determined mode, the driving signal output at the second time point refers to a driving signal output in the second priority according to the determined mode, and the driving signal output at the third time point may mean a driving signal output at the third priority according to the determined mode.

For example, the mode determination unit 2540 determines the fourth mode, so that, the first driving signal P1 can be preferentially output at the first time point according to the determined fourth mode, the third driving signal can be output at a second time point when the delay time has elapsed from the first time point, and the second driving signal P2 can be output at a third time point when the delay time has elapsed from the second time point.

Here, when designing a camera device, the mode determination unit 2540 can determine in advance a mode in which the difference between the final position and the target position is the smallest among the six modes.

For example, the embodiment may proceed with a process of determining the mode when designing a camera device. That is, the embodiment determines first to third drive signals for moving the moving part to the target position when designing the camera device. In addition, the embodiment can perform reliability evaluation for each mode by varying the output order of the determined first to third driving signals for each of the first to sixth modes. The reliability evaluation may be performed based on the difference between the final position of the moving part for each mode and the preset target position. In addition, the embodiment may predetermine a specific mode that has a smallest deviation from the target position among the final positions of the moving part 2100 for the first to sixth modes.

In addition, the mode determination unit 2540 stores information about the predetermined specific mode and allows the first driving signal P1, the second driving signal P2, and the third driving signal P3 to be sequentially output from the driving signal output unit 2530 based on the order according to the stored predetermined specific mode.

In addition, the control unit 2500 can periodically perform reliability evaluation in the camera device's usage environment. In addition, when the reliability of the predetermined mode decreases, the control unit 2500 can re-determine the mode with the smallest deviation from the target position among the final positions of the moving part 2100 for the first to sixth modes. That is, the control unit 2500 may reevaluate the reliability of the pre-stored mode and update the pre-stored mode information according to the result of the reevaluation. This can be performed by the mode determination unit 2540 of the control unit 2500, but is not limited thereto.

Unlike this, in the second embodiment, the mode may be set to correspond to a current state rather than being previously preset. That is, the mode determination unit 2540 in the second embodiment may determine the mode based on the second movement information (GDI) acquired by the second motion sensor 2420.

Hereinafter, the operation of determining the mode according to the second embodiment will be described in detail.

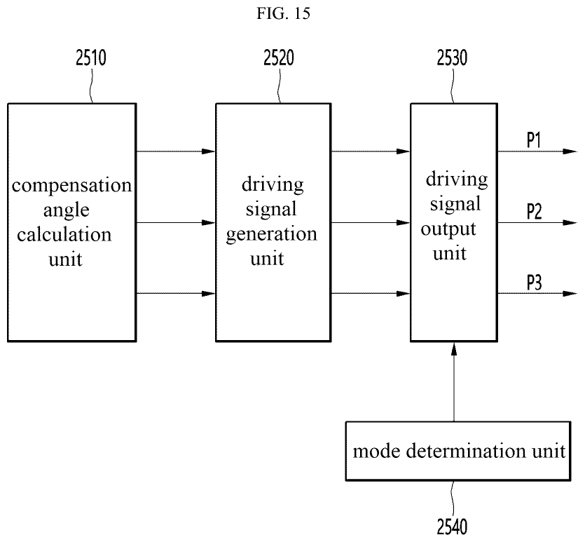

FIG. 15 is a view for explaining hand shaking characteristics according to the holding direction or shooting mode of the camera device.

Referring to FIG. 15, generally, a camera device can be used while held in a horizontal or vertical direction. For example, a user can use the camera device while holding it in a horizontal direction, or use it while holding it in a vertical direction. At this time, when the user enters the shooting mode while holding the camera device in the horizontal direction, the shooting mode may be a first shooting mode corresponding to a horizontal shooting mode. In addition, when the user enters the shooting mode while holding the camera device in the vertical direction, the shooting mode may be a second shooting mode corresponding to a vertical shooting mode.

At this time, the hand-shaking may generally occur concentrated in a long axis direction.

As shown in (a) of FIG. 15, when the holding direction is the horizontal direction or the shooting mode is the first shooting mode, the long axis direction of the camera device is the x-axis. And, when the camera device operates in this state, the hand-shaking mainly occurs in the x-axis direction, which is the long axis direction.

In addition, as shown in (b) of FIG. 15, when the holding direction is the vertical direction or the shooting mode is the second shooting mode, the long axis direction of the camera device becomes the y-axis. And, when the camera device operates in this state, the hand tremor mainly occurs in the y-axis, which is the long axis direction.

In other words, it can be seen that in three-dimensional space, the OIS operation based on three rotation axes has a dependent relationship between the rotation axes. At this time, the movement of the rotation axis compensated as the first priority among the three rotation axes affects the movement of the rotation axis compensated as the next priority. And, as the movement of the rotation axis compensated for the first priority increases, the degree of influence on the movement of the rotation axis compensated for the next priority increases.

At this time, when shooting in the first shooting mode while holding the camera device in the horizontal direction, the degree of shaking in the x-axis direction, which is the long axis direction, appears to be greater than the degree of shaking in the y-axis or z-axis directions.

Accordingly, in the embodiment, the hand-shaking compensation is preferentially performed on the rotation axis with a large degree of shaking, depending on the holding direction or shooting mode of the camera device. For example, when the holding direction of the camera is the horizontal direction or the shooting mode is the first shooting mode, the embodiment allows preferential hand-shaking compensation for the first rotation axis corresponding to the x-axis. In addition, when hand-shaking compensation of the first rotation axis corresponding to the x-axis is terminated, the embodiment allows hand-shaking compensation of the second and third rotation axes corresponding to the y-axis and z-axis to be continuously performed.

For example, when the holding direction of the camera is the vertical direction or the shooting mode is the second shooting mode, the embodiment allows preferential hand-shaking compensation for the second rotation axis corresponding to the y-axis. In addition, when hand-shaking compensation of the second rotation axis corresponding to the y-axis is terminated, the embodiment allows hand-shaking compensation of the first and third rotation axes corresponding to the x-axis and z-axis to be continuously performed.

For example, when the holding direction is the horizontal direction or the shooting mode is the first shooting mode, the mode determination unit 2540 selects one of the first mode and the fourth mode among the first to sixth modes so that hand-shaking compensation for the first rotation axis is preferentially performed, or the first drive signal P1 for hand-shaking compensation of the first rotation axis is output preferentially.

Meanwhile, the holding direction or shooting mode can be determined by the following method.

The second motion sensor 2420 can detect acceleration information about how the camera device rotated. For example, the second motion sensor 2420 may detect acceleration information of the x-axis component and acceleration information of the y-axis component. In addition, the control unit 2500 can detect the holding direction or shooting mode using the acceleration information of the x-axis component and the acceleration information of the y-axis component. For example, the holding direction or shooting mode can be detected using Equation 1 below.

arctan(y/x)=Dangle [Equation 1]

In Equation 1, y is acceleration information of the y-axis component, x is acceleration information of the x-axis component, and Dangle is the arrangement angle of the camera device.

Therefore, the embodiment can detect the arrangement angle of the camera device using the acceleration information of the x-axis component and the acceleration information of the y-axis component, and estimate the holding direction or shooting mode based on the detected arrangement angle.

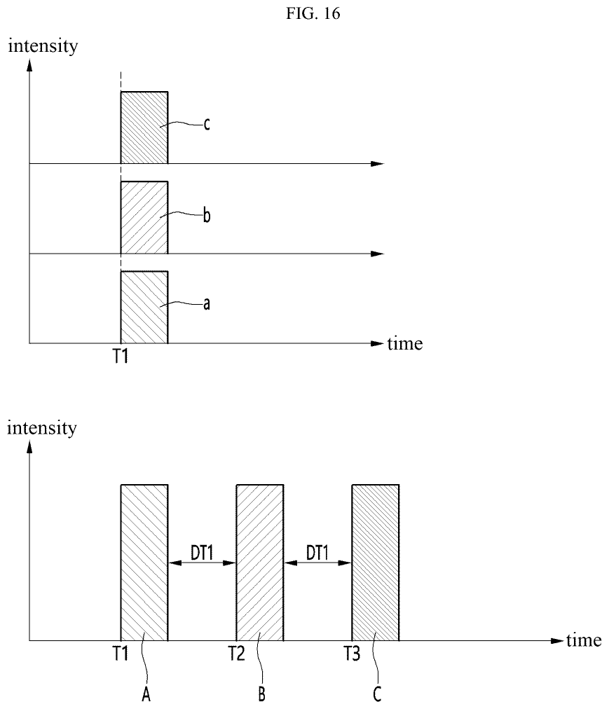

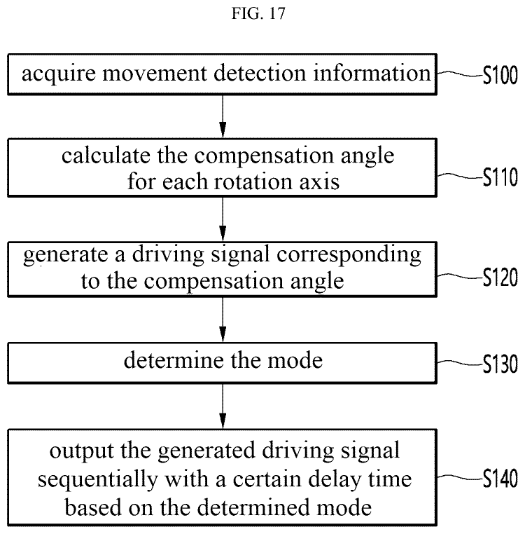

FIG. 16 is a view for explaining the output order of driving signals according to the comparative example and the embodiment.

FIG. 16 (a) is a view showing the output order of driving signals according to a comparative example. In (a) of FIG. 16, the x-axis can represent a time axis, and the y-axis can represent the intensity of the driving signal (for example, the amplitude of the pulse signal).

Referring to (a) of FIG. 16, in a comparative example, first to third drive signals (a, b, c), which are drive signals for rotating a moving part about the first to third rotation axes, were simultaneously output from the control unit. For example, in the comparative example, the first to third driving signals (a, b, c) were supplied simultaneously to each driving part or output simultaneously from the control unit. For example, the first to third driving signals (a, b, and c) were output simultaneously at the first time point T1.

FIG. 16 (b) is a view showing the output order of the driving signal according to an embodiment.

In (b) of FIG. 16, the x-axis can represent the time axis, and the y-axis can represent the intensity of the driving signal (for example, the amplitude of the pulse signal).

In an embodiment, even if the first to third driving signals are generated simultaneously by the driving signal generation unit, the first to third driving signals may be output from the driving signal output unit 2530 at different time points. Accordingly, in the embodiment, driving signals may be provided to the first driving part 2210, the second driving part 2220, and the third driving part 2230 at different time points.

For example, in the embodiment, the driving signal A is output at the first time point T1. Then, the driving signal (B) is output at a second time point T2 when the first delay time DT1 has elapsed from the first time point T1 at which the driving signal (A) was output. In addition, in an embodiment, the driving signal C can be output at a third time point T3 when a second delay time DT2 has elapsed from the second time point T2 at which the driving signal B is output. At this time, the driving signal (A), driving signal (B), and driving signal (C) may correspond to the determined mode.

For example, when the determined mode is the second mode, the driving signal (A) output at the first time point T1 can be the second driving signal P2 provided to the second driving part 2220, the driving signal B output at the second time point T2 can be the third driving signal P3 provided to the third driving part 2230, and the driving signal C output at the third time point T3 can be the first driving signal P1 provided to the first driving part 2210.

The camera device according to the embodiment includes a driving part that moves the moving part with respect to the fixed part. At this time, the driving part includes a first driving part that moves the moving part around a first rotation axis, and a second driving part that moves the moving part around a second rotation axis, and a third driving part that moves the moving part around a third rotation axis. At this time, when the 3-axis OIS is driven by the first to third driving parts, in the comparative example, first to third driving signals were simply provided to the first to third driving parts without considering the order of operation of these. However, 3-axis OIS technology can define each rotation axis as a rotation matrix by rotation transformation. At this time, since the relationship between each rotation axis is dependent, the movement change of the preceding rotation axis affects the movement change of the other rotation axis. Accordingly, a deviation occurs in the final position of the moving part depending on the driving order.

Accordingly, when the OIS is driven, the embodiment allows determining the hand-shaking compensation order for each rotation axis or the output order of the drive signal supplied to each driving part, and allows OIS operation for each rotation axis to be performed sequentially according to the determined hand-shaking compensation order or output order. Accordingly, the embodiment improves the accuracy of the final position of the moving part by allowing the OIS drive to be performed based on a specific hand-shaking compensation order or output order with the least mutual influence, and furthermore, it allows to improve OIS reliability.

That is, the embodiment allows determining the hand-shaking compensation order for each rotation axis or the output order of the driving signal supplied to each driving part when driving OIS, and allows OIS operation for each rotation axis to be performed sequentially according to the determined hand-shaking compensation order or output order. Accordingly, the embodiment improves the accuracy of the final position of the moving part by allowing the OIS drive to be performed based on a specific hand-shaking compensation order or output order with the least mutual influence, and furthermore, it allows to improve OIS reliability.

In addition, when the OIS is driven around three rotation axes, the embodiment allows the OIS to proceed sequentially in the order of the rotation axis with the largest amount of movement or the rotation axis with the largest rotation angle (for example, the rotation axis with the most shaking) or the rotation axis with the greatest degree of hand-shaking.

Accordingly, the embodiment can minimize cross-talk generated by other rotation axes by performing OIS starting from the rotation axis with a large degree of shaking. In addition, the degree of shaking may correspond to changes in the user's posture. Accordingly, the embodiment can perform OIS operation adaptively according to the user's posture by performing OIS operation in the order of the degree of shaking (or hand shaking), thereby improving user satisfaction.

In addition, the embodiment allows OIS operation to be adaptive to the user's shooting posture. That is, the embodiment allows determining the hand-shaking compensation order for each rotation axis or the output order of the driving signal supplied to each driving part in response to the user's shooting posture. For example, the embodiment determines the hand-shaking compensation order or output order depending on whether the user holds the camera device in the horizontal direction or vertical direction. For example, the embodiment determines the hand-shaking compensation order or output order depending on whether the shooting mode of the camera device is horizontal shooting mode or vertical shooting mode. For example, if the holding direction is a horizontal direction or the shooting mode is horizontal shooting mode, a main hand shaking occurs in the x-axis. And, if the holding direction is a horizontal direction or the shooting mode is horizontal shooting mode, the OIS is driven by giving first priority to the hand-shaking compensation order of the first rotation axis corresponding to the x-axis or the output order of the first drive signal. Conversely, if the holding direction is a vertical direction or the shooting mode is vertical shooting mode, the main hand-shaking occurs in the y-axis. And, if the holding direction is the vertical direction or the shooting mode is vertical shooting mode, the OIS is driven by giving first priority to the hand-shaking compensation order of the second rotation axis corresponding to the y-axis or the output order of the second drive signal. Accordingly, the embodiment can provide OIS performance optimized for the user's shooting posture and thereby improve hand-shaking compensation accuracy.

FIG. 17 is a flowchart for step-by-step explaining the operation method of the camera device according to the first embodiment. At this time, the first embodiment may include a first sub-embodiment and a second sub-embodiment. The first sub-embodiment can be performed based on a preset mode. In addition, the second sub-embodiment can additionally proceed with a process of setting the mode based on second movement information.

Referring to FIG. 17, the movement detection unit 2400 in the embodiment can detect movement information by detecting the movement of the camera device (S100).

Next, the compensation angle calculation unit 2510 in the embodiment calculates the compensation angle for moving the moving part 2100 to the target position based on the movement information detected by the movement detection unit 2400 (S110). At this time, the compensation angle may include a first compensation angle with respect to the first rotation axis, a second compensation angle with respect to the second rotation axis, and a third compensation angle with respect to the third rotation axis.

Next, the driving signal generation unit 2520 in the embodiment generates a driving signal corresponding to the compensation angle (S120). For example, the driving signal generation unit 2520 generates a first driving signal P1 corresponding to the first compensation angle. For example, the driving signal generation unit 2520 generates a second driving signal P2 corresponding to the second compensation angle. For example, the driving signal generation unit 2520 generates a third driving signal P3 corresponding to the third compensation angle.

The mode determination unit 2540 can determine a mode corresponding to the output order of the first to third driving signals (S130). For example, the mode determination unit 2540 can determine the output order of the first to third driving signals. For example, the mode determination unit 2540 can determine a hand-shaking compensation order to drive 3-axis OIS.

For example, the mode determination unit 2540 in the first sub-embodiment can extract pre-stored mode information, and determine the output order or hand-shaking compensation order for the first to third driving signals based on the extracted mode information. At this time, the stored mode information may be information stored when designing the camera device. Alternatively, the stored mode information can be information updated through a periodic position accuracy evaluation process in the camera device's usage environment.

For example, the mode determination unit 2540 in the second sub-embodiment uses the second movement information (GDI) acquired through the second motion sensor 2420 to determine the holding direction or shooting mode of the camera device. judge. In addition, the mode determination unit 2540 may select or determine a mode for preferentially performing hand-shaking compensation for the axis with the greatest hand-shaking using the determined holding direction or shooting mode.

The driving signal output unit 2530 determines the output order of the first to third driving signals according to the mode determined through the mode determination unit 2540, and sequentially outputs the first to third driving signals with a predetermined delay time according to the determined output order (S140). Alternatively, the driving signal output unit 2530 can determine a hand-shaking compensation order and sequentially output driving signals for hand-shaking compensation for each rotation axis according to the hand-shaking compensation order.

For example, when the determined mode is the second mode, the driving signal output unit 2530 outputs a second driving signal P2 to be provided to the second driving part 2220 at the first time point T1. For example, when the determined mode is the second mode, in order to perform hand-shaking compensation for the second rotation axis as the first priority, the driving signal output unit 2530 may output a second driving signal P2 to be provided to the second driving part 2220 at the first time point T1.

In addition, when the determined mode is the second mode, the driving signal output unit 2530 can output a third driving signal P3 to be provided to the third driving part 2230 at the second time point T2, and can output a first driving signal P1 to be provided to the first driving part 2210 at the third time point T3.

That is, the output order of the driving signal can also be expressed as a hand-shaking compensation order for the first to third rotation axes. For example, the embodiment can allow determining the hand-shaking compensation order for the first to third rotation axes, and allow hand-shaking compensation for each rotation axis to proceed sequentially based on this.

For example, when the determined mode is the second mode, the driving signal output unit 2530 can set hand-shaking compensation for the second rotation axis as first priority, set hand-shaking compensation for the third rotation axis as the second priority, and set hand-shaking compensation for the first rotation axis as the third priority.

In addition, the embodiment may allow hand-shaking compensation for the second rotation axis set to the first priority to proceed to the first priority. In addition, when the hand-shaking compensation for the second rotation axis is completed or when the first delay time has elapsed, the embodiment may allow hand-shaking compensation for the third rotation axis set to the second priority to proceed to the second priority. In addition, when the hand-shaking compensation for the third rotation axis is completed or the second delay time has elapsed, the embodiment may allow hand-shaking compensation for the first rotation axis set to the third priority to proceed to the third priority.

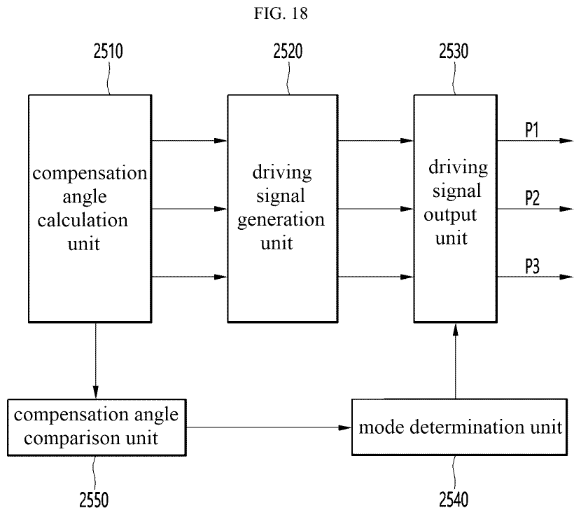

FIG. 18 is a block diagram showing the detailed configuration of the control unit of FIG. 12 or FIG. 13 according to the second embodiment.

Referring to FIG. 18, the control unit 2500 according to the embodiment includes a compensation angle calculation unit 2510, a driving signal generation unit 2520, a driving signal output unit 2530, a compensation angle comparison unit 2550, and a mode determination unit 2540. The control unit of FIG. 18 may further include a compensation angle comparison unit 2550 compared to the control unit of FIGS. 14A and 14B.

The compensation angle calculation unit 2510 can calculate the compensation angle for moving the moving part 2100 to the target position based on movement information (MI, or first movement information provided through the first motion sensor) provided from the movement detection unit 2400 and position information provided from the position sensor 2300. For example, the compensation angle calculation unit 2510 may integrate movement information MI provided from the movement detection unit 2400 and calculate an angle or movement distance according to the integration result. At this time, the compensation angle calculation unit 2510 can calculate the compensation angle for each of the three rotation axes.

Specifically, the compensation angle calculation unit 2510 may calculate the target position of the moving part 2100 based on the movement information MI. In addition, the compensation angle calculation unit 2510 may calculate the compensation angle based on the difference between the calculated target position and the position information of the moving part 2100.

The compensation angle calculation unit 2510 can include a target position calculation unit for calculating the target position, a comparison unit for comparing the target position and the position information, and a PID controller for Proportional Integral Derivative (PID) control of the output of the comparison unit, but is not limited thereto.

The driving signal generation unit 2520 may generate a driving signal based on the compensation angle output from the compensation angle calculation unit 2510. For example, the compensation angle may include a first compensation angle for the first rotation axis, a second compensation angle for the second rotation axis, and a third compensation angle for the third rotation axis.

In addition, the driving signal generation unit 2520 may generate a first driving signal P1 to be provided to the first driving part 2210 based on the first compensation angle.

In addition, the driving signal generation unit 2520 may generate a second driving signal P2 to be provided to the second driving part 2220 based on the second compensation angle.

In addition, the driving signal generation unit 2520 may generate a third driving signal P3 to be provided to the third driving part 2230 based on the third compensation angle.

The driving signal generation unit 2520 can include an amplifier for amplifying the output of the PID controller of the compensation angle calculation unit 2510, a pulse signal generation unit for generating a pulse signal (e.g., a pulse width modulated signal) based on the output of the amplifier, and a driver for generating the first driving signal P1, the second driving signal P2, and the third driving signal P3 based on the pulse signal, but is not limited thereto.

The driving signal output unit 2530 may output the first driving signal P1, the second driving signal P2, and the third driving signal P3 generated by the driving signal generation unit 2520, respectively.

At this time, the driving signal output unit 2530 does not output the first driving signal P1, the second driving signal P2, and the third driving signal P3 at the same time, but outputs the driving signals sequentially based on a certain delay time.

For example, the driving signal output unit 2530 can output any one of the first to third driving signals (P1, P2, and P3) at a first time point, output another driving signal at a second time point when a certain delay time has elapsed from the first time point, and output the remaining driving signal at a third time point when a certain delay time has elapsed from the second time point.

At this time, the delay time may be set based on at least one of the driving frequency, the frequency of the clock signal of the control unit 2500, and the driving response speeds of the first to third driving parts.

The mode determination unit 2540 determines the mode for the output order of the driving signal from the driving signal output unit 2530.

The mode may include first to sixth modes.

The mode determination unit 2540 may determine the mode based on the comparison result of the compensation angle comparison unit 2550.

The compensation angle comparison unit 2550 can compare the compensation angle for each rotation axis calculated in the compensation angle calculation unit 2510. For example, the compensation angle comparison unit 2550 may compare the size of the compensation angle for each rotation axis calculated by the compensation angle calculation unit 2510. For example, the compensation angle comparison unit 2550 can compare the movement amount of the moving part corresponding to the compensation angle for each rotation axis.

For example, the compensation angle includes first to third compensation angles.

The first compensation angle may correspond to the first movement amount of the moving part 2100 around the first rotation axis.

In addition, the second compensation angle may correspond to a second movement amount of the moving part 2100 around the second rotation axis.

In addition, the third compensation angle may correspond to a third movement amount of the moving part 2100 around a third rotation axis.

In addition, the compensation angle comparison unit 2550 can compare the first to third movement amounts. And, the compensation angle comparison unit 2550 can output information corresponding to the comparison result. For example, the compensation angle comparison unit 2550 may output information about the rotation axis with the largest movement amount, the rotation axis with the middle movement amount, and the rotation axis with the smallest movement amount.

The mode determination unit 2540 can determine the mode based on the information output from the compensation angle comparison unit 2550. For example, the mode determination unit 2540 may determine the mode based on the order of the greatest movement amount based on the comparison result of the compensation angle comparison unit 2550. For example, the mode determination unit 2540 may determine the mode based on the order of the largest compensation angle, based on the comparison result of the compensation angle comparison unit 2550.

For example, the first compensation angle may be 3°, the second compensation angle may be 2°, and the third compensation angle may be 5°. Accordingly, the size order for the compensation angle may be ‘third compensation angle>first compensation angle>second compensation angle’.

Accordingly, the mode determination unit 2540 can determine the corresponding mode so that the driving signal is output in the order of the compensation angle becoming larger. For example, in the case of the compensation angle size as above, the mode determination unit 2540 causes the third driving signal P3 to be output at first priority, causes the first driving signal P1 to be output as the second priority, and causes the second drive signal P2 to be output as the third priority. For example, the mode determination unit 2540 determines the mode as the third mode so that the driving signals are output in the order of the third driving signal P3, the first driving signal P1, and the second driving signal P2. Here, among the first to third driving signals (P1, P2, and P3), the driving signal output at the first time point may be referred to as the first priority driving signal, the driving signal output at the second time point may be referred to as the second priority driving signal, and the driving signal output at the third time point may be referred to as the third priority driving signal.

In the embodiment, when the OIS is driven around three rotation axes, the embodiment allows the OIS to proceed sequentially in the order of the rotation axis with the largest amount of movement or the rotation axis with the largest rotation angle (for example, the rotation axis with the most shaking) or the rotation axis with the greatest degree of hand-shaking. Accordingly, the embodiment can minimize cross-talk generated by other rotation axes by performing OIS starting from the rotation axis with a large degree of shaking. In addition, the degree of shaking may correspond to changes in the user's posture. Accordingly, the embodiment can perform OIS operation adaptively according to the user's posture by performing OIS operation in the order of the degree of shaking (or hand shaking), thereby improving user satisfaction.

Specifically, the first sub-embodiment of the first embodiment performs an OIS operation according to the set mode with the optimized mode set for the camera device. In addition, the second sub-embodiment of the first embodiment predicts a rotation axis with a large compensation angle based on the holding direction or shooting mode, and determines the mode for preferential hand-shaking compensation of the expected rotation axis.

In contrast, the second embodiment calculates the compensation angle for each rotation axis based on the first movement information MI, and determines the mode for performing hand-shaking compensation in the order of the rotation axis with the actual compensation angle, based on the calculated compensation angle.

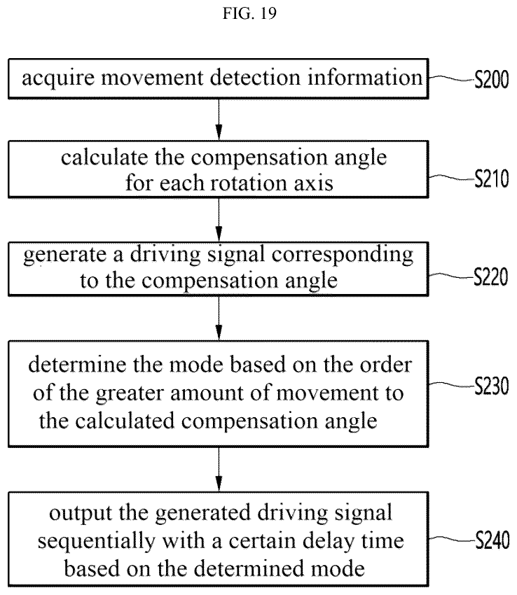

FIG. 19 is a flowchart for step-by-step explaining the operation method of the camera device according to the second embodiment.

Referring to FIG. 19, the movement detection unit 2400 in the embodiment can detect movement information by detecting the movement of the camera device (S200).

Next, the compensation angle calculation unit 2510 in the embodiment calculates the compensation angle for moving the moving part 2100 to the target position based on the movement information detected by the movement detection unit 2400 (S210). At this time, the compensation angle may include a first compensation angle with respect to the first rotation axis, a second compensation angle with respect to the second rotation axis, and a third compensation angle with respect to the third rotation axis.

Next, the driving signal generation unit 2520 in the embodiment generates a driving signal corresponding to the compensation angle (S220). For example, the driving signal generation unit 2520 generates a first driving signal P1 corresponding to the first compensation angle. For example, the driving signal generation unit 2520 generates a second driving signal P2 corresponding to the second compensation angle. For example, the driving signal generation unit 2520 generates a third driving signal P3 corresponding to the third compensation angle.

The mode determination unit 2540 can determine a mode corresponding to the output order of the first to third driving signals (S230). For example, the mode determination unit 2540 can determine the output order of the first to third driving signals. To this end, the compensation angle comparison unit 2550 can compare the compensation angle for each rotation axis calculated by the compensation angle calculation unit 2510. For example, the compensation angle comparison unit 2550 may compare the size of the compensation angle for each rotation axis calculated by the compensation angle calculation unit 2510. For example, the compensation angle comparison unit 2550 can compare the movement amount of the moving part corresponding to the compensation angle for each rotation axis. In addition, the compensation angle comparison unit 2550 can compare the first to third movement amounts.

And, the compensation angle comparison unit 2550 can output information corresponding to the comparison result. For example, the compensation angle comparison unit 2550 may output information about the rotation axis with the largest movement amount, the rotation axis with the middle movement amount, and the rotation axis with the smallest movement amount. Next, the mode determination unit 2540 can determine the mode based on the information output from the compensation angle comparison unit 2550. For example, the mode determination unit 2540 may determine the mode based on the order of the greatest movement amount based on the comparison result of the compensation angle comparison unit 2550. For example, the mode determination unit 2540 may determine the mode based on the order of the largest compensation angle, based on the comparison result of the compensation angle comparison unit 2550. For example, the first compensation angle may be 3°, the second compensation angle may be 2°, and the third compensation angle may be 5°. Accordingly, the size order for the compensation angle may be ‘third compensation angle>first compensation angle>second compensation angle’. Accordingly, the mode determination unit 2540 can determine the corresponding mode so that the driving signal is output in the order of the compensation angle becoming larger. For example, in the case of the compensation angle size as above, the mode determination unit 2540 causes the third driving signal P3 to be output at first priority, causes the first driving signal P1 to be output as the second priority, and causes the second drive signal P2 to be output as the third priority. For example, the mode determination unit 2540 determines the mode as the third mode so that the driving signals are output in the order of the third driving signal P3, the first driving signal P1, and the second driving signal P2.

Next, the driving signal output unit 2530 determines the output order of the first to third driving signals according to the mode determined through the mode determination unit 2540, and sequentially outputs the first to third driving signals with a predetermined delay time according to the determined output order (S240).

For example, when the determined mode is the third mode, the driving signal output unit 2530 outputs a third driving signal P3 to be provided to the third driving part 2230 at the first time point T1, outputs a first driving signal P1 to be provided to the first driving part 2210 at the second time point T2, and outputs a second driving signal P2 to be provided to the second driving part 2220 at the third time point T1

<Optical Device>

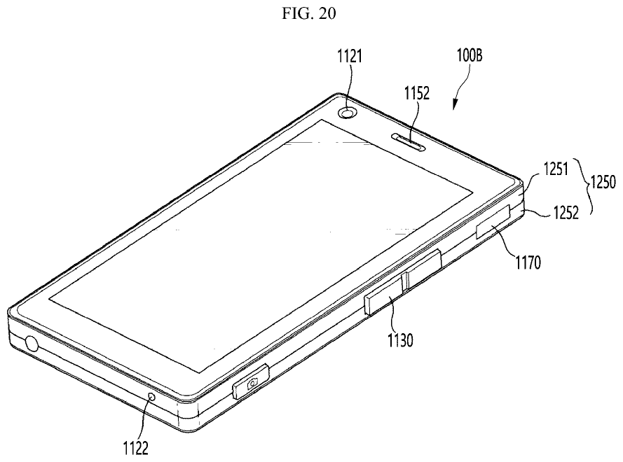

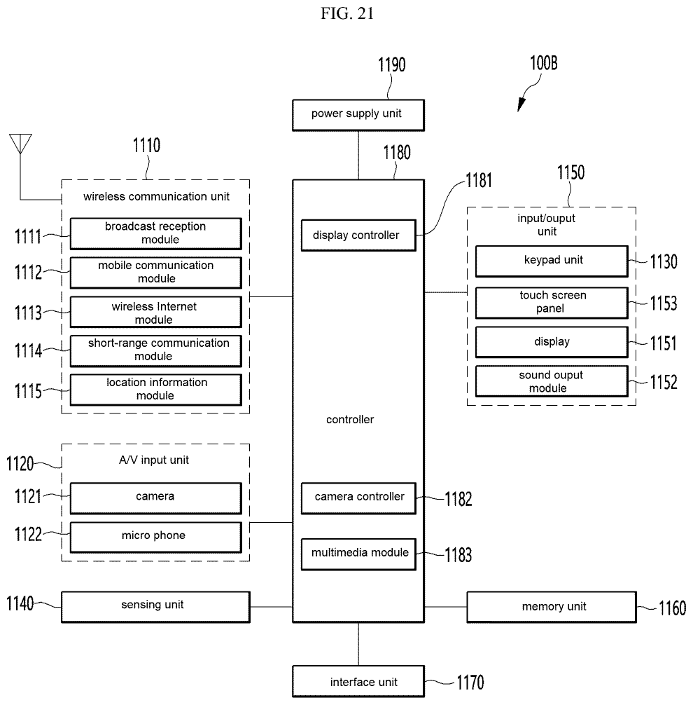

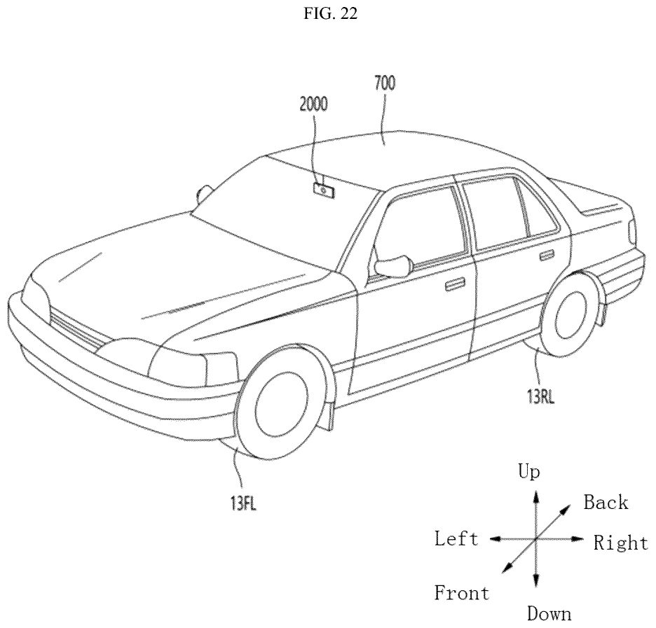

FIG. 20 is a perspective view of an optical device according to an embodiment, and FIG. 21 is a configuration diagram of the optical device shown in FIG. 20.

The optical device may be any one of a cell phone, a mobile phone, a smart phone, a portable smart device, a digital camera, a laptop computer, a digital broadcasting terminal, a PDA (Personal Digital Assistants), a PMP (Portable Multimedia Player), and a navigation device. However, the type of optical device is not limited thereto, and any device for taking an image or photo may be included in the optical device.

The optical device may include a body 1250. The body 1250 may have a bar shape. Alternatively, the body 1250 may have various structures such as a slide type, a folder type, a swing type, a swivel type, in which two or more sub-bodies are coupled to be movable relative to each other. The body 1250 may include a case (casing, housing, or cover) forming an exterior. For example, the body 1250 may include a front case 1251 and a rear case 1252. Various electronic components of an optical device may be embedded in a space formed between the front case 1251 and the rear case 1252. A display 1151 may be disposed on one surface of the body 1250. A camera 1121 may be disposed on one or more surfaces of one surface of the body 1250 and the other surface disposed opposite to the one surface.

The optical device may include a wireless communication unit 1110. The wireless communication unit 1110 may include one or more modules that enable wireless communication between the optical device and the wireless communication system or between the optical device and a network in which the optical device is located. For example, the wireless communication unit 1110 may include any one or more of a broadcast reception module 1111, a mobile communication module 1112, a wireless Internet module 1113, a short-range communication module 1114, and a location information module 1115.

The optical device may include an A/V input unit 1120. The A/V (Audio/Video) input unit 1120 is for inputting an audio signal or a video signal, and may include any one or more of a camera 1121 and a microphone 1122. In this case, the camera 1121 may include the camera device according to the present embodiment.

The optical device may include a sensing unit 1140. The sensing unit 1140 may detect a current state of the optical device, such as open/close status of optical device, position of optical device, presence of user contact, bearing of optical device, acceleration/deceleration of optical device, and generate a sensing signal for controlling the operation of the optical device. For example, when the optical device is in the form of a slide phone, it is possible to sense whether the slide phone is opened or closed. In addition, it may be responsible for sensing functions related to whether the power supply unit 1190 supplies power, whether the interface unit 1170 is coupled to an external device, and the like.

The optical device may include an input/output unit 1150. The input/output unit 1150 may be configured to generate an input or output related to visual, auditory, or tactile sense. The input/output unit 1150 may generate input data for controlling the operation of the optical device, and may output information processed by the optical device.

The input/output unit 1150 may include any one or more of a keypad unit 1130, a display 1151, a sound output module 1152, and a touch screen panel 1153. The keypad unit 1130 may generate input data in response to a keypad input. The display 1151 may output an image captured by the camera 1121. The display 1151 may include a plurality of pixels whose color changes according to an electrical signal. For example, the display 1151 may include at least one of a liquid crystal display, a thin film transistor-liquid crystal display, an organic light-emitting diode, a flexible display, or a three-dimensional display (3D display). The sound output module 1152 may output audio data received from the wireless communication unit 1110 in a call signal reception, a call mode, a recording mode, a voice recognition mode, or a broadcast reception mode, or audio data stored in the memory unit 1160. The touch screen panel 1153 may convert a change in capacitance generated due to a user's touch on a specific region of the touch screen into an electrical input signal.

The optical device may include a memory unit 1160. A program for processing and control of the controller 1180 may be stored in the memory unit 1160. Also, the memory unit 1160 may store input/output data, for example, any one or more of a phone book, a message, an audio, a still image, a photo, and a moving image. The memory unit 1160 may store an image captured by the camera 1121, for example, a photo or a video.

The optical device may include an interface unit 1170. The interface unit 1170 serves as a passage for connecting to an external device connected to the optical device. The interface unit 1170 may receive data from an external device, receive power and transmit it to each component inside the optical device, or transmit data inside the optical device to the external device. The interface unit 1170 may include any one or more of a wired/wireless headset port, an external charger port, a wired/wireless data port, a memory card port, a port for connecting a device having an identification module, and an audio I/O (Input/Output), a video input/output (I/O) port, and an earphone port.

The optical device may include a controller 1180. The controller 1180 may control the overall operation of the optical device. The controller 1180 may perform related control and processing for voice call, data communication, video call, and the like. The controller 1180 may include a multimedia module 1181 for playing multimedia. The multimedia module 1181 may be provided within the controller 1180 or may be provided separately from the controller 1180. The controller 1180 may perform a pattern recognition process capable of recognizing a handwriting input or a drawing input performed on the touch screen as characters and images, respectively.

The optical device may include a power supply unit 1190. The power supply unit 1190 may receive external power or internal power under the control of the controller 1180 to supply power required for operation of each component.

FIG. 22 is a perspective view of a vehicle to which a camera module according to an embodiment is applied. For example, FIG. 22 is an external view of a vehicle equipped with a vehicle driving assistance device to which a camera module according to an embodiment is applied.

Referring to FIG. 22, a vehicle 700 according to the embodiment can include wheels 13FL and 13FR rotating by a power source and a predetermined sensor. The sensor can be the camera sensor 2000, but is not limited thereto.

The camera 2000 can be a camera sensor to which the camera module 1000 according to the embodiment is applied.

The vehicle 700 of the embodiment may obtain image information through the camera sensor 2000 that captures a front image or a surrounding image. And the vehicle 700 of the embodiment may determine a lane identification situation using image information and create a virtual lane when the lane is not identified.

For example, the camera sensor 2000 may obtain a front image by capturing the front of the vehicle 700, and a processor (not shown) may acquire image information by analyzing an object included in the front image.

For example, when objects such as lanes, adjacent vehicles, driving obstacles, and indirect road markings such as median strips, curbs, and roadside trees are captured in the image captured by the camera sensor 2000, the processor may detect these objects and include them in image information.

At this time, the processor may acquire distance information with the object detected through the camera sensor 2000 to further supplement the image information. The image information can be information about an object photographed in an image.

The camera sensor 2000 can include an image sensor and an image processing module. The camera sensor 2000 may process a still image or moving image obtained by an image sensor (e.g., CMOS or CCD). The image processing module may process a still image or video obtained through an image sensor, extract necessary information, and transmit the extracted information to a processor.

In this case, the camera sensor 2000 can include a stereo camera to improve object measurement accuracy and further secure information such as a distance between the vehicle 700 and the object, but is not limited thereto.

The vehicle 700 of the embodiment may provide advanced driver assistance systems (ADAS).

For example, Advanced Driver Assistance Systems (ADAS) can include Autonomous Emergency Braking (AEB), which automatically slows down or stops without the driver applying the brakes in the event of a risk of collision. Advanced Driver Assistance Systems (ADAS) can include Lane Keep Assist System (LKAS), which maintains the lane by adjusting the driving direction when departing from the lane. Advanced Driver Assistance Systems (ADAS) can include Advanced Smart Cruise Control (ASCC: Advanced Smart Cruise Control) that automatically maintains the distance to the vehicle in front while driving at a pre-set speed. Advanced Driver Assistance Systems (ADAS) can include Blind-Spot Collision Avoidance Assist System (AB SD: Active Blind Spot Detection) helps to change lanes safely by detecting the risk of collision in the blind spot. Advanced Driver Assistance Systems (ADAS) can include Around View Monitoring System (AVM: Around View Monitor) that visually displays a situation around the vehicle.

In such an advanced driver assistance system (ADAS), the camera module functions as a core component along with radar and the like, and the proportion of the camera module to which it is applied is gradually widening.

For example, in the case of an automatic emergency braking system (AEB), a vehicle front camera sensor and a radar sensor detect a vehicle or pedestrian in front and automatically emergency brake when the driver does not control the vehicle. Alternatively, in the case of a driving steering assistance system (LKAS), a camera sensor can be used to detect whether a driver departs from a lane without operating a turn signal lamp, and automatically steer the steering wheel to maintain the lane. In addition, in the case of the Around View Monitoring System (AVM), the situation around the vehicle can be visually displayed through camera sensors placed on all sides of the vehicle.

Features, structures, effects, etc. described in the embodiments above are included in at least one embodiment, and are not necessarily limited to only one embodiment. Furthermore, the features, structures, and effects illustrated in each embodiment can be combined or modified with respect to other embodiments by those skilled in the art in the field to which the embodiments belong. Therefore, contents related to these combinations and modifications should be construed as being included in the scope of the embodiments.

Although the above has been described centering on the embodiment, this is only an example and does not limit the embodiment, and those skilled in the art in the field to which the embodiment belongs may find various things not exemplified above to the extent that they do not deviate from the essential characteristics of the embodiment. It will be appreciated that variations and applications of branches are possible. For example, each component specifically shown in the embodiment can be modified and implemented. And differences related to these modifications and applications should be construed as being included in the scope of the embodiments set forth in the appended claims.

1. A lens driving device comprising:
a first housing;
a lens assembly disposed in the first housing;
a first driving part disposed in the first housing and configured to drive the lens assembly;
a second housing disposed to surround the first housing, and
a second driving part disposed in the second housing and corresponding to the first driving part;
wherein the first driving part includes a plurality of first driving members configured to drive the lens assembly based on each of a plurality of rotation axes, and
wherein the plurality of first driving members are arranged at a same distance from a center of any one of the plurality of rotation axes in the first housing.

2. The lens driving device of claim 11, wherein the plurality of first driving members includes at least two of:
a first magnet part configured to move the lens assembly based on a first rotation axis;
a second magnet part configured to move the lens assembly based on a second rotation axis different from the first rotation axis; and
a third magnet part configured to move the lens assembly based on a third rotation axis different from the first and second rotation axes.

3. The lens driving device of claim 2, wherein the center of the rotation axis is a center of any one of the first to third rotation axes.

4. The lens driving device of claim 3, wherein the centers of the first to third rotation axes are the same.

5. The lens driving device of claim 2, wherein a distance from the center of the rotation axis to the third magnet part is same as at least one of a distance from the center of the rotation axis to the first magnet part and a distance from the center of the rotation axis to the second magnet part.

6. The lens driving device of claim 5, wherein the third rotation axis corresponds to an optical axis through which light is incident on the lens assembly.

7. The lens driving device of claim 2, wherein sizes of the first to third magnet parts are the same.

8. The lens driving device of claim 2, wherein the plurality of second driving members include:
a first coil part corresponding to the first magnet part;
a second coil part corresponding to the second magnet part; and
a third coil part corresponding to the third magnet part.

9. The lens driving device of claim 2, wherein the lens assembly includes:
a bobbin; and
a lens disposed in the bobbin;
wherein the second driving part includes a fourth coil part disposed in the bobbin and corresponding to the first magnet part and the second magnet part.

10. The lens driving device of claim 2, wherein the first magnet part includes a plurality of first magnets disposed facing each other in a first horizontal direction,
wherein the second magnet part includes a plurality of second magnets facing each other in a second horizontal direction perpendicular to the first horizontal direction, and
wherein the third magnet part includes a plurality of third magnets facing each other in a diagonal direction between the first horizontal direction and the second horizontal direction.

11. The lens driving device of claim 1, wherein each of the plurality of first driving members includes a magnet, and
wherein the second driving part includes a plurality of second driving members including a coil corresponding to each of the plurality of first driving members.

12. The lens driving device of claim 8, wherein a distance from the center of the rotation axis to the third coil part, the distance from the center of the rotation axis to the first coil part, and the distance from the center of the rotation axis to the second coil part are the same.

13. The lens driving device of claim 10, wherein a first distance between the plurality of first magnets passing through the center of the first housing is equal to at least one of a second distance between the plurality of second magnets passing through the center of the first housing and a third distance between the plurality of third magnets passing through the center of the first housing.

14. The lens driving device of claim 13, wherein the first to third distances are equal to each other.

15. A lens driving device comprising:
a housing;
a bobbin disposed in the housing;
a lens disposed in the bobbin; and
a driving part disposed in the housing and configured to drive the lens,
wherein the driving part includes a plurality of magnet parts,
wherein the plurality of magnet parts include:
a plurality of first magnets arranged to face each other in a first horizontal direction with respect to a center of the housing;
a plurality of second magnets arranged to face each other in a second horizontal direction perpendicular to the first horizontal direction with respect to the center of the housing; and
a plurality of third magnets arranged to face each other in a diagonal direction between the first and second horizontal directions with respect to the center of the housing, and
wherein a first distance between the plurality of first magnets passing through the center of the housing is equal to at least one of a second distance between the plurality of second magnets passing through the center of the housing and a third distance between the plurality of third magnets passing through the center of the housing.

16. The lens driving device of claim 15, wherein the first to third distances are equal to each other.

17. The lens driving device of claim 15, wherein the plurality of first magnets are a yaw driving part configured to yaw the lens,
wherein the plurality of second magnets are a pitch driving part configured to pitch the lens, and
wherein the plurality of third magnets are a roll driving part configured to roll the lens.

18. A lens driving device comprising:
a first housing having a first receiving space;
a lens assembly disposed in the first receiving space of the first housing;
a second housing having a second receiving space in which the first housing is disposed; and
a driving part configured to move the first housing including the lens assembly relative to the second housing,
wherein the driving part includes:
a first driving part configured to drive the first housing based on a first rotation axis;
a second driving part configured to drive the first housing based on a second rotation axis different from the first rotation axis; and
a third driving part configured to drive the first housing based on a third rotation axis different from the first and second rotation axes,
wherein distances from a center of any one of the first to third rotation axes to the first to third driving parts is the same.

19. The lens driving device of claim 18, wherein the centers of each of the first to third rotation axes are the same.

20. The lens driving device of claim 18, wherein the first driving part includes a first magnet part and a first coil part,
wherein the second driving part includes a second magnet part and a second coil part,
wherein the third driving part includes a third magnet part and a third coil part, and
wherein distances from the center of the rotation axes to the first to third magnet parts is the same, and
wherein distances from the center of the rotation axes to the first to third coil parts is the same.
